(19) United States
(12) Patent Application Publication
(10) Pub. No.: US 2025/0197765 A1
(43) Pub. Date: Jun. 19, 2025

(54) Lubricant Compositions Containing Phosphorus For Use In Hydrogen Fueled Engines

(71) Applicant: INFINEUM INTERNATIONAL LIMITED, ABINGDON (GB)

(72) Inventors: THOMAS M. FEATHERSTONE, BRISTOL (GB); ANDREW J.D. RITCHIE, CHATHAM, NJ (US); ELLIS MUTTER, SWINDON, WILTSHIRE (GB); MARK P. DRIVER, DIDCOT, OXFORDSHIRE (GB); ROXANA CHIRITA, Juvisy-sur-Orge (FR)

(73) Assignee: INFINEUM INTERNATIONAL LIMITED, ABINGDON (GB)

(21) Appl. No.: 18/971,578

(22) Filed: Dec. 6, 2024

Related U.S. Application Data
(60) Provisional application No. 63/609,993, filed on Dec. 14, 2023.

(51) Int. Cl. C10M 169/04; C10M 135/10; C10M 137/10; C10M 141/10; C10M 149/10; C10M 155/00; C10M 161/00; C10N 20/04; C10N 30/00; C10N 30/02; C10N 30/04; C10N 30/12; C10N 40/25; F02M 25/14

(52) U.S. Cl. CPC C10M 169/044; C10M 135/10; C10M 137/10; C10M 141/10; C10M 149/10; C10M 155/00; C10M 161/00; F02M 25/14; C10M 2203/003; C10M 2217/028; C10M 2219/044; C10M 2223/045; C10M 2229/00; C10N 2020/04; C10N 2030/02; C10N 2030/04; C10N 2030/12; C10N 2030/42; C10N 2040/25

(57) ABSTRACT

This invention relates to a method of reducing abnormal combustion events in a hydrogen fueled internal combustion engine during operation of the engine including:
(i) providing a lubricating oil composition to the hydrogen fueled internal combustion engine;
(ii) providing fuel comprising hydrogen to the internal combustion engine; and
(iii) combusting the fuel in the hydrogen fueled internal combustion engine;
   wherein the lubricating oil composition: 1) includes one or more zinc dihydrocarbyl dithiophosphate compounds that provide more than 0.01 mass % zinc, and less than 0.08 mass % of phosphorus, or alternatively greater than or equal to 0.10 mass % and less than 0.40 mass % of phosphorus, based upon the weight lubricating oil composition, and 2) exhibits reduced pre-ignition at a given engine speed (rpm) whilst operating at maximum BMEP for that given engine speed (rpm), as compared to the same composition except that the concentration of the zinc dihydrocarbyl diphosphate compounds is such that the mass % phosphorus present in the lubricating oil composition is not within the specified ranges.

### STATEMENT OF RELATED APPLICATIONS

This application is related to following U.S. Provisional Applications filed on the same date as this application:
1. USSN No. 63/609,985, entitled “Lubricant Compositions Containing Silicon For Reduced Pre-ignition In Hydrogen Fueled Engines”;
2. USSN No. 63/610,000, entitled “Lubricant Compositions Containing Magnesium Detergent For Reduced Pre-ignition In Hydrogen Fueled Engines”;
3. USSN No. 63/610,004, entitled “Lubricant Compositions Containing Detergent For Reduced Pre-ignition In Hydrogen Fueled Engines”;
4. USSN No. 63/610,012, entitled “Lubricant Compositions Containing Molybdenum For Reduced Pre-ignition In Hydrogen Fueled Engines”; and
5. USSN No. 63/610,014, entitled “Lubricant Compositions For Reduced Pre-ignition In Hydrogen Fueled Engines.”

### CROSS-REFERENCE TO RELATED APPLICATION

This U.S. Non-provisional application claims priority to U.S. Provisional Application Ser. No. 63/609,993 filed on Dec. 14, 2023, the contents of which are herein incorporated by reference in their entirety.

### FIELD OF THE INVENTION

This disclosure relates to the use of lubricating oil compositions having phosphorus for use in hydrogen fueled engines to reduce abnormal combustion events, such as in compression ignited internal combustion engine and or spark ignited internal combustion engine applications.

### BACKGROUND OF THE INVENTION

The present invention relates to lubricating oil compositions for use in internal combustion engines (such as hydrogen fueled engines using spark, compression or spark assisted compression ignition) which exhibit improved abnormal combustion event (“ACE”) characteristics (e.g., backfire, various types of knock, including super knock and heavy knock type events, as well as pre-ignition type events). The present invention further relates to lubricating oil compositions for use in compression ignited, or spark assisted compression-ignited internal combustion engines such compositions often referred to as crankcase lubricants; and to the use of additives in such lubricating oil compositions for reducing abnormal combustion events in use of such engines and/or improving the performance of an engine lubricated with the lubricating oil composition by facilitating, inter alia, use of use of hydrogen fueled internal combustion engines where abnormal combustion events, such as pre-ignition, are a concern.

Several terms exist for various forms of abnormal combustion in internal combustion engines including knock, extreme knock (sometimes referred to as super-knock, mega-knock, or heavy knock), surface ignition, and pre-ignition (ignition occurring prior to spark or desired compression ignition point). Extreme knock occurs in the same manner as traditional knock, but with increased knock amplitude, and typically can be mitigated using traditional knock control methods. Pre-ignition can occur at high or low speeds and is a notable characteristic of hydrogen internal combustion engines.

Pre-ignition is a form of abnormal combustion event where the air/fuel mixture ignites prior to the desired ignition by a spark plug, e.g., before the spark plug fires or before a desired ignition point in a compression ignited engine. There are many kinds of pre-ignition and methods used to address one kind of pre-ignition, do not necessarily treat another. Likewise, many elements combine to influence pre-ignition, therefore is it a complex problem.

Historically, pre-ignition in hydrogen fueled systems has generally been a challenge. Hydrogen as an internal combustion engine fuel exhibits a lower minimum ignition energy, wider flammability range and faster flame propagation than gasoline. (A Study of Abnormal Ignition in a Hydrogen Combustion Engine, Naoyoshi Matsubara, Yoshinori Miyamoto, Shiro Tanno, Carbon Neutral Development Div. Toyota Motor Corporation, Yuua Abe Denso Corporation, 10^{th} International Engine Congress, Baden-Baden, Germany, Feb. 28 to Mar. 1, 2023, ATZ Live Springer Fachmedien Weisbaden GmbH, Wiesbaden, Germany). These combustion properties increase the potential for abnormal combustion of the air-fuel mixture. Early abnormal combustion events tend to be initiated by an energy source other than the designed spark event in a spark ignition engine, or by air heated from compression in a compression ignition engine. Sources of abnormal combustion ignition can include combustion chamber hotspots (hot air pockets, hot surfaces or combustion chamber deposits), or energy contained within oil droplets ejected into the combustion chamber. (FEV's Pathway to an ICE Powertrain Powered by Future Fuels Achieving the Maximum Efficiency, Dieter Van DerPut, FEV Eurpoe GmbH, 10^{th} International Engine Congress, Baden-Baden, Germany, Feb. 28 to Mar. 1, 2023, ATZ Live Springer Fachmedien Weisbaden GmbH, Wiesbaden, Germany).

Abnormal combustion events can occur in both spark ignition and compression ignition engines (see Hydrogen Combustion in a Compression Ignition Diesel Engine, Stanislaw Szwaja & Karol Grab-Rogalinski, International Journal of Hydrogen Energy, vol 34, issue 10, May 2009, pg 4413-4421) and are typically counted and characterized by inspecting crank angle resolved cylinder pressure traces to identify combustion cycles with early and, or high pressure events relative to the mean combustion pressure trace, or by mass fraction burned by a defined crank angle. These high pressure events have potential to cause engine damage which includes, but is not limited to, damage to the piston or piston ring, or damage to the head gasket, cylinder head bolts or cylinder head. Such damage adversely impacts the expected engine life (see Xu H, Ni X, Su X, Xiao B, Luo Y, Zhang F, Weng C and Yao C, Experimental and numerical investigation on effects of pre-ignition positions on knock intensity of hydrogen fuel, Int. J. Hydrogen Energy 46 26631-45, 2021), and Yang Luo, Chuanhao Zhao, Na Overview of Pre-ignition of Hydrogen Engine, J. Scientific Research and Reports. 26 (10): 1-7, 2020). Milder pre-igntion events may not cause significant engine damage, but can adversely impact fuel economy, engine performance, tailpipe emissions and engine noise, vibration, and harshness (NVH).

Oil-derived hydrogen abnormal combustion is different to gasoline low speed pre-ignition. Trace base oil appears to reduce the auto-ignition delay of hydrogen-air mixture, in effect making early abnormal ignition more likely. (see Hydrogen Combustion in a Compression Ignition Diesel Engine, Stanislaw Szwaja & Karol Grab-Rogalinski, International Journal of Hydrogen Energy, vol 34, issue 10, May 2009, pg 4413-4421, and Aggarwal S K, Awomolo O and Akber K, Ignition characteristics of heptane-hydrogen and heptanemethane fuel blends at elevated pressures Int. J. Hydrogen Energy 36 15392-402, 2011).

As hydrogen internal combustion engines continue to evolve, pre-ignition causes and impacts are expected to evolve as well. First generation hydrogen internal combustion engines are typically port fuel injection or low pressure direct injection. This is driven by available hardware technology (high pressure direct injection injectors do not typically have the required level of durability, and require complex fuel tank management to deliver a competitive vehicle range). The limited fuel pressure possible, combined with propensity of the air-fuel mixture to pre-ignite, is leading engine manufacturers to develop engines with very lean combustion, where the air-to-fuel ratio (AFR) is typically between 2 to 2.5 (in contrast, gasoline engines tend to operate around 1).

A consequence of very lean combustion is additional air handling cost, as more air will need to be delivered to the combustion chamber (relative to a non-lean engine), and this requires a higher air charge. In practice is this delivered with a variable geometry turbocharger, two stage turbocharger or a supercharger. Air charge cooling will also be required to ensure sufficient air density, and to prevent abnormal combustion from heated air charge. Operators will also find that throttle response of lean burn engines is poorer, increasing the time between input and desired output. This is a consequence of the greater inertia of the air charge system, and desire to prevent pre-ignition from fuel enrichment.

Without wishing to be bound by theory, the instant inventors anticipate that engine designers will wish to increase engine brake mean effective pressure (BMEP) to close the performance gap between hydrogen internal combustion engines and diesel internal combustion engines, this will require identifying solutions to limit or mitigate pre-ignition at high BMEP, where higher energy combustion and great air/fuel charge will increase the likelihood of pre-ignition. Without wishing to be bound by theory, the instant inventors further expect that engine designers will both wish to increase engine throttle performance, and reduce air charge handling cost by moving to less lean engine operation (tend towards air fuel ratio of 1).

It is also recognised in some aspects of abnormal combustion that some components in lubricating oils can have an varying impacts on increasing or decreasing abnormal combustion, and more difficultly, have impacts on other components as they impact the abnormal combustion events.

Many different lubricant additive chemistries have been proposed to control or influence the occurrence of abnormal combustion events (i.e., pre-ignition, knock, heavy knock type events) in modern internal combustion engines, such as turbocharged, gasoline direct injected engines, but these chemistries do not easily translate to hydrogen fueled engines which have significantly different combustion environments.

United States patent application U.S. Ser. No. 18/475,174, filed Sep. 26, 2023 discusses the prevention of low speed pre-ignition in hydrogen engines, and suggests that lubricants formulated with high levels of abnormal combustion event inhibiting compound(s) (such as phosphorus compounds) can significantly reduce or eliminate abnormal combustion events, offering the opportunity to increase internal combustion engine power density and use a wider range of fuels, such as e-fuels, co-blended fuels, fuels containing abnormal combustion event promoters (e.g., ethanol), and or lower octane/cetane fuels.

U.S. Pat. No. 8,163,681 discloses a lubricant composition of a synthetic oil of lubricating viscosity, 3 to 6 percent by weight of a nitrogen-containing dispersant, 1 to 2.5 weight percent of an overbased magnesium detergent, 1 to 5 weight percent of an antioxidant; and 0.25 to 1.5 weight percent of a friction modifier is useful for lubricating a hydrogen-fueled engine. The composition will typically contain less than 0.01 weight percent Ca, less than 0.01 weight percent Zn, less than 0.06 weight percent P, and will have a sulfated ash level of less than 1.2%. At col 14, line 48-66 U.S. Pat. No. 8,163,681 discloses a zinc free low corrosion/rust lubricant for use in a fleet of hydrogen-fueled busses, comprising, other things, group IV basestocks (synthetic polyalpha-olefin), polyolester, succinimide dispersant, magnesium alkyl benzenesulfonate detergents, antioxidant mixture (ester substituted hindered phenol, alkylaromatic amine, and phosphosulfurized olefin), linear fatty acid monoester and oleamide, and antifoam agent, where a calculated KV100 of the combined PAO bases stocks is likely about 12 cSt (based upon a weighted average of the two PAO base stocks), and the lubricant likely has a sixty weight (60) SAE viscosity descriptor.

U.S. Pat. No. 11,034,912 discloses a method of preventing or reducing the occurrence of low speed pre-ignition in a direct-injected, boosted, spark-ignited internal combustion gasoline engine by lubricating the crankcase with a lubricating oil composition having a total sulfated ash content of no greater than about 1.2 mass %, a zinc-phosphorus compound providing said composition with a phosphorus content of from about 0.05 to about 0.08 mass %, a magnesium detergent in an amount providing said composition with at least about 0.3 mass % of magnesium sulfated ash, and an amount of calcium detergent, or calcium and sodium detergent providing said composition with from about 0.3 to about 0.4 mass % of calcium sulfated ash, or calcium and sodium sulfated ash, wherein the total amount of sulfated ash provided to said composition from detergent is no greater than 1.0 mass %, and at least 40 mass % of the total amount of metal introduced into said lubricating oil composition by metal detergent is magnesium, and wherein said zinc phosphorus compound is zinc dihydrocarbyl dithiophosphate derived from secondary alcohol, or primary and secondary alcohol.

Other references of interest include: CN11512503A; WO2023057581; WO 2017/011633; WO 2018/036285; EP 3 366 755; EP 2940110; U.S. Pat. Nos. 11,214,756; 11,034,910; 11,142,719; 10,604,720; U.S. Pat. Nos. 10,214,703; 10,519,394; 10,584,300; 10,669,505; 11,155,764; 10,604,720; Leach et al. SAE Int. J. Fuels Lubr./Volume 15, Issue 1, 2022, SAE Apr. 15, 2001-001.

The present inventor's investigations into hydrogen pre-ignition has identified that the impact of lubricant composition is distinct and different to that of gasoline LSPI and thus presents different and unique challenges.

The present invention relates to lubricating oil compositions for use in (spark-ignited) and (compression-ignited, or spark assisted compression ignited) internal combustion engines fueled with a fuel composition containing up to and including 100% hydrogen; and to the use of additives in such lubricating oil compositions for reducing abnormal combustion events in use of such engines and/or improving the performance, such as the brake mean effective pressure (BMEP) and/or durability impact of a hydrogen fueled engine lubricated with the lubricating oil composition.

It has now surprisingly been found by the present inventors that phosphorus containing materials, such as metal hydrocarbylthiophosphates, such as zinc dihydrocarbyldithiophosphate compounds, can be used in a lubricant composition, such as in hydrogen fueled internal combustion engines, to provide very low abnormal combustion events, such as pre-ignition.

### SUMMARY OF THE INVENTION

This invention relates to a method of reducing abnormal combustion events in a hydrogen fueled internal combustion engine during operation of the engine comprising:
(i) providing a lubricating oil composition to the hydrogen fueled internal combustion engine;
(ii) providing fuel comprising hydrogen to the internal combustion engine; and
(iii) combusting the fuel in the hydrogen fueled internal combustion engine,
   wherein the lubricating oil composition: 1) comprises one or more zinc dihydrocarbyl dithiophosphate compounds that provide more than 0.01 mass % zinc and less than 0.080 mass % of phosphorus or greater than or equal to 0.10 mass % and less than 0.40 mass % of phosphorus, based upon the weight lubricating oil composition, and 2) exhibits reduced pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

This invention also relates to a lubricating oil composition for a hydrogen fueled internal combustion engine comprising one or more base oils at greater than or equal to 50 mass % of the overall lubricating oil composition and one or more zinc dihydrocarbyl dithiophosphate compounds that provide more than 0.01 mass % zinc and less than 0.080 mass % of phosphorus or greater than or equal to 0.10 mass % and less than 0.40 mass % of phosphorus, based upon the weight lubricating oil composition, and exhibits reduced pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

This invention further relates to embodiments where the lubricating oil composition used in the hydrogen fueled engine preferably has an SAE viscosity descriptor of 25W-X, 20W-X, 15W-X, 10W-X, 5W-X or 0W-X (preferably 25W-X, 20W-X, 15W-X, 10W-X, 5W-X or 0W-X), where X represents any one of 8, 12, 16, 20, 30, 40, 50 and 60. Optionally the lubricating oil composition used in the hydrogen fueled engine does not have an SAE viscosity descriptor of X=60.

This invention further relates to embodiments where the lubricating oil composition used in the hydrogen fueled engine comprises one or more Group I, Group II and or Group III base oils (such as at least 50 mass % of Group I, Group II and or Group III base oils, based upon the weight of the lubricating oil composition), optionally where the lubricating oil composition has a kinematic viscosity at 100° C. of 10 cSt or less (as measured by ASTM D445).

This invention further relates to embodiments where the lubricating oil composition used in the hydrogen fueled engine comprises one or more Group I, Group II and or Group III base oils and the kinematic viscosity at 100° C. of the combination of all Group I, Group II and Group III base oils present in the lubricating oil composition is 10 cSt or less (as measured by ASTM D445).

This invention further relates to embodiments where the lubricating oil composition used in the hydrogen fueled engine comprises from 0 to 70 mass % of Group IV base oil [as defined by the API EOLCS 1509 definition (American Petroleum Institute Publication 1509, see section E.1.3, 19th edition, January 2021, www.API.org)].

This invention further relates to embodiments where the lubricating oil composition used in the hydrogen fueled engine comprises calcium detergent and magnesium detergent.

This invention further relates to embodiments where the lubricating oil composition used in the hydrogen fueled engine comprises calcium detergent and magnesium sulfonate detergent.

This invention further relates to embodiments where the lubricating oil composition used in the hydrogen fueled engine comprises calcium salicylate and/or magnesium salicylate detergent.

This invention further relates to embodiments where the lubricating oil composition used in the hydrogen fueled engine comprises calcium salicylate and/or magnesium sulfonate detergent.

### BRIEF DESCRIPTION OF THE DRAWINGS

FIG. 1 (FIG. 1) is a graph of the dependence of the NOx emissions versus lambda, λ, see FIG. 4 of Gschiel, K. et al. Measures to Improve The Transient Behaviour of Hydrogen ICE, Proceedings of the 44^{th} International Vienna Motor Symposium Apr. 26-28, 2023, pages 867-877, Österreichischer Verein für Kraftfahrzeugtechnik, 2023 (ISBN 978-3-9504969-2-5).

FIG. 2 (FIG. 2) is a graph of engine power versus engine speed used to define test speeds. See Regulation 49 in the Experimental section.

### DEFINITIONS

For purposes of this specification and all claims to this invention, the following words and expressions, if and when used, have the meanings ascribed below.

For purposes herein, the new numbering scheme for the Periodic Table of the Elements is used as set out in CHEMICAL AND ENGINEERING NEWS, 63 (5), 27 (1985), i.e., Alkali metals are group 1 metals (e.g., Li, Na, K, etc.) and Alkaline earth metals are group 2 metals (e.g., Mg, Ca, Ba, etc.).

The term “about” means approximately, which includes values obtain by rounding. As used herein, the term “about” modifying the quantity of an ingredient, component, or reactant of the invention employed refers to variation in the numerical quantity that can occur, for example, through typical measuring and liquid handling procedures used for making concentrates or lubricating oil compositions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The term “LOC” means lubricating oil composition.

The term “major amount” means more than 50 mass % of a composition, such as more than 60 mass % of a composition, such as more than 70 mass % of a composition, such as from 80 to 99.009 mass % of a composition, such as from 80 to 99.9 mass % of a composition, of a composition based upon the mass of the composition.

The term “mass %” means mass percent of a component, based upon the mass of the composition as measured in grams, unless otherwise indicated, and is alternately referred to as weight percent (“weight %”, “wt %”, “wt. %” or “% w/w”).

The term “minor amount” means 50 mass % or less of a composition; such as 40 mass % or less of a composition; such as 30 mass % or less of a composition, such as from 20 to 0.001 mass %, such as from 20 to 0.1 mass %, based upon the mass of the composition.

The term “active ingredient” (also referred to as “a.i.” or “A.I.”) refers to additive material that is neither diluent nor solvent. Unless otherwise indicated, amounts herein are described as active ingredient.

The terms “oil-soluble” and “oil-dispersible,” or cognate terms, used herein do not necessarily indicate that the compounds or additives are soluble, dissolvable, miscible, or are capable of being suspended in the oil in all proportions. These do mean, however, that they are, for example, soluble or stably dispersible in oil to an extent sufficient to exert their intended effect in the environment in which the oil is employed. Moreover, the additional incorporation of other additives may also permit incorporation of higher levels of a particular additive, if desired.

The term “hydrocarbon” means a compound of hydrogen and carbon atoms. A “heteroatom” is an atom other than carbon or hydrogen. When referred to as “hydrocarbons,” particularly as “refined hydrocarbons,” the hydrocarbons may also contain one or more heteroatoms or heteroatom-containing groups (such as halo, especially chloro and fluoro, amino, alkoxyl, mercapto, alkylmercapto, nitro, nitroso, sulfoxy, etc.) in minor amounts (e.g., where the heteroatom(s) do not substantially alter the hydrocarbon properties of the hydrocarbon compound).

The terms “group” and “radical” are used interchangeably herein.

The term “hydrocarbyl” means a radical that contains hydrogen and carbon atoms. Preferably, the group consists essentially of, more preferably consists only of, hydrogen and carbon atoms, unless specified otherwise. Preferably, the hydrocarbyl group comprises an aliphatic hydrocarbyl group. The term “hydrocarbyl” includes “alkyl,” “alkenyl,” “alkynyl,” and “aryl” as defined herein. Hydrocarbyl groups may contain one or more atoms/groups other than carbon and hydrogen provided they do not affect the essentially hydrocarbyl nature of the hydrocarbyl group. Those skilled in the art will be aware of such atoms/groups (e.g., halo, especially chloro and fluoro, amino, alkoxyl, mercapto, alkylmercapto, nitro, nitroso, sulfoxy, etc.).

The term “alkyl” means a radical of carbon and hydrogen (such as a C₁ to C₃₀, such as a C₁ to C₁₂ group). Alkyl groups in a compound are typically bonded to the compound directly via a carbon atom. Unless otherwise specified, alkyl groups may be linear (i.e., unbranched) or branched, be cyclic, acyclic, or part cyclic/acyclic. Preferably, the alkyl group comprises a linear or branched acyclic alkyl group. Representative examples of alkyl groups include, but are not limited to, methyl, ethyl, n-propyl, iso-propyl, n-butyl, sec-butyl, iso-butyl, tert-butyl, n-pentyl, iso-pentyl, neo-pentyl, hexyl, heptyl, octyl, dimethyl hexyl, nonyl, decyl, undecyl, dodecyl, tridecyl, tetradecyl, pentadecyl, hexadecyl, heptadecyl, octadecyl, nonadecyl, icosyl and triacontyl.

The term “alkenyl” means a radical of carbon and hydrogen (such as a C₂ to C₃₀ radical, such as a C₂ to C₁₂ radical) having at least one double bond. Alkenyl groups in a compound are typically bonded to the compound directly via a carbon atom. Unless otherwise specified, alkenyl groups may be linear (i.e., unbranched) or branched, be cyclic, acyclic or part cyclic/acyclic.

The term “alkylene” means a C₁ to C₂₀, preferably a C₁ to C₁₀, bivalent saturated aliphatic radical, which may be linear or branched. Representative examples of alkylene include methylene, ethylene, propylene, butylene, pentylene, hexylene, heptylene, octylene, nonylene, decylene, 1-methyl ethylene, 1-ethyl ethylene, 1-ethyl-2-methyl ethylene, 1,1-dimethyl ethylene and 1-ethyl propylene.

An “olefin”, alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “isoprene” content of 55 mass % to 95 mass %, it is understood that the mer unit in the copolymer is derived from isoprene in the polymerization reaction and said derived units are present at 55 mass % to 95 mass %, based upon the weight of the copolymer. A “polymer” has two or more of the same or different mer units. A “homopolymer” is a polymer having mer units that are the same. A “copolymer” is a polymer having two or more mer units that are different from each other. “Different” as used to refer to mer units indicates that the mer units differ from each other by at least one atom or are different isomerically. An “isoprene polymer” or “isoprene copolymer” is a polymer or copolymer comprising at least 50 mol % isoprene derived units, a “butadiene polymer” or “butadiene copolymer” is a polymer or copolymer comprising at least 50 mol % butadiene derived units, and so on. Likewise, when a polymer is referred to as a “partially or fully saturated polymer comprising C₄₋₅ olefins,” the C₄₋₅ olefin(s) present in such polymer or copolymer are the polymerized form of the olefin(s), and the polymer has been partially or fully saturated (such as by hydrogenation) after polymerization of the monomers.

The term “alkynyl” means a C₂ to C₃₀ (such as a C₂ to C₁₂) radical, which includes at least one carbon-to-carbon triple bond.

The term “aryl” means a group containing at least one aromatic ring, such a cyclopentadiene, phenyl, naphthyl, anthracenyl, and the like. Aryl groups are typically C₅ to C₄₀ (such as C₅ to C₁₈, such as C₆ to C₁₄) aryl groups, optionally substituted by one or more hydrocarbyl groups, heteroatoms, or heteroatom-containing groups (such as halo, hydroxyl, alkoxy and amino groups). Preferred aryl groups include phenyl and naphthyl groups and substituted derivatives thereof, especially phenyl, and alkyl substituted derivatives of phenyl.

The term “substituted” means that a hydrogen atom has been replaced with hydrocarbon group, a heteroatom, or a heteroatom-containing group. An alkyl substituted derivative means a hydrogen atom has been replaced with an alkyl group. An “alkyl substituted phenyl” is a phenyl group where a hydrogen atom has been replaced by an alkyl group, such as a C₁ to C₂₀ alkyl group, such as methyl, ethyl, n-propyl, iso-propyl, n-butyl, sec-butyl, iso-butyl, tert-butyl, n-pentyl, iso-pentyl, neo-pentyl, hexyl, heptyl, octyl, dimethyl hexyl, nonyl, decyl, undecyl, dodecyl, tridecyl, tetradecyl, pentadecyl, hexadecyl, heptadecyl, octadecyl, nonadecyl, icosyl and/or triacontyl.

The term “halogen” or “halo” means a group 17 atom or a radical of group 17 atom, such as fluoro, chloro, bromo, and iodo.

The term “ashless” in relation to an additive means the composition does not include a metal. The term “ash-containing” in relation to an additive means the composition includes a metal.

The term “effective amount” in respect of an additive means an amount of such an additive in a lubricating oil composition so that the additive provides the desired technical effect.

The term “effective minor amount” in respect of an additive means an amount of such an additive of less than 50 mass % of the lubricating oil composition so that the additive provides the desired technical effect. The term “effective major amount” in respect of an additive means an amount of such an additive of 50 mass % or more of the lubricating oil composition so that the additive provides the desired technical effect.

The term “ppm” means parts per million by mass, based on the total mass of the lubricating oil composition, unless otherwise indicated.

The term “metal content” of a lubricating oil composition or of an additive component, for example, magnesium content, molybdenum content or total metal content (i.e., the sum of all individual metal contents), is measured by ASTM D5185.

The term “absent” as it relates to components included within the lubricating oil compositions described herein and the claims thereto means that the particular component is present at 0 mass %, based upon the weight of the lubricating oil composition, or if present in the lubricating oil composition the component is present at levels that do not impact the lubricating oil composition properties, such as less than 10 ppm, or less than 1 ppm or less than 0.001 ppm. When the term “absent” is used in relation to monomer reactants and/or to repeat units in (co)polymers described herein, it means present at 0 wt %, based upon the weight of all (co)monomers in the (co)polymer, or, if present at all, at levels so low that they do not substantially impact the physical properties of the (co)polymer, such as at 0.2 wt % or less or at 0.1 wt % or less.

As used herein, Mn is number average molecular weight, Mw is weight average molecular weight, and Mz is z average molecular weight. Molecular weight distribution (MWD), also referred to as polydispersity index (PDI), is defined to be Mw divided by Mn. Unless otherwise noted, all molecular weight units (e.g., Mw, Mn, Mz) are reported in g/mol. When used in context of functionalized polymers (such as dispersants, functionalized styrenic polymers, etc.), the molecular weights are typically reported in terms of the base polymer prior to modification. For example PIBSA-PAM dispersant molecular weights are typically reported for the base polyisobutylene polymer prior to functionalization with the acylating agent (maleic acid or anhydride) and functional group (such as polyamine).

Total Base Number, also referred to as “TBN,” in relation to an additive component or of a lubricating oil composition (i.e., unused lubricating oil composition) means total base number as measured by ASTM D2896 and reported in units of mgKOH/g. “High TBN” is considered to be greater than or equal to 200 KOH/g, or 300 to 500 mgKOH/g. “Low TBN” is considered less than 200 KOH/g, or less than 100 KOH/g.

Total Acid Number (“TAN”) is determined by ASTM D664.

Phosphorus, Boron, Calcium, Zinc, Molybdenum, Sodium, Silicon, and Magnesium content are measured by ASTM D5185.

Sulfur content in oil formulations is measured by ASTM D5185.

Sulfated ash (“SASH”) content is measured by ASTM D874.

Kinematic viscosity (KV100, KV40) is determined pursuant to ASTM D445-19a and reported in units of cSt, unless otherwise specified.

Viscosity index is determined according to ASTM D2270.

Saponification number is determined by ASTM D94, and reported in units of mgKOH/g.

A hydrogen fueled internal combustion engine is an internal combustion engine (mobile or standing) that uses a fuel containing hydrogen, which can be up to 100% hydrogen, such as 1 to 100 mass %, such as 25 to 100 mass % hydrogen, based upon the mass of the fuel. Common fuels containing hydrogen include compressed hydrogen, hydrogen compressed hydrocarbon combinations (such as hydrogen/compressed natural gas) and the like.

For purposes of this specification and all claims to this invention, an abnormal combustion event (“ACE”) is defined to be an event where combustion in a spark ignited internal combustion engine (SI engine) occurs outside the flame front propagated from a spark plug, or in a compression ignited internal combustion engine (“CI engine”) an event where combustion occurs outside of or in the incorrect location or time of the piston compression cycle. (A spark assisted compression ignited engine may have either or both of the above defined of abnormal combustion events.) Auto-ignition and pre-ignition are both abnormal combustion events. Auto-ignition (also referred to as detonation) is the spontaneous combustion of an fuel/air mixture in the combustion chamber that occurs after normal combustion is initiated by the spark plug or by compression (such as by a compressing piston). Pre-ignition is defined as the ignition of the air/fuel mixture prior to the spark plug firing in an SI engine or prior to the correct time/pressure in the compression ignition cycle in a CI engine. Low Speed Pre-ignition (LSPI) is a specific type of pre-ignition which occurs under low engine speeds and relatively high engine loads. Knocking (also referred to as knock, detonation, spark knock, pinging or pinking) in internal combustion engines typically occurs when combustion of some of the air/fuel mixture in the cylinder does not result from propagation of the flame front ignited by the spark plug, but one or more pockets of air/fuel mixture explode outside the envelope of the normal combustion front. The fuel-air charge is meant to be ignited by the spark plug only and at a precise point in the piston's stroke. Knock occurs when the peak of the combustion process no longer occurs at the optimum moment for the engine stroke cycle (such as a four-stroke cycle). The shock wave from the auto-ignition can create the characteristic metallic “pinging” or “knocking” sound. Effects of engine knocking range from inconsequential to completely destructive to the engine. Knocking should not be confused with pre-ignition as they are two separate events. However, pre-ignition can be followed by knocking. Abnormal combustion events (such as auto-ignition) are influenced by multiple factors, including but not limited to, engine design (shape, size, geometry, plug location), spark plug performance/timing, compression ratio, engine timing, air/fuel mixture temperature, cylinder pressure, fuel octane rating, lubricant composition, fuel additive composition, and the like.

Octane number is defined as the Research Octane Number plus the Motor Octane Number divided by two (i.e., (RON+MON)/2). Research Octane Number is determined by ASTM D2699-21. Motor Octane Number is determined by ASTM D2700-21. Diesel gasoline cetane number is determined by ASTM D613.

Unless otherwise indicated, all percentages reported are mass % on an active ingredient basis, i.e., without regard to carrier or diluent oil.

Also, it will be understood that various components used, essential as well as optimal and customary, may react under conditions of formulation, storage or use and that the disclosure also provides the product obtainable or obtained as a result of any such reaction.

Further, it is understood that any upper and lower quantity, range and ratio limits set forth herein may be independently combined.

Also, it will be understood that the preferred features of each aspect of the present disclosure are regarded as preferred features of every other aspect of the present disclosure. Accordingly, preferred and more preferred features of one aspect of the present disclosure may be independently combined with other preferred and/or more preferred features of the same aspect or different aspects of the present disclosure.

### DETAILED DESCRIPTION

The features of the disclosure relating, where appropriate, to each and all aspects of the disclosure, will now be described in more detail as follows.

Hydrogen engine abnormal combustion is distinct and different to gasoline combustion engine low speed preignition (LSPI). In particular, a hydrogen-air mixture requires much lower minimum ignition energy than a gasoline-air mixture, that is approximately 0.02 mJ for a hydrogen-air mixture compared to 0.25 mJ for gasoline-air mixture. Additionally, a hydrogen-air mixture also exhibits shorter ignition delay than a gasoline-air mixture at high combustion temperatures and low cylinder pressures. These factors are expected to increase the propensity for hydrogen abnormal combustion compared to gasoline pre-ignition under equivalent combustion conditions. Furthermore, the high propensity for hydrogen internal combustion engines (ICEs) to experience abnormal combustion requires lean combustion operation with air to fuel ratios of from 1.5 to 2.5 being typical. In contrast, gasoline combustion engines operate near-stoichiometrically with an air to fuel ratio of about or approximately 1.0. It is well known that fuel enrichment in gasoline engines experiencing LSPI will mitigate pre-ignition. However in hydrogen ICE applications, the inventors have demonstrated that abnormal combustion, and specifically pre-ignition unexpectedly and surprisingly increases with fuel enrichment (reference Table 1 herein) contrary to what is typical in a gasoline ICE.

This invention relates to a method of reducing abnormal combustion events in a hydrogen fueled internal combustion engine during operation of the engine comprising:
(i) providing a lubricating oil composition to the hydrogen fueled internal combustion engine;
(ii) providing fuel comprising hydrogen to the internal combustion engine; and
(iii) combusting the fuel in the hydrogen fueled internal combustion engine;
   wherein the lubricating oil composition: 1) comprises one or more zinc hydrocarbyl dithiophosphate compounds providing more than 0.01 mass % (such as more than 0.02 mass %) of zinc and less than 0.08 mass % (such as less than 0.06 mass %, such as less than 0.02 mass %, such as 0.016 mass % or less) of phosphorus, or alternatively greater than or equal to 0.10 mass % and less than 0.40 mass % (such as 0.12 mass %, or 0.14 mass %, or 0.16 mass %, or 0.18 mass %, or 0.20 mass %, or 0.25 mass %, or 0.30 mass %, or 0.35 mass %) of phosphorus, based upon the weight lubricating oil composition; 2) exhibits reduced pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges; and 3) preferably has an SAE viscosity descriptor of 25W-X, 20W-X, 15W-X, 10W-X, 5W-X or 0W-X, where X represents any one of 8, 12, 16, 20, 30, 40, 50, and 60.

This invention further relates to embodiments where the lubricating oil composition used in the hydrogen fueled engine comprises one or more Group I, Group II and or Group III base oils, optionally where the lubricating oil composition has a kinematic viscosity at 100° C. of 10 cSt or less, or 2 to 8 cSt, or 4 to 8 cSt (as measured by ASTM D445).

This invention further relates to embodiments where the lubricating oil composition used in the hydrogen fueled engine comprises one or more Group I, Group II and or Group III base oils and the kinematic viscosity at 100° C. of the combination of all Group I, Group II and Group III base oils present in the lubricating oil composition is 10 cSt or less, or 2 to 8 cSt, or 4 to 8 cSt (as measured by ASTM D445). This invention further relates to embodiments where the lubricating oil composition used in the hydrogen fueled engine comprises 70 mass % or less, such as 60 mass % or less, 50 mass % or less, such as 40 mass % or less, 30 mass % or less, such as 20 mass % or less, 10 mass % or less, such as 5 mass % or less, or is absent polyalphaolefin, such as polyalphaolefin having a viscosity index of 100 or more, such as 120 or more, such as 140 or more as determined by ASTM D2270.

This invention further relates to embodiments where the lubricating oil composition used in the hydrogen fueled engine comprises 70 mass % or less, such as 60 mass % or less, 50 mass % or less, such as 40 mass % or less, 30 mass % or less, such as 20 mass % or less, 10 mass % or less, such as 5 mass % or less, or is absent polyalphaolefin having a kinematic viscosity at 100° C. of more than 10 cSt, or 20 cSt or more, or 30 cSt ot more, or 40 cSt or more (as measured by ASTM D445).

This invention further relates to embodiments where the lubricating oil composition used in the hydrogen fueled engine comprises calcium detergent and magnesium detergent.

This invention further relates to embodiments where the lubricating oil composition used in the hydrogen fueled engine comprises calcium detergent and magnesium sulfonate detergent.

This invention further relates to embodiments where the lubricating oil composition used in the hydrogen fueled engine comprises calcium salicylate and/or magnesium salicylate detergent.

This invention further relates to embodiments where the lubricating oil composition used in the hydrogen fueled engine comprises calcium salicylate and/or magnesium sulfonate detergent.

This invention further relates to embodiments where the lubricating oil composition used in the hydrogen fueled engine comprises less than 0.70 phenate detergent, such as less than 0.5 mass %, such as less than 0.40 mass %, such as less than 0.30 mass %, such as less than 0.20 mass %, such as less than 0.10 mass %. Alternately, phenate detergent is absent.

This invention further relates to embodiments where the lubricating oil composition used in the hydrogen fueled engine comprises less than 0.50 calcium phenate detergent, such as less than 0.5 mass %, such as less than 0.40 mass %, such as less than 0.30 mass %, such as less than 0.20 mass %, such as less than 0.10 mass %, based upon the weight of the lubricating oil composition. Alternately, calcium phenate detergent is absent from the lubricating oil composition.

This invention further relates to embodiments where the lubricating oil composition used in the hydrogen fueled engine comprises less than 5 mass % PIBSA ester of methylene-bridged naphthyloxy ethanol, such as less than 4 mass %, such as less than 3 mass %, such as less than 2 mass %, such as less than 0.20 mass %, such as less than 0.10 mass %, based upon the weight of the lubricating oil composition. Alternately, dispersant is absent from the lubricating oil composition.

In embodiments, the one or more zinc hydrocarbyl dithiophosphate compounds are zinc dihydrocarbyl dithiophosphate compounds (ZDDP's), such as zinc dialkyl dithiophosphate compounds, as further described below in section B. The hydrocarbyl groups of the zinc hydrocarbyl dithiophosphate compounds (such as the zinc dihydrocarbyl dithiophosphate compounds) may be the same or different hydrocarbyl groups. The alkyl groups of the zinc dialkyl dithiophosphate compounds may be the same or different alkyl groups. Alternately, the zinc dihydrocarbyl dithiophosphate compounds used herein may be combinations of two or more, such as three or more, zinc dihydrocarbyl dithiophosphate compounds where the hydrocarbyl groups are derived from different alcohols.

The hydrocarbyl groups of the zinc dihydrocarbyl dithiophosphate compounds (such as zinc dialkyl dithiophosphate compounds) may be derived from primary alcohols, secondary alcohols or mixtures thereof. Alternately, the zinc dihydrocarbyl dithiophosphate compounds used herein may be combinations of two or more, such as three or more, zinc dihydrocarbyl dithiophosphate compounds where the hydrocarbyl groups are derived from different primary alcohols, secondary alcohols or mixtures thereof.

The zinc dihydrocarbyl dithiophosphate compounds (such as zinc dihydrocarbyl dithiophosphate compounds, such as zinc dialkyl dithiophosphate compounds) are typically used in amounts of from about 0.01 mass % to about 5 mass %, from about 0.05 mass % to about 3 mass %, from about 0.4 mass % to about 1.2 mass %, from about 0.1 mass % to about 1.0 mass %, preferably from about 0.5 mass % to about 1.0 mass %, and more preferably from about 0.6 mass % to about 0.8 mass %, based on the total weight of the lubricating composition, although more or less can often be used advantageously.

In embodiments, the zinc dihydrocarbyl dithiophosphate compounds comprise secondary ZDDP's (i.e., derived from secondary alcohols), and are present in the lubricating oil composition at an amount of from about 0.001 to 10 mass % of the total weight of the lubricating composition.

In embodiments, the zinc dihydrocarbyl dithiophosphate compounds comprise mixed primary and secondary ZDDP's (i.e., derived from a mixture of primary and secondary alcohols or are a mixture of a ZDDP derived from a primary alcohol and a ZDDP derived from a secondary alcohol), and are present in the lubricating oil composition to provide less than 0.080 mass % of phosphorus, or alternatively greater than or equal to 0.10 mass % and less than 0.40 mass % of phosphorus of the total weight of the lubricating oil composition.

In embodiments, the lubricating oil composition comprises one or more petroleum derived base oils, such as one or more (such as two or more, such as three or more) of Group I, II and or III base oils. Petroleum derived (or derived from petroleum) means base oils obtained by the refining of petroleum. Base oils obtained by synthetic processes where monomer units are polymerized (such as polyalphaolefins obtained by the polymerization of alpha-olefins, such as C₆-C₁₈, such as C₁₀, alpha-olefin monomer units) are not considered derived from petroleum for purposes of this invention and the claims thereto, even though the monomer units, such as decene-1, can be obtained from processing of petroleum products.

In embodiments, the lubricating oil composition comprises 50 mass % or more of Group I, II and or III base oil, based upon the weight of the lubricating oil composition;

In embodiments, the lubricating oil composition comprises less than 50 mass % of Group IV base oil, such as less than 50 mass % of PAO base oil.

In embodiments, the lubricating oil composition described herein for use in hydrogen fueled engines optionally has an SAE viscosity descriptor of 25W-X, 20W-X, 15W-X, 10W-X, 5W-X or 0W-X, (such as 20W-X, 15W-X, 10W-X, 5W-X or 0W-X, such as 20W-X, SAE 15W-X, SAE 10W-X, SAE 5W-X or SAE 0W-X), where X represents any one of 8, 12, 16, 20, 30, 40, 50, and 60.

In embodiments, the lubricating oil composition useful in hydrogen fueled engines described herein comprises: a) Group I, II and or III base oil, b) zinc dialkyl dithiophosphate, c) detergent, and d) dispersant and or dispersant viscosity modifier. In embodiments, the dispersant and or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

In embodiments, the fuel supplied to the hydrogen fueled engine comprises at least 5 mass % hydrogen, such as at least 10 mass % hydrogen, such as at least 15 mass % hydrogen, such as 20 mass % hydrogen, such as at least 25 mass % hydrogen, such as at least 30 mass % hydrogen, such as at least 35 mass % hydrogen, such as at least 40 mass % hydrogen, such as at least 45 mass % hydrogen, such as at least 50 mass % hydrogen, such as at least 55 mass % hydrogen, such as at least 60 mass % hydrogen, such as at least 70 mass % hydrogen, such as at least 75 mass % hydrogen, such as at least 80 mass % hydrogen, such as at least 85 mass % hydrogen, such as at least 90 mass % hydrogen, such as at least 95 mass % hydrogen, such as at least 99 mass % hydrogen, such as 100 mass % hydrogen, based upon the mass of the fuel. Optionally, the hydrogen comprises white hydrogen, green hydrogen, blue hydrogen, brown hydrogen, or combinations thereof. Generally, white hydrogen is naturally occurring hydrogen, green hydrogen is created from renewable energy such as solar or wind energy used to hydrolyze water, blue hydrogen is derived from fossil fuels, such as steam reforming of natural gas (with or without carbon capture and or storage) or methane pyrolysis, and brown hydrogen is produced from coal.

In embodiments the fuel supplied to the hydrogen fueled engine comprises at least 5 mass % hydrogen and less than 95 mass % of non-hydrogen fuel (such as hydrocarbon fuel), such as at least 10 mass % hydrogen and less than 90 mass % of non-hydrogen fuel, such as at least 15 mass % hydrogen and less than 85 mass % of non-hydrogen fuel, such as 20 mass % hydrogen and less than 80 mass % of non-hydrogen fuel, such as at least 25 mass % hydrogen and less than 75 mass % of non-hydrogen fuel, such as at least 30 mass % hydrogen and less than 70 mass % of non-hydrogen fuel, such as at least 35 mass % hydrogen and less than 65 mass % of non-hydrogen fuel, such as at least 40 mass % hydrogen and less than and less than 60 mass % of non-hydrogen fuel, such as at least 45 mass % hydrogen and less than 55 mass % of non-hydrogen fuel, such as at least 50 mass % hydrogen and less than 50 mass % of non-hydrogen fuel, such as at least 55 mass % hydrogen and less than 45 mass % of non-hydrogen fuel, such as at least 60 mass % hydrogen and less than 40 mass % of non-hydrogen fuel, such as at least 70 mass % hydrogen and less than 30 mass % of non-hydrogen fuel, such as at least 75 mass % hydrogen and less than 25 mass % of non-hydrogen fuel, such as at least 80 mass % hydrogen and less than 20 mass % of non-hydrogen fuel, such as at least 85 mass % hydrogen and less than 15 mass % of non-hydrogen fuel, such as at least 90 mass % hydrogen and less than 10 mass % of non-hydrogen fuel, such as at least 95 mass % hydrogen and less than 5 mass % of non-hydrogen fuel, such as at least 99 mass % hydrogen and less than 1 mass % of non-hydrogen fuel, based upon the mass of the fuel. Optionally the non-hydrogen fuel may be one or more of natural gas, compressed natural gas, gasoline (such as gasoline having an octane number of 87 or more, such as 93 more), diesel fuel (such as diesel fuel having a cetane number of 40 or more, such as 50 or more), aviation fuel, renewable fuel.

This invention also relates to the use of the lubricating oil composition described herein, to lubricate a hydrogen fueled internal combustion engine where the fuel provided to the hydrogen fueled internal combustion engine comprises:
a) 1 to 100 mass % of hydrogen,
b) 0 to 99 mass % of petroleum derived fuel, and/or
c) from 0 to 99 mass %, or 0.1 to 98.9 mass %, or 1 to 75 mass %, or 5 to 50 mass %, of renewable fuel other than hydrogen, based upon the total mass of hydrogen fuel, renewable fuel and the petroleum derived fuel, wherein the lubricating oil composition: 1) comprises one or more zinc dihydrocarbyl dithiophosphate compounds that provide more than 0.01 mass % zinc, and less than 0.08 mass % of phosphorus, or alternatively greater than or equal to 0.10 mass % and less than 0.40 mass % of phosphorus, based upon the weight lubricating oil composition, 2) exhibits reduced pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

In embodiments, the fuel comprising: 1) hydrogen and 2) lubricating oil composition are combined in the combustion chamber to form a fuel composition, alternately the fuel comprising hydrogen and the lubricating oil composition are combined prior to injection into the combustion chamber to form a fuel composition.

In embodiments, the fuel composition comprising hydrogen and the lubricating oil composition comprises from 0.01 to 20 mass % of lubricating oil composition, such as from 0.025 to 15 mass % of lubricating oil composition, from 0.05 to 10 mass % of lubricating oil composition, from 0.10 to 5 mass % of lubricating oil composition, from 0.015 to 2.5 mass % of lubricating oil composition, based upon the mass of the fuel comprising hydrogen and the lubricating oil composition.

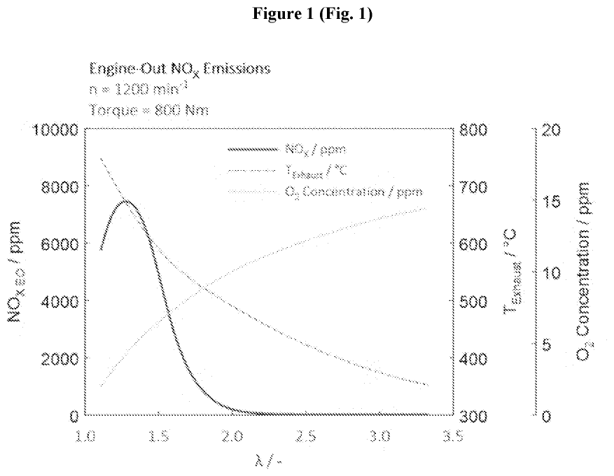

Lambda, λ, is the air fuel ratio of the amount of air and fuel provided to an engine combustion chamber divided by the air fuel ratio for a stoichiometric reaction in the same engine combustion chamber under the same conditions of pressure and temperature. In a preferred embodiment, the lambda, λ, for hydrogen fueled engines being lubricated with the lubrication composition herein is 0.5 to 3.5, such as 1 to 3.0, such as 1 to 2.5, such as such as 1 to 2.1 such as 1.3 to 2, such as 1.4 to 1.9, such as 1.5 to 1.85, such as 3.5 or less, such as 3.0 or less, such as 2.5 or less, such as 2 or less, such as 1.85 or less, such as 1.7 or less, such as 1.6 or less, such as 1.5:1 or less, such as 1.4 or less. For a given hydrogen fueled engine, a lower lambda can mean lower cost because less air is injected into the combustion chamber allowing more fuel to be consumed and more power to be produced. Likewise, less cost is incurred in engine design and operation as more efficient lambda, λ, at higher pressures requires less specialized high pressure equipment to inject air into the combustion chambers, among other things. Hence, the lubricating oil compositions described herein when utilized with hydrogen fueled engines built with existing engine block technology, enable easier/more efficient retrofitting/less-redesign to be able to efficiently use hydrogen fuel. Further, operations at more efficient (higher lambda, λ) while minimizing NOx (NOx is a collective name for nitrogen oxides, e.g., NO and NO₂) emissions are also desirable. FIG. 1 illustrates common NOx production at lambda, λ, values of 1 to 3.5. (see Gschiel, K. et al. Measures to Improve The Transient Behaviour of Hydrogen ICE, Proceedings of the 44^{th} International Vienna Motor Symposium Apr. 26-28, 2023, pages 867-877, Österreichischer Verein für Kraftfahrzeugtechnik, 2023 (ISBN 978-3-9504969-2-5). Note that lower lambda, λ, values produce higher NOx, which is less desirable. Thus, balancing engine efficiency with NOx production is often a difficult task in internal combustion engine design and operation.

In embodiments, the air fuel ratio in the combustion chamber of a hydrogen fueled internal combustion engine at 12 bar (1.2 MPa) BMEP, is 3.5:1 or less, such as 3.0:1 or less, such as 2.5:1 or less, or 2:1 or less, 1.85:1 or less, or 1.7:1 or less, or 1.6:1 or 1.5:1 or less, or 1.4:1 or less, such as 1:1 to 2.5:1, such as 1:1 to 2.25:1 such as 1:1 to 2.0:1 or 1.5 to 1.9.

In embodiments, the air fuel ratio in the combustion chamber of a hydrogen fueled internal combustion engine at 18 bar (1.8 MPa), is 3.5:1 or less, such as 3.0:1 or less, such as 2.5:1 or less, or 2:1 or less, 1.85:1 or less, or 1.7:1 or less, or 1.6:1 or 1.5:1 or less, or 1.4:1 or less, such as 1:1 to 2:1 or 1.5 to 1.9.

Each engine has a rated speed and a maximum brake mean effective pressure (BMEP) at a given engine speed (rpm) at or below the rated speed. The rated speed of an engine is defined by the manufacturer of the engine. The engine speed and power are mapped producing an Engine Mapping Curve as described in Regulation 49, defined in the Experimental section), which is then used to calculate the maximum BMEP at a given engine speed (rpm). BMEP=(2πTn)/(Vd), where T is torque (Nm), n is the number of revolutions per cycle, Vd is displacement (m³). For a 4 stroke engine n is 2, for a 2 stroke engine n is 1.

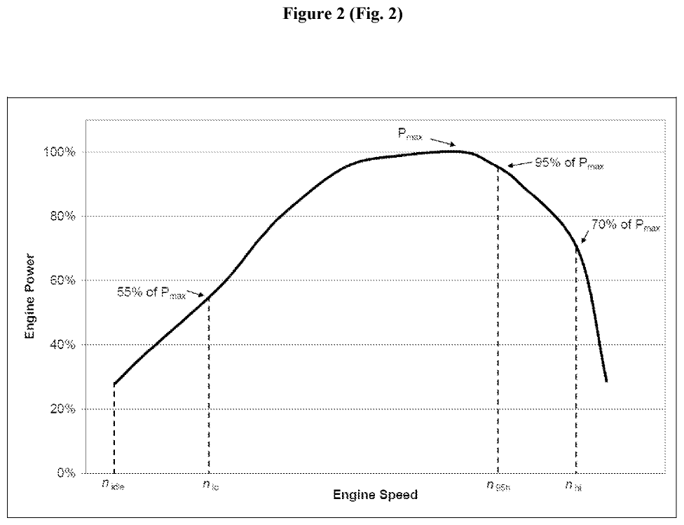

The instant invention provides reduced pre-ignition (Pre-Ignition Testing Method 1 or Pre-Ignition Testing Method 2, see Experimental section) at a given engine speed whilst operating at maximum BMEP for that given engine speed (rpm), as compared to the same composition except that the ZDDP concentration is such that the mass % phosphorus in the lubricating oil composition is not within the specified ranges. Preferably the lubricating oil compositions described herein obtain a lower number of pre-ignition events at an engine speed of 55% of Pmax (as determined according to Engine Mapping Curve (Regulation 49 (Uniform Provisions Concerning the Measures to be Taken Against The Emission of Gaseous and Particulate Pollutants From Compression-Ignition Engines and Positive Ignition Engines For Use in Vehicles), Annex 4, section 7.3 to 7.4.7, et seq, page 115 et seq. of E/ECE/324/Rev.1/Add.48/Rev.6-E/ECE/TRANS/505/Rev.1/Add.48/Rev.6, see FIG. 2 of this specification) as compared to the same composition except that the ZDDP concentration is such that the mass % phosphorus in the lubricating oil composition is not within the specified ranges, preferably at least 10% less (such as at least 20% less, such as at least 30% less, such as at least 40% less, such as at least 50% less, such as at least 60% less, such as at least 70% less) pre-ignition events (Pre-Ignition Testing Method 1 or Pre-Ignition Test Method 2, see Experimental section).

The instant invention provides reduced pre-ignition (Pre-Ignition Testing Method 1, see Experimental section) at a given engine speed whilst operating at maximum BMEP for that given engine speed (rpm), as compared to the same composition except that the ZDDP concentration is such that the mass % phosphorus in the lubricating oil composition is not within the specified ranges. Preferably the lubricating oil compositions described herein obtain a lower number of pre-ignition events at an engine speed of 100% of Pmax (as determined according to Engine Mapping Curve (Regulation 49 (Uniform Provisions Concerning the Measures to be Taken Against The Emission of Gaseous and Particulate Pollutants From Compression-Ignition Engines and Positive Ignition Engines For Use in Vehicles), Annex 4, section 7.3 to 7.4.7, et seq, page 115 et seq. of E/ECE/324/Rev.1/Add.48/Rev.6-E/ECE/TRANS/505/Rev.1/Add.48/Rev.6, see FIG. 2 of this specification) as compared to the same composition except that the ZDDP concentration is such that the mass % phosphorus in the lubricating oil composition is not within the specified ranges, preferably at least 10% less (such as at least 20% less, such as at least 30% less, such as at least 40% less, such as at least 50% less, such as at least 60% less, such as at least 70% less) pre-ignition events (Pre-Ignition Testing Method 1, see Experimental section).

The instant invention provides reduced pre-ignition (Pre-Ignition Testing Method 1, see Experimental section) at 1000 rpm whilst operating at maximum BMEP for 1000 rpm (calculated from engine torque in the Engine Mapping Curve), as compared to the same composition except that the ZDDP concentration is such that the mass % phosphorus in the lubricating oil composition is not within the specified ranges. Preferably the lubricating oil compositions described herein obtain at least 10% less pre-ignition events at the engine speed at 1200 rpm and maximum BMEP (calculated from engine torque in the Engine Mapping Curve) as compared to the same composition except that the ZDDP concentration is such that the mass % phosphorus in the lubricating oil composition is not within the specified ranges, preferably at least 15% less (such as at least 20% less, such as at least 30% less, such as at least 40% less, such as at least 50% less, such as at least 60% less, such as at least 69% less) pre-ignition events (Pre-Ignition Testing Method 1, see Experimental section).

The instant invention provides reduced pre-ignition (Pre-Ignition Testing Method 1, see Experimental section) at 1200 rpm whilst operating at maximum BMEP for 1200 rpm (calculated from engine torque in the Engine Mapping Curve), as compared to the same composition except that the ZDDP concentration is such that the mass % in the lubricating oil composition is not within the specified ranges. Preferably the lubricating oil compositions described herein obtain at least 10% less pre-ignition events at the engine speed at 1200 rpm and maximum BMEP (calculated from engine torque in the Engine Mapping Curve) as compared to the same composition except that the ZDDP concentration is such that the mass % phosphorus is present in the lubricating oil composition is not within the specified ranges, preferably at least 15% less (such as at least 20% less, such as at least 30% less, such as at least 40% less, such as at least 41% less) pre-ignition events (Pre-Ignition Testing Method 1, see Experimental section).

Further, the lubricating oil compositions described herein facilitate obtaining a number of pre-ignition events/1000 cycles at 12 Bar BMEP (Pre-Ignition Testing Method 1, see Experimental section) of at least 10% (such as at least 20%, such as at least 30% such as at least 40%, such as at least 50%, such as at least 60% such as at least 70%) less than the same composition except that the ZDDP concentration is such that the mass % phosphorus in the lubricating oil composition is not within the specified ranges.

Further, the lubricating oil compositions described herein facilitate obtaining a number of pre-ignition events/1000 cycles at 16 Bar BMEP (Pre-Ignition Testing Method 1, see Experimental section) of at least 10% (such as at least 20%, such as at least 30% such as at least 40%, such as at least 50%, such as at least 55%) less than the same composition except that the ZDDP concentration is such that the mass % phosphorous in the lubricating oil composition is not within the specified ranges.

Further, the lubricating oil compositions described herein facilitate obtaining a number of pre-ignition events/1000 cycles at 17 Bar BMEP (Pre-Ignition Testing Method 1, see Experimental section) of at least 5% (such as at least 10%, such as at least 15% such as at least 17%) less than the same composition except that the ZDDP concentration is such that the mass % phosphorus in the lubricating oil composition is not within the specified ranges.

Further, the lubricating oil compositions described herein obtaining a number of pre-ignition events/1000 cycles at 18 Bar BMEP (Pre-Ignition Testing Method 1, see Experimental section) of at least 10% (such as at least 20%, such as at least 30% such as at least 38%) less than the same composition except that the ZDDP concentration is such that the mass % phosphorus in the lubricating oil composition is not within the specified ranges.

The hydrogen fueled internal combustion engines described herein may be retrofitted engines, engines designed for moving vehicles (such as automobiles, trucks, generators, marine engines etc.), stationary engines, such as heavy duty internal combustion engines or standing generators comprising internal combustion engines.

In embodiments, the lubricating compositions disclosed herein may be used in heavy-duty engines (e.g., heavy-duty vehicles having a gross vehicle weight rating of 10,000 pounds or more.)

In embodiments, the lubricating compositions disclosed herein may be used as passenger car motor oils.

In embodiments, the lubricating compositions disclosed herein may be used in a passenger car where the hydrogen fueled internal combustion engine is an passenger car internal combustion engine (optionally also using gasoline and or diesel fuel).

In embodiments, the lubricating compositions disclosed herein may be for use in a heavy duty internal combustion engines or stationary internal combustion engines.

### Lubricating Oil Compositions

The lubricating oil compositions useful herein comprise components that may or may not remain the same chemically before and after mixing with an oleaginous carrier (such as a base oil) and/or other additives. This disclosure encompasses compositions which comprise the components before mixing, or after mixing, or both before and after mixing.

This disclosure relates to lubricating oil compositions (also referred to as “LOC,” “lubricant compositions,” “lubricating compositions,” or “lubricant oil compositions”) used in the methods described herein comprising or resulting from the admixing of:
(a) from 1 to 99 mass % (alternately 30 to 95 mass %, alternately 50 to 90 mass %, alternately 60 to 95 mass %, alternately 70 to 85 mass %) of one or more base oils (such as 50 mass % or more Group I, II and or III base oils), based upon the weight of the lubricating composition;
(b) from 0.01 to 20 mass % (in particular 0.15 to 10 mass %, alternately 0.20 mass % to 5 mass %, alternately 0.25 to 2 mass %, alternately 0.5 to 1 mass %), based upon the weight of the composition, of one or more zinc dihydrocarbyl diphosphate compounds such that the lubricating oil composition comprises 0.01 mass % zinc or more and less than 0.080 mass % P, or alternatively more than or equal to 0.10 mass % and less than 0.40 mass % P, based upon the weight of the lubricating composition; where the lubricating oil composition exhibits reduced pre-ignition (Pre-Ignition Testing Method 1 or 2, see Experimental section) at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the above specified ranges.

This disclosure also relates to lubricating oil compositions comprising or resulting from the admixing of:
(i) from 1 to 99 mass % (alternately 30 to 95 mass %, alternately 50 to 90 mass %, alternately 60 to 95 mass %, alternately 70 to 85 mass %) of one or more Group I, II and/or III base oils, based upon the weight of the lubricating composition;
(ii) from 0.01 to 20 mass % (in particular 0.1 to 12 mass %, alternately 0.1 to 8 mass %), based on total weight of the lubricating composition, of one or more dispersants (such as blends of dispersants);
(iii) from 0.10 to 20 mass % (in particular 0.15 to 10 mass %, alternately 0.20 mass % to 5 mass %, alternately 0.25 to 2 mass %), based upon the weight of the composition, of one or more detergents;
(iv) from 0.001 to 10 mass % (in particular, 0.01 to 5 mass %, alternately 0.1 to 3 mass %, alternately 0.25 to 1.5 mass %, alternately 0.5 to 1.0 mass %), based on total weight of the lubricating composition, of one or more zinc dihydrocarbyl diphosphate compounds such that the lubricating oil composition comprises 0.01 mass % zinc or more and less than 0.80 mass % P, or alternatively more than or equal to 1.0 mass % and less than 4.0 mass % P, based upon the weight of the lubricating composition;
   where the lubricating oil composition:
1) exhibits reduced pre-ignition (Pre-Ignition Testing Method 1 or 2, see Experimental section) at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the above specified ranges; and
2) optionally exhibits an SAE viscosity descriptor of 25W-X, 20W-X, 15W-X, 10W-X, 5W-X or 0W-X, (50W-X, 40W-X, 30W-X, 20W-X, 15W-X, 10W-X, 5W-X or 0W-X, such as 20W-X, SAE 15W-X, SAE 10W-X, SAE 5W-X or SAE 0W-X), where X represents any one of 8, 12, 16, 20, 30, 40, 50, and 60.

This disclosure also relates to lubricating oil compositions comprising or resulting from the admixing of:
A) from 1 to 99 mass % (alternately 30 to 95 mass %, alternately 50 to 90 mass %, alternately 60 to 95 mass %, alternately 70 to 85 mass %) based upon the weight of the lubricating oil composition, of one or more base oils;
B) from 0.10 to 20 mass % (in particular, 0.15 to 10 mass %, alternately 0.20 mass % to 5 mass %, alternately 0.25 to 2 mass %), based on total weight of the lubricating oil composition, of zinc dihydrocarbyl diphosphate compounds;
C) from 0.10 to 20 mass % (in particular, 0.15 to 10 mass %, alternately 0.20 mass % to 5 mass %, alternately 0.25 to 2 mass %), based upon the weight of the lubricating oil composition, of one or more detergents (such as blends of detergents);
D) optionally, from 0.01 to 5 mass % (in particular 0.1 to 4 mass %, alternately 0.25 to 3 mass %, alternately 0.045-0.15 mass %), based on total weight of the lubricating oil composition, of one or more friction modifiers (such as blends of friction modifiers);
E) optionally, from 0.01 to 10 mass % (in particular, 0.01 to 5 mass %, alternately 0.01 to 3 mass %, alternately 0.1 to 1.5 mass %), based on total weight of the lubricating oil composition, of one or more antioxidants (such as blends of antioxidants);
F) optionally, from 0.01 to 5 mass % (in particular, 0.01 to 3 mass %, alternately 0.1 to 1.5 mass %), based on total weight of the lubricating oil composition, of one or more pour point depressants (such as blends of pour point depressants);
G) optionally, from 0.001 to 5 mass % (in particular, 0.01 to 3 mass %, alternately 0.1 to 1.5 mass %), based on total weight of the lubricating oil composition, of one or more anti-foam agents (such as blends of anti-foam agents);
H) optionally, from 0.001 to 10 mass % (in particular, 0.01 to 6 mass %, alternately 0.01 to 5 mass %, alternately 0.1 to 4 mass %, alternately 0.1 to 2 mass %, alternately 0.1 to 1 mass %), based on total weight of the lubricating oil composition, of one or more viscosity modifiers (such as blends of viscosity modifiers);
I) optionally, from 0.01 to 20 mass % (in particular, 0.1 to 12 mass %, alternately 0.1 to 8 mass %), based on total weight of the lubricating oil composition, of one or more dispersants (such as blends of dispersants);
J) optionally, from 0.01 to 5 mass % (in particular, 0.1 to 3 mass %, alternately 0.1 to 1.5 mass %), based on total weight of the lubricating oil composition, of one or more inhibitors and/or anti-rust agents (such as blends of inhibitors and/or anti-rust agents);
K) from 0.001 to 10 mass % (in particular, 0.01 to 5 mass %, alternately 0.1 to 3 mass %, alternately 0. to 1.5 mass %), based on total weight of the lubricating oil composition, of one or more anti-wear agents (such as blends of anti-wear agents, other than the zinc dihydrocarbyl diphosphate compounds of component B);
M) optionally, from 0.01 to 5 mass % (in particular, 0.05 to 2 mass %, alternately 0.1 to 1 mass %), based on total weight of the lubricating oil composition, of one or more seal compatibility agents, such as seal swell agents, and/or
O) optionally, from 0.01 to 5 mass % (in particular, 0.1 to 3 mass %, alternately 0.1 to 1.5 mass %), based on total weight of the lubricating oil composition, of one or more unsaturated C₁₂-C₆₀ hydrocarbons (such as C₁₂-C₂₄ linear alpha-olefins (LAOs), oligomers/polymers of polyisobutylenes, and/or blends thereof).

For purposes of this disclosure, zinc dihydrocarbyl diphosphate compounds are not added in the elements C, D, E, F G, H, I, J, K, M, and/or O above for determining weight percentages, even though they may show similar properties, e.g., zinc dihydrocarbyl diphosphate compounds may impact wear positively, but are not added into element K) for determining weight percent of anti-wear agents.

In embodiments, all of elements D, E, F G, H, I, J, K, M, and O are present in addition to the base oil, detergent, and the zinc dihydrocarbyl diphosphate compounds described herein.

In embodiments, elements D, E, F G, H, I, and J are present in addition to the base oil, detergent, and the zinc dihydrocarbyl diphosphate compounds described herein.

In embodiments, elements I, F, and G are present in addition to the base oil, detergent, and the one or more zinc dihydrocarbyl diphosphate compounds described herein.

In embodiments, element K is present in addition to the base oil, detergent, and the one or more zinc dihydrocarbyl diphosphate compounds described herein.

Suitably, the lubricant composition may have a total base number (TBN) of 1 to 30 mgKOH/g, such as 4 to 15 mgKOH/g, such as 5 to 15 mgKOH/g, such as 5 to 12 mgKOH/g, such as 7 to 12 mgKOH/g, such as 8 to 11 mgKOH/g, as measured by ASTM D2896.

Suitably, the lubricant composition may have a phosphorus level of less than 800 ppm, alternately 600 ppm or less, alternately 500 ppm or less, alternately 400 ppm or less, such as 1 to 600, such as 50 to less than 800 ppm, such as 100 to less than 600 parts per million (ppm) by mass of phosphorus, expressed as atoms of phosphorus, based on the total mass of the lubricating compositions, as measured by ASTM D5185. Alternatively, the lubricant composition may have a phosphorus level of greater than or equal to 1000 ppm and less than 4000 ppm, or 1200 ppm to 3800 ppm, or 1400 ppm to 3600 ppm, or 1600 ppm to 3400 ppm, or 1800 ppm to 3200 ppm, or 2000 ppm to 3000 ppm, or 2200 ppm to 2800 ppm, or 2400 ppm to 2600 ppm.

Typically, the lubricating compositions may contain low levels of sulfur. Preferably, the lubricating composition contains up to 0.4, more preferably up to 0.3, most preferably up to 0.2, such as 0.1 to 0.4 mass % sulfur, based on the total mass of the lubricating oil composition, as measured by ASTM D5185.

Typically, the lubricating compositions may contain low levels of sulfated ash, such as 1.2% or less, such as 1.0 mass % or less, preferably 0.9 mass or less %, preferably 0.8 mass % or less, alternately 0.0001 to 0.5 mass % or less sulfated ash, based on the total mass of the lubricating composition, as measured by ASTM D874-13a (2018).

The lubricating compositions disclosed herein may have a kinematic viscosity as measured by ASTM D-445 at 100° C. of 3 cSt (mm²/s) or more, such as from 3 to 26.1 cSt, such as from 3.8 to less than 21.9 cSt, such as from 4.1 to less than 16.3 cSt, such as from 4.1 to less than 21.9.

The lubricating compositions disclosed herein may have a kinematic viscosity as measured by ASTM D-445 at 100° C. of 3 cSt (mm²/s), or more, such as from 3 to 26.1 cSt, such as from 4.0 to less than 6.1 cSt, such as from 5.0 to less than 7.1 cSt, such as from 6.1 to less than 8.2 cSt, such as from 6.9 to less than 9.3 cSt, such as 9.3 to less than 12.5 cSt, such as 12.5 to less than 16.3 cSt, such as 16.3 to less than 21.9 cSt, such as 21.9 to 26.1 cSt.

The lubricating composition of the present disclosure may be a multigrade oil identified by the viscometric descriptor SAE 25W-X, 20W-X, 15W-X, 10W-X, 5W-X or 0W-X, where X represents any one of 8, 12, 16, 20, 30, 40, 50, and 60, where X represents any one of 8, 12, 16, 20, 30, 40, 50, and 60), the characteristics of the different viscometric grades can be found in the standard SAE J300 published January 2015 by SAE International, formerly known as Society of Automotive Engineers. Alternately, the lubricating composition of the present disclosure may be a multigrade oil identified by the viscometric descriptor SAE 20W-X, SAE 15W-X, SAE 10W-X, SAE 5W-X or SAE 0W-X, where X represents any one of 8, 12, 16, 20, 30, 40, 50, and 60 (the characteristics of the different viscometric grades can be found in the standard SAE J300 published January 2015 by SAE International, formerly known as Society of Automotive Engineers.

Alternately, lower viscosity lubricating composition may have viscosity grade SAE 15W-X, SAE 10W-X, SAE 5W-X or SAE 0W-X, such as in the form of SAE 15W-X or SAE 10W-X, wherein X represents any one of 8, 12, 16, 20, 30, 40, 50, and 60. Preferably X is 8, 12, 16, or 20.

Alternately, the lubricating composition of the present disclosure may be a multigrade oil identified by the viscometric descriptor SAE 10W-30, 15W-40, 5W-30, 5W-40, 10W-40, 5W-50.

Alternately, the lubricating composition may have a SAE viscosity grade of 0W-Y, wherein Y may be 12, 16, or 20. In one embodiment, the lubricating composition has an SAE viscosity grade of 0W-12.

Optionally, the lubricating composition may be absent phenolic antioxidant, such as hindered phenolic antioxidants.

Optionally, the lubricating composition may be absent aminic antioxidant, such as phenylamines, such as diphenyl amines, such as alkylated diphenyl amines (such as mono or dialkylated diphenyl amines).

Optionally, the lubricating composition may be absent hindered phenolic antioxidant and aminic antioxidant, such as phenylamines, such as diphenyl amines, such as alkylated diphenyl amines (such as mono or dialkylated diphenyl amines).

In embodiments, the lubricating oil composition may comprise less than 20 mass % (such as less than 15 mass %, such as less than 10 mass %, such as less than 5 mass %, such as less than 3 mass %, such as less than 1 mass %) functionalized (such as aminated) polybutene (such as polyisobutylene), such as PIBSA-PAM. In embodiments, the lubricating oil composition may comprise, may be substantially free of, or may be absent, functionalized (such as aminated) polybutene (such as polyisobutylene), such as PIBSA-PAM.

In embodiments, the lubricating oil composition may comprise acylated polymers, such as polyisobutylene succinic acid (PIBSA), optionally derived from polymer having an Mn of 500 to 50,000 g/mol, such as 600 to 5,000 g/mol, such as 700 to 3000 g/mol. In embodiments, the lubricating oil composition may comprise acylated polymers, such as polyisobutylene succinic acid, derived from PIB having an Mn of 500 to 1600 g/mol, such as 700 to 1200 g/mol, such as 700 to 2000 g/mol, such as 700 to 1500 g/mol such as 800 to 1400 g/mol, such as 800 to less than 1000 g/mol. In embodiments, the lubricating oil composition comprises more than 0.1 mass % (such as 0.1 to 10 mass % or more, such as 0.5 to 8 mass % or more), acylated polybutene (such as polyisobutylene), such as PIBSA.

In embodiments, the lubricating oil composition may comprise 20 mass % or less (such as 15 mass % or less, such as 10 mass % or less, such as 5 mass % or less, such as 3 mass % or less, such as 1 mass % or less) block copolymer, such as block, radial (also referred to as “star”), random, and/or tapered block copolymer).

In embodiments, the lubricating oil composition may be substantially free of or may be absent block copolymer, such as block, radial, random, and/or tapered block copolymer.

In embodiments, the lubricating oil composition may comprise 20 mass % or less (such as 15 mass % or less, such as 10 mass % or less, such as 5 mass % or less, such as 3 mass % or less, such as 1 mass % or less) styrenic copolymer, such as block, radial, random, and/or tapered styrenic block copolymer). In embodiments, the lubricating oil composition may be substantially free or absent styrenic copolymer, such as block, radial, random, and/or tapered styrenic block copolymer.

In embodiments, the lubricating oil composition may comprise less than 20 mass % (such as less than 15 mass %, such as less than 10 mass %, such as less than 5 mass %, such as less than 3 mass %, such as less than 1 mass %) of functionalized diluent, such as functionalized oil.

In another advantageous form, the lubricating oil composition of the instant disclosure further optionally includes one or more functionalized polymers (which may act as dispersant viscosity modifiers), such as olefin (such as ethylene-propylene) copolymers, acrylate polymers, styrenic copolymers, isoprene based polymers, and the like, at from 0.2 to 2.0 mass %, or 0.4 to 1.8 mass %, or 0.6 to 1.6 mass %, or 0.8 to 1.4 mass %, or 1.0 to 1.2 mass % of the composition.

In another advantageous form, the lubricating oil composition of the instant disclosure further optionally includes one or more functionalized copolymers described in U.S. Ser. No. 18/480,571, filed Oct. 4, 2023, such as one or more amide functionalized C₄₋₅ olefin polymers (which may act as dispersant viscosity modifiers).

In embodiments, the lubricating oil composition may comprise, may be substantially free of, or may be absent functionalized diluent, such as functionalized oil and or functionalized solvent.

In embodiments, the lubricating oil composition may comprise less than 20 mass % (such as less than 15 mass %, such as less than 10 mass %, such as less than 5 mass %, such as less than 3 mass %, such as less than 1 mass %) of solvent, such as aromatic solvent.

In embodiments, the lubricating oil composition may have a total saponification number (SAP) 25 or more (such as 28 or more, such as 30 or more, such as 32 or more) mgKOH/g, as determined by ASTM 94.

In embodiments, the lubricating compositions disclosed herein may be used in hydrogen fueled heavy-duty engines (e.g., heavy-duty vehicles having a gross vehicle weight rating of 10,000 pounds or more.)

### Concentrates

A concentrate, also referred to as an additive package, adpak, or addpack, is a composition having less than 50 mass % (such as from 1 to 40 mass %, such as from 2 to 30 mass %, such as 3 to 25 mass %, such as 4 to 20 mass %, such as 5 to 15 ass %) base oil and lubricant composition additives (such as described herein) which is typically then further blended with additional Group I, II, and or Group III base oil to form a lubricating oil product. The concentrate typically is absent Group IV base oil, such as polyalphaolefin, having a viscosity index of 100 or more, such as 120 or more, such as 140 or more as determined by ASTM D2270. Alternately the concentrate contains Group IV base oil, such as polyalphaolefin, having a viscosity index of 100 or more, such as 120 or more, such as 140 or more as determined by ASTM D2270 in amounts that the total concentration of the PAO in the final lubrication oil composition is less 70 mass % or less, such as 60 mass % or less, 50 mass % or less, such as 40 mass % or less, 30 mass % or less, such as 20 mass % or less, 10 mass % or less, such as 5 mass % or less, based upon the weight of the lubricating oil composition.

This disclosure relates to concentrate compositions comprising or resulting from the admixing of:
(i) from 1 to less than 50 mass % (alternately 2 to 45 mass %, alternately 3.5 to 40 mass %, alternately 4 to 35 mass %, alternately 5 to 25 mass %, alternately from 1 to 10 mass %), based upon the weight of the composition, of one or more base oil(s);
(ii) from 0.10 to 20 mass % (in particular 0.15 to 10 mass %, alternately 0.20 mass % to 5 mass %, alternately 0.25 to 2 mass %), based upon the weight of the composition, of one or more detergent(s);
(iii) from 0.10 to 20 mass % (in particular 0.15 to 10 mass %, alternately 0.20 mass % to 5 mass %, alternately 0.25 to 2 mass %), based upon the weight of the composition, of one or more dispersant(s) (such as PIBSA-PAM); and
(iv) from 0.10 to 20 mass % (in particular 0.15 to 10 mass %, alternately 0.20 mass % to 8 mass %, alternately 0.25 to 5 mass %), based upon the weight of the composition, of one or more zinc hydrocarbyl dithiophosphate compounds such as to provide more than 0.01 mass % (such as more than 0.10 mass %, such as 0.01 to 0.1200 mass %, such as 0.015 to 0.10 mass %) of zinc, and less than 0.08 mass % (such as less than 0.06 mass %, such as less than 0.2 mass %, such as 0.16 mass % or less of phosphorus, or alternatively such as to provide greater than or equal to 0.10 mass % and less than 0.40 mass % (such as 0.12 mass %, or 0.14 mass %, or 0.16 mass %, or 0.18 mass %, or 0.20 mass %, or 0.25 mass %, or 0.30 mass %, or 0.35 mass %) of phosphorus to the lubricating composition, based upon the weight lubricating oil composition;
(v) optional additional components, antioxidants, pour point depressants, anti-foam agents, viscosity modifiers, corrosion inhibitors, anti-wear agents, extreme pressure additives, demulsifiers, seal compatibility agents, additive diluent base oils, friction modifier(s) (such as, organic FM, such as organic ester, such as fatty acid ester), etc.

In embodiments, the concentrate composition may optionally be absent solvent (such as aliphatic or aromatic solvent) and/or absent functionalized base oil.

This disclosure also relates to concentrate compositions comprising or resulting from the admixing of:
A) from 1 to less than 50 mass % (alternately 5 to 45 mass %, alternately 7 to 40 mass %, alternately 10 to 35 mass %, alternately 10 to 25 mass %), based upon the weight of the concentrate composition, of one or more base oil(s);
B) from 0.10 to 20 mass % (in particular 0.15 to 10 mass %, alternately 0.20 mass % to 8 mass %, alternately 0.25 to 5 mass %), based upon the weight of the composition, of one or more zinc hydrocarbyl dithiophosphate compounds such as to provide more than 0.01 mass % (such as more than 0.10 mass %, such as 0.01 to 0.1200 mass %, such as 0.015 to 0.10 mass %) of zinc, and less than 0.08 mass % (such as less than 0.06 mass %, such as less than 0.2 mass %, such as 0.16 mass % or less of phosphorus, or alternatively greater than or equal to 0.10 mass % and less than 0.40 mass % (such as 0.12 mass %, or 0.14 mass %, or 0.16 mass %, or 0.18 mass %, or 0.20 mass %, or 0.25 mass %, or 0.30 mass %, or 0.35 mass %) of phosphorus to the lubricating composition, based upon the weight lubricating oil composition;
C) from 0.1 to 20 mass % (in particular 0.5 to 10 mass %, alternately 2 to 6 mass %), based on total weight of the concentrate composition, of one or more detergent(s) (such as blends of detergents);
D) optionally, from 0.01 to 5 mass % (in particular, 0.1 to 4 mass %, alternately 0.25 to 3 mass %, alternately 0.25 to 0.075 mass %), based on total weight of the concentrate composition, of one or more friction modifier(s) (such as organic friction modifiers, such as glycerol monoeoleate);
E) optionally, from 0.01 to 20 mass % (in particular, 0.01 to 15 mass %, alternately 0.1 to 10 mass %), based on total weight of the concentrate composition, of one or more antioxidant(s) (such as blends of antioxidants);
F) optionally, from 0.01 to 5 mass % (in particular, 0.01 to 3 mass %, alternately 0.1 to 1.5 mass %), based on total weight of the concentrate composition, of one or more pour point depressants (such as blends of pour point depressants);
G) optionally, from 0.001 to 5 mass % (in particular, 0.01 to 3 mass %, alternately 0.02 to 1 mass %), based on total weight of the concentrate composition, of one or more anti-foam agents (such as blends of anti-foam agents);
I) optionally, from 0.01 to 40 mass % (in particular, 0.1 to 30 mass %, alternately 1 to 20 mass %), based on total weight of the concentrate composition, of one or more dispersants (such as blends of dispersants);
K) optionally, from 0.001 to 10 mass % (in particular, 0.1 to 8 mass %, alternately 1 to 5 mass % alternately 0.25 to 0.075 mass %), based on total weight of the concentrate composition, of one or more anti-wear agents (other than the zinc hydrocarbyl diphosphates of B) above.

Concentrates may be present in the lubricating oil composition at from of 0.5 mass % to 35 mass %, such as 5 mass % to 30 mass %, such as 7.5 mass % to 25 mass %, such as 10 to 22.5 mass %, such as 15 to 20 mass %, based upon the mass of the lubricating oil composition.

In embodiments, the concentrate may comprise acylated polymers, such as polyisobutylene succinic acid, optionally, having an Mn of 500 to 50,000 g/mol, such as 600 to 5,000 g/mol, such as 700 to 3000 g/mol. In embodiments, the concentrate may comprise acylated polymers, such as polyisobutylene succinic acid, having an Mn of 500 1600 g/mol, such as 700 to 1200 g/mol.

In embodiments, the concentrate may have a kinematic viscosity at 100° C. of less than 1000 cSt, such as less than 500 cSt, such as less than 200 cSt.

### Lubricating Oil Composition Components and Concentrate Components

### A. Base Oil

The base oil (also referred to as “base stock,” “lubricating oil basestock,” or “oil of lubricating viscosity”) useful herein may be a single oil or a blend of oils, and is typically a large liquid constituent of a lubricating composition, also referred to as a lubricant, into which additives and optional additional oils are blended, for example, to produce a lubricating composition, such as a final lubricant composition, a concentrate, or other lubricating composition.

A base oil may be selected from vegetable, animal, mineral, and synthetic lubricating oils, and mixtures thereof. It may range in viscosity from light distillate mineral oils to heavy lubricating oils, such as those for gas engine oil, mineral lubricating oil, motor vehicle oil, and heavy-duty diesel oil. Generally, the kinematic viscosity at 100° C. (“KV100”) of the base oil ranges from 1 to 30 cSt, such as 2 to 25 cSt, such as 5 to 20 cSt, as determined according to ASTM D445-19a, in particular, from 1.0 cSt to 10 cSt, from 1.5 cSt to 8.3 cSt, from 2.7 cSt to 8.1 cSt, from 3.0 cSt to 7.2 cSt, or from 2.5 cSt to 6.5 cSt. Generally, the high temperature high shear (HTHS) viscosity at 150° C. of the base oil ranges from 0.5 to 20 cP such as 1 to 10 cP, such as 2 to 5 cP as determined according to ASTM D4683-20.

Typically, when lubricating oil basestock(s) is used to make a concentrate, it may advantageously be present in a concentrate-forming amount to give a concentrate containing, from 1 mass % to 20 mass %, such as from 5 mass % to 80 mass %, from 10 mass % to 70 mass %, or from 5 mass % to 50 mass % of active ingredient, based upon the weight of the concentrate.

Common oils useful as base oils include animal and vegetable oils (e.g., castor and lard oil), liquid petroleum oils, and hydrorefined and/or solvent-treated mineral lubricating oils of the paraffinic, naphthenic, and mixed paraffinic-naphthenic types. Oils derived from coal or shale are also useful base oils. Base stocks may be manufactured using a variety of different processes including, but not limited to, distillation, solvent refining, hydrogen processing, oligomerization, esterification, and re-refining.

Synthetic lubricating oils useful herein as base oils include hydrocarbon oils such as homopolymerized and copolymerized olefins, referred to as polyalphaolefins or PAO's or group IV base oils [according to the API EOLCS 1509 definition (American Petroleum Institute Publication 1509, see section E.1.3, 19th edition, January 2021, www.API.org)]. Examples of PAO's useful as base oils include: poly(ethylenes), copolymers of ethylene and propylene, polybutylenes, polypropylenes, propylene-isobutylene copolymers, chlorinated polybutylenes, poly(l-hexenes), poly(l-octenes), poly(l-decenes), homo- or co-polymers of C₈ to C₂₀ alkenes, homo- or co-polymers of C₈, and/or C₁₀, and/or C₁₂ alkenes, C₈/C₁₀ copolymers, C₈/C₁₀/C₁₂ copolymers, and C₁₀/C₁₂ copolymers, and the derivatives, analogues and homologues thereof.

In another embodiment, the base oil may comprise polyalphaolefins comprising oligomers of linear olefins having 6 to 14 carbon atoms, more preferably 8 to 12 carbon atoms, more preferably 10 carbon atoms having a Kinematic viscosity at 100° C. of 10 or more (as measured by ASTM D445); and preferably having a viscosity index (“VI”), as determined by ASTM D2270, of 100 or more, preferably 110 or more, more preferably 120 or more, more preferably 130 or more, more preferably 140 or more; and/or having a pour point of −5° C. or less (as determined by ASTM D97), more preferably −10° C. or less, more preferably −20° C. or less.

In another embodiment polyalphaolefin oligomers useful in the present disclosure may comprise C₂₀ to C₁₅₀₀ paraffins, preferably C₄₀ to C₁₀₀₀ paraffins, preferably C₅₀ to C₇₅₀ paraffins, preferably C₅₀ to C₅₀₀ paraffins. The PAO oligomers are dimers, trimers, tetramers, pentamers, etc., of C₅ to C₁₄ alpha-olefins in one embodiment, and C₆ to C₁₂ alpha-olefins in another embodiment, and C₈ to C₁₂ alpha-olefins in another embodiment. Suitable olefins include 1-pentene, 1-hexene, 1-heptene, 1-octene, 1-nonene, 1-decene, 1-undecene, and 1-dodecene. In one embodiment, the olefin is a combination of 1-octene, 1-decene, and 1-dodecene, or alternately may be substantially 1-decene, and the PAO is a mixture of dimers, trimers, tetramers, and pentamers (and higher) thereof. Useful PAO's are described more particularly in, for example, U.S. Pat. Nos. 5,171,908 and 5,783,531, and in Synthetic Lubricants and High-Performance Functional Fluids 1-52 (Leslie R. Rudnick & Ronald L. Shubkin, ed. Marcel Dekker, Inc. 1999).

PAO's useful in the present disclosure typically possess a number average molecular weight of from 100 to 21,000 g/mol in one embodiment, and from 200 to 10,000 g/mol in another embodiment, and from 200 to 7,000 g/mol in yet another embodiment, and from 200 to 2,000 g/mol in yet another embodiment, and from 200 to 500 g/mol in yet another embodiment. Desirable PAO's are commercially available as SpectraSyn™ Hi-Vis, SpectraSyn™ Low-Vis, SpectraSyn™ plus, SpectraSyn™ Elite PAO's (ExxonMobil Chemical Company, Houston Texas) and Durasyn PAO's from Ineos Oligomers USA LLC.

Synthetic lubricating oils useful as base oils also include hydrocarbon oils such as homopolymerized and copolymerized: alkylbenzenes (e.g., dodecylbenzenes, tetradecylbenzenes, dinonylbenzenes, di(2-ethylhexyl)benzenes); polyphenols (e.g., biphenyls, terphenyls, alkylated polyphenols); and alkylated diphenyl ethers, and alkylated diphenyl sulfides; and the derivatives, analogues, and homologues thereof.

In alternate embodiments, the lubricating oil composition comprises less than 50 mass % of Group IV base oil (such as the PAO's described above), such as less than 40 mass %, such as less than 30 mass %, such as less than 20 mass % such as less than 10 mass %, based upon the mass of the lubricating oil composition.

Another suitable class of synthetic lubricating oils useful as base oils comprises the esters of dicarboxylic acids (e.g., phthalic acid, succinic acid, alkyl succinic acids and alkenyl succinic acids, maleic acid, azelaic acid, suberic acid, sebasic acid, fumaric acid, adipic acid, linoleic acid dimer, malonic acid, alkylmalonic acids, alkenyl malonic acids) reacted with a variety of alcohols (e.g., butyl alcohol, hexyl alcohol, dodecyl alcohol, 2-ethylhexyl alcohol, ethylene glycol, diethylene glycol monoether, propylene glycol). Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid.

Esters useful as synthetic oils herein also include those made from C₅ to C₁₂ monocarboxylic acids and polyols, and polyol ethers such as neopentyl glycol, trimethylolpropane, pentaerythritol, dipentaerythritol, and tripentaerythritol.

Desirable ester base oils are commercially available as Esterex™ Esters (ExxonMobil Chemical Company, Houston, Texas).

Silicon-based oils such as the polyalkyl-, polyaryl-, polyalkoxy- or polyaryloxysilicone oils and silicate oils comprise another useful class of synthetic lubricants useful herein; such oils include tetraethyl silicate, tetraisopropyl silicate, tetra-(2-ethylhexyl) silicate, tetra-(4-methyl-2-ethylhexyl) silicate, tetra-(p-tert-butyl-phenyl) silicate, hexa-(4-methyl-2-ethylhexyl)disiloxane, poly(methyl) siloxanes, and poly(methylphenyl)-siloxanes.

Other synthetic lubricating oils useful herein include liquid esters of phosphorous-containing acids (e.g., tricresyl phosphate, trioctyl phosphate, diethyl ester of decylphosphonic acid) and polymeric tetrahydrofurans.

Unrefined, refined, and re-refined oils can be used in the lubricating compositions disclosed herein. Unrefined oils are those obtained directly from a natural or synthetic source without further purification treatment. For example, a shale oil obtained directly from retorting operations, a petroleum oil obtained directly from distillation, or an ester oil obtained directly from an esterification process and used without further treatment is considered an unrefined oil. Refined oils are similar to the unrefined oils except they have been further treated in one or more purification steps to improve one or more properties. Many such purification techniques, such as distillation, solvent extraction, acid or base extraction, filtration, and percolation are used by those in the art. Re-refined oils are oils obtained by processes similar to those used to obtain refined oils where the refining processes are applied to previously refined oils which have been previously used in service. Such re-refined oils are also referred to as reclaimed or reprocessed oils and often are additionally processed for removal of spent additive and oil breakdown products. A re-refined base oil is preferably substantially free from materials introduced through manufacturing, contamination, or previous use.

Other examples of useful base oils are gas-to-liquid (“GTL”) base oils, i.e., the base oil is an oil derived from hydrocarbons made from synthesis gas (“syn gas”) containing H₂ and CO using a Fischer-Tropsch catalyst. These hydrocarbons typically require further processing in order to be useful as a base oil. For example, they may, by methods known in the art, be hydroisomerized; hydrocracked and hydroisomerized; dewaxed; or hydroisomerized and dewaxed. For further information on useful GTL base oils and blends thereof, please see U.S. Pat. No. 10,913,916 (col 4, ln 62 to col 5, ln 60) and U.S. Pat. No. 10,781,397 (col 14, ln 54 to col 15, ln 5, and col 16, ln 44 to col 17, ln 55).

In particular, oils from renewable sources, i.e., based in part on carbon and energy captured from the environment, such as biological sources, are useful herein.

The various base oils are often categorized as Group I, II, III, IV, or V according to the API EOLCS 1509 definition (American Petroleum Institute Publication 1509, see section E.1.3, 19th edition, January 2021, www.API.org). Generally speaking, Group I base stocks have a viscosity index of between about 80 to 120 and contain greater than about 0.03% sulfur and/or less than about 90% saturates. Group II base stocks have a viscosity index of between about 80 to 120 and contain less than or equal to about 0.03% sulfur and greater than or equal to about 90% saturates. Group III base stocks have a viscosity index greater than about 120 and contain less than or equal to about 0.03% sulfur and greater than about 90% saturates. Group IV base stocks includes polyalphaolefins (PAO). Group V base stocks include base stocks not included in Groups I-IV, such as ester base stocks. (Viscosity index measured by ASTM D 2270, saturates is measured by ASTM D2007, and sulfur is measured by ASTM D5185, D2622, ASTM D4294, ASTM D4927, and ASTM D3120). Group I, II and III base oils are derived from petroleum, while Group IV and V base oils tend to be synthetic.

Base oils for use in the formulated lubricating compositions useful in the present disclosure are any one, two, three, or more of the variety of oils described herein. In desirable embodiments, base oils for use in the formulated lubricating compositions useful in the present disclosure are those described as API Group I (including Group I+), Group II (including Group II+), Group III (including Group III+), Group IV, and Group V oils and mixtures thereof, preferably API Group II, Group III, Group IV, and Group V oils and mixtures thereof. Likewise, in desirable embodiments, base oils for use in the formulated lubricating compositions useful in the present disclosure are those described as API Group I (including Group I+), Group II (including Group II+), Group III (including Group III+) and mixtures thereof, preferably API Group II, Group III oils and mixtures thereof. The base oil may be a Group III, Group III+, IV, and Group V base oils due to their exceptional volatility, stability, viscometric, and cleanliness features. Minor quantities of Group I basestock, such as the amount used to dilute additives for blending into formulated lube oil products, can be tolerated but are typically kept to a minimum, e.g., amounts only associated with their use as diluent/carrier oil for additives used on an “as-received” basis. In regard to the Group II basestocks, it is often more useful that the Group II base stock be in the higher quality range associated with that base stock, i.e., a Group II base stock having a viscosity index in the range from 100 to 120.

The base oil useful herein may be selected from any of the synthetic, natural, or re-refined oils (such as those typically used as crankcase lubricating oils for spark-ignited and compression-ignited engines). Mixtures of synthetic and/or natural and/or re-refined base oils may be used if desired. Multi-modal mixtures (such as bi- or tri-modal mixtures) of Group I, II, III, IV, and/or V base stocks may be used if desired. Multi-modal mixtures (such as bi-, tri- or tetra-modal mixtures) of Group I, Group II, and or Group III base stocks with 70 mass % or less, such as 60 mass % or less, 50 mass % or less, such as 40 mass % or less, 30 mass % or less, such as 20 mass % or less, 10 mass % or less, such as 5 mass % or less, or such as absent Group IV base stocks, such as PAO's, may be used if desired.

The base oil or base oil blend used herein conveniently has a kinematic viscosity at 100° C. (KV100, as measured according to ASTM D445-19a, and reported in units of centistoke (cSt) or it its equivalent, mm²/s), of about 2 to about 40 cSt, alternately of 3 to 30 cSt, alternately 4 to 20 cSt at 100° C., alternately 5 to 10 cSt, alternately the base oil or base oil blend may have a kinematic viscosity at 100° C. of 2 to 20 cSt, of 2.5 to 2 cSt, and preferably of about 2.5 cSt to about 9 cSt.

The base oil or base oil blend preferably has a saturate content of at least 65 mass %, more preferably at least 75 mass %, such as at least 85 mass %, such as at least than 90 mass % as determined by ASTM D2007.

Preferably, the base oil or base oil blend will have a sulfur content of less than 1 mass %, preferably less than 0.6 mass %, most preferably less than 0.4 mass %, such as less than 0.3 mass %, based on the total mass of the lubricating composition, as measured by ASTM D5185.

In embodiments, the volatility of the base oil or base oil blend, as measured by the Noack test (ASTM D5800, procedure B), is less than or equal to 30 mass %, such as less than or equal to 25 mass %, such as less than or equal to 20 mass %, such as less than or equal to 16 mass %, such as less than or equal to 12 mass %, such as less than or equal to 10 mass %, based on the total mass of the lubricating composition.

In embodiments, the viscosity index (VI) of the base oil is at least 95, preferably at least 110, more preferably at least 120, even more preferably at least 125, most preferably from about 130 to 240, in particular from about 105 to 140 (as determined by ASTM D2270).

The base oil may be provided in a major amount, in combination with a minor amount of one or more additive components as described hereinafter, constituting a lubricant. This preparation may be accomplished by adding the additives directly to the oil or by adding the one or more additives in the form of a concentrate thereof to disperse or dissolve the additive(s). Additives may be added to the oil by any method known to those skilled in the art, either before, at the same time as, or after addition of other additives.

The base oil may be provided in a minor amount, in combination with minor amounts of one or more additive components as described hereinafter, constituting an additive concentrate. This preparation may be accomplished by adding the additives directly to the oil or by adding the one or more additives in the form of a solution, slurry or suspension thereof to disperse or dissolve the additive(s) in the oil. Additives may be added to the oil by any method known to those skilled in the art, either before, at the same time as, or after addition of other additives.

The base oil typically constitutes the major component of an engine oil lubricant composition of the present disclosure and typically is present in an amount ranging from about 50 to about 99 mass %, preferably from about 70 to about 95 mass %, and more preferably from about 80 to about 95 mass %, based on the total weight of the composition.

Typically, one or more base oils are present in the lubricating composition in an amount of 32 mass % or more, alternately 55 mass % or more, alternately 60 mass % or more, alternately 65 mass % or more, based on the total weight of the lubricating composition. Typically, one or more base oils are present in the lubricating composition at an amount of 98 mass % or less, more preferably 95 mass % or less, even more preferably 90 mass % or less. Alternately, one or more base oils are present in the lubricating composition at from 1 to 99 mass %, alternately 50 to 97 mass %, alternately to 60 to 95 mass %, alternately 70 to 95 mass %, based upon the weight of the lubricating composition.

The base oils and blends thereof described above are also useful for making concentrates as well as for making lubricants therefrom.

Concentrates constitute a convenient means of handling additives before their use, as well as facilitating solution or dispersion of additives in lubricants. When preparing a lubricant that contains more than one type of additive (sometime referred to as “additive components”), each additive may be incorporated separately, each in the form of a concentrate. In many instances, however, it is convenient to provide a so-called additive “package” (also referred to as an “addpack”) comprising one or more additives/co-additives, such as described hereinafter, in a single concentrate.

Typically, one or more base oils are present in the concentrate composition in an amount of 50 mass % or less, alternately 40 mass % or less, alternately 30 mass % or less, alternately 20 mass % or less, based on the total weight of the concentrate composition. Typically, one or more base oils are present in the concentrate composition at an amount of 0.1 to 49 mass %, alternately 5 to 40 mass %, alternately to 10 to 30 mass %, alternately 15 to 25 mass %, based upon the weight of the concentrate composition.

### B. Zinc Hydrocarbyl Dithiophosphate Compounds

In embodiments, the one or more zinc hydrocarbyl dithiophosphate compounds are zinc dihydrocarbyl dithiophosphate compounds (ZDDP's), such as zinc dialkyl dithiophosphate compounds. The hydrocarbyl groups of the zinc hydrocarbyl dithiophosphate compounds (such as the zinc dihydrocarbyl dithiophosphate compounds) may be the same or different hydrocarbyl groups. The alkyl groups of the zinc dialkyl dithiophosphate compounds may be the same or different alkyl groups.

Zinc dihydrocarbyl dithiophosphate compounds that may be used herein are generally represented by the formula Zn[SP(S)(OR¹)(OR²)]₂ where R¹ and R² are, independently, C₁₋₃₀ hydrocarbyl groups, such as C₁₋₁₈ hydrocarbyl groups, such as C₁-C₁₈ alkyl groups and/or C₁-C₂₄ alkyl-aryl groups, and/or C₅₋₃₀ aryl groups, such as C₂-C₁₂ alkyl or aryl groups (such as C₄-C₁₂ alkyl groups) such as methyl, ethyl, propyl, butyl, pentyl, hexyl, heptyl, octyl, nonyl or decyl, phenyl, naphthyl, alkyl substituted phenyl, or isomers thereof. The hydrocarbyl groups (such as alkyl groups) may be straight chain (linear), cyclic and/or branched.

For ease of reference when a zinc hydrocarbyl dithiophosphate compounds (such as zinc dihydrocarbyl dithiophosphate compounds and zinc dialkyl dithiophosphate compounds) are referred to as being derived from one or more alcohols, it is understood that it is the hydrocarbyl groups (such as the alkyl groups) that are derived from the alcohols. The zinc dihydrocarbyl dithiophosphate compounds (such as zinc dialkyl dithiophosphate compounds) may be derived from primary alcohols, secondary alcohols or mixtures thereof. In embodiments, the hydrocarbyl group of the zinc dihydrocarbyl dithiophosphate is derived from one or more primary alcohols, one or more secondary alcohols and or a combination of primary and secondary alcohols. In particular, C₁-C₁₈ primary alcohols, mixtures of C₁-C₁₈ primary alcohols, C₁-C₁₈ secondary alcohols, mixtures of C₁-C₁₈ secondary alcohols, and or mixtures of C₁-C₁₈ primary and C₁-C₁₈ secondary alcohols can be used to prepare the zinc hydrocarbyl dithiophosphate compounds described herein.

Alcohols used to produce the hydrocarbyl groups of the zinc dihydrocarbyl dithiophosphate compounds include alcohols represented by the formula: R^{z}—OH, where R^{z} is one or more of C₁₋₃₀ hydrocarbyl groups, such as C₁₋₁₈ hydrocarbyl groups, such as C₁-C₁₈ alkyl groups and/or C₁-C₂₄ alkyl-aryl groups, and/or C₅₋₃₀ aryl groups, such as C₂-C₁₂ alkyl or aryl groups (such as C₄-C₁₂ alkyl groups) such as methyl, ethyl, propyl, butyl, pentyl, hexyl, heptyl, octyl, nonyl or decyl, phenyl, naphthyl, alkyl substituted phenyl, or isomers thereof, where the hydrocarbyl groups (such as alkyl groups) may be straight chain (linear), cyclic and/or branched. In preferred embodiments, alcohols used to produce the zinc dihydrocarbyl dithiophosphate compounds include but are not limited to one or more of ethanol, 2-propanol, butanol, secondary butanol, pentanols, hexanols such as 4-methyl-2-pentanol, n-hexanol, n-octanol, 2-ethyl hexanol, alcohols of alkyl aryl groups (such as alkylated phenols), and the like.

Useful zinc dithiophosphates include zinc dithiophosphates such as those available from The Lubrizol Corporation under the trade designations “LZ™ 677A”, “LZ™ 1095” and “LZ™ 1371”, from Chevron Oronite under the trade designation “OLOA™ 262” and from Afton Chemical under the trade designation “HiTEC™ 7169”.

The zinc dihydrocarbyl dithiophosphate compounds (such as zinc dihydrocarbyl dithiophosphate compounds, such as zinc dialkyl dithiophosphate compounds) are typically used in amounts of from about 0.01 mass % to about 5 mass %, from about 0.05 mass % to about 3 mass %, from about 0.4 mass % to about 1.2 mass %, from about 0.1 mass % to about 1.0 mass %, preferably from about 0.5 mass % to about 1.0 mass %, and more preferably from about 0.6 mass % to about 0.8 mass %, based on the total weight of the lubricating composition, although more or less can often be used advantageously.

In embodiments, the zinc dihydrocarbyl dithiophosphate compounds comprise secondary ZDDP's (i.e., derived from secondary alcohols), and are present in the lubricating oil composition at an amount of from 0.1 to 5.0 mass % of the total weight of the lubricating composition.

In embodiments, the zinc dihydrocarbyl dithiophosphate compounds comprise mixed primary and secondary ZDDP's (i.e., derived from a mixture of primary and secondary alcohols or are a mixture of a ZDDP derived from a primary alcohol and a ZDDP derived from a secondary alcohol), and are present in the lubricating oil composition at from about 0.1 to 5.0 mass % of the total weight of the lubricating composition.

Examples of zinc dialkyldithiophosphate compounds useful herein include one or more compounds represented by the following general formula:

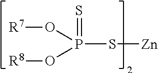

In the formula above, R⁷ and R⁸ each independently represent a primary or secondary alkyl group having 3 to 22 carbon atoms or an alkylaryl group substituted with an alkyl group having 3 to 18 carbon atoms. Examples of primary or secondary alkyl groups having 3 to 22 carbon atoms include a primary or secondary propyl group, a primary or secondary butyl group, a primary or secondary pentyl group, a primary or secondary hexyl group, a primary or secondary heptyl group, a primary or secondary octyl group, a primary or secondary nonyl group, a primary or secondary decyl group, a primary or secondary dodecyl group, a primary or secondary tetradecyl group, a primary or secondary hexadecyl group, a primary or secondary octadecyl group, a primary or secondary eicosyl group, and the like. Examples of the alkylaryl group substituted with an alkyl group having 3 to 18 carbon atoms include a propylphenyl group, a pentylphenyl group, an octylphenyl group, a nonylphenyl group, a dodecylphenyl group, and the like.

The lubricating composition according to the present disclosure may further comprise one or more additives such as detergents, friction modifiers, antioxidants, pour point depressants, anti-foam agents, viscosity modifiers, dispersants, corrosion inhibitors, anti-wear agents, extreme pressure additives, demulsifiers, seal compatibility agents, additive diluent base oils, etc. Specific examples of such additives are described in, for example, Kirk-Othmer Encyclopedia of Chemical Technology, third edition, volume 14, pp. 477-526, and several are discussed in further detail below.

### C. Detergents

The lubricating composition may comprise one or more metal detergents (such as blends of metal detergents) also referred to as a “detergent additive.” Metal detergents typically function both as detergents to reduce or remove deposits and as acid neutralizers or rust inhibitors, thereby reducing wear and corrosion and extending engine life. Detergents generally comprise a polar head with a long hydrophobic tail, with the polar head comprising a metal salt of an acidic organic compound. The salts may contain a substantially stoichiometric amount of the metal in which case they are usually described as normal or neutral salts, and would typically have a total base number (“TBN” as measured by ASTM D2896) of up to 150 mgKOH/g, such as from 0 to 80 (or 5-30) mgKOH/g. A large amount of a metal base may be incorporated by reacting excess metal compound (e.g., an oxide or hydroxide) with an acidic gas (e.g., carbon dioxide). Such detergents, sometimes referred to as overbased, may have a TBN of 100 mgKOH/g or more (such as 200 mgKOH/g or more), and typically will have a TBN of 250 mgKOH/g or more, such as 300 mgKOH/g or more, such as from 200 to 800 mgKOH/g, 225 to 700 mgKOH/g, 250 to 650 mgKOH/g, or 300 to 600 mgKOH/g, such as 150 to 650 mgKOH/g.

Suitable detergents include, oil-soluble neutral and overbased sulfonates, phenates, sulfurized phenates, thiophosphonates, salicylates, naphthenates and other oil-soluble carboxylates of a metal, particularly the alkali metals (Group 1 metals, e.g., Li, Na, K, Rb) or alkaline earth metals (Group 2 metals, e.g., Be, Mg, Ca, Sr, Ba), particularly, sodium, potassium, lithium, calcium, and magnesium, such as Ca and/or Mg. Furthermore, the detergent may comprise a hybrid detergent comprising any combination of sodium, potassium, lithium, calcium, or magnesium salts of sulfonates, phenates, sulfurized phenates, thiophosphonates, salicylates, and naphthenates or other oil-soluble carboxylates of a Group 1 and/or 2 metal.

Preferably, the detergent additive(s) useful in the present disclosure comprises calcium and/or magnesium metal salts. The detergent may be a calcium and/or magensium carboxylate (e.g., salicylates), sulfonate, or phenate detergent. More preferably, the detergent additives are selected from magnesium salicylate, calcium salicylate, magnesium sulfonate, calcium sulfonate, magnesium phenate, calcium phenate, and hybrid detergents comprising two, three, four, or more of more of these detergents and/or combinations thereof.

The metal-containing detergent may also include “hybrid” detergents formed with mixed surfactant systems including phenate and/or sulfonate components, e.g., phenate/salicylates, sulfonate/phenates, sulfonate/salicylates, sulfonates/phenates/salicylates, as described, for example, in U.S. Pat. Nos. 6,429,178; 6,429,179; 6,153,565; and 6,281,179. Where, for example, a hybrid sulfonate/phenate detergent is employed, the hybrid detergent would be considered equivalent to amounts of distinct phenate and sulfonate detergents introducing like amounts of phenate and sulfonate soaps, respectively.

The metal-containing detergent may also include polyolefin substituted hydroxy-aromatic carboxylic acid or salt thereof where the polyolefin is derived from a branched alkene having at least 4 carbon atoms and wherein the polyolefin has a number average molecular weight of 150 to 800 g/mol, (such as those disclosed in US 2022/0073836), such as a such as a salicylate detergent.

The overbased metal-containing detergent may be sodium salts, calcium salts, magnesium salts, or mixtures thereof of the phenates, sulfur-containing phenates, sulfonates, salixarates, and salicylates. Overbased phenates and salicylates typically have a total base number of 180 to 650 mgKOH/g, such as 200 to 450 TBN mgKOH/g. Overbased sulfonates typically have a total base number of 250 to 600 mgKOH/g, or 300 to 500 mgKOH/g. In embodiments, the sulfonate detergent may be predominantly a linear alkylbenzene sulfonate detergent having a metal ratio of at least 8 as is described in paragraphs [0026] to [0037] of US Patent Application Publication No. 2005/065045 (and granted as U.S. Pat. No. 7,407,919). The overbased detergent may be present at 0 mass % to 15 mass %, or 0.1 mass % to 10 mass %, or 0.2 mass % to 8 mass %, or 0.2 mass % to 3 mass %, based upon of the lubricating composition. For example, in a heavy-duty diesel engine, the detergent may be present at 2 mass % to 3 mass % of the lubricating composition. For a passenger car engine, the detergent may be present at 0.2 mass % to 1 mass % of the lubricating composition.

The detergent additive(s) may comprise one or more magnesium sulfonate detergents. The magnesium detergent may be a neutral salt or an overbased salt. Suitably the magnesium detergent is an overbased magnesium sulfonate having a TBN of from 80 to 650 mgKOH/g (ASTM D2896), such as 200 to 500 mgKOH/g, such as 240 to 450 mgKOH/g.

Alternately, the detergent additive(s) is a magnesium salicylate, optionally having a TBN of from 30 to 650 mgKOH/g (ASTM D2896), such as 50 to 500 mgKOH/g, such as 200 to 500 mgKOH/g, such as 240 to 450 mgKOH/g or alternately of 150 mgKOH/g or less, such as 100 mgKOH/g or less.

The magnesium detergent typically provides the lubricating composition thereof with from 200-4000 ppm of magnesium atoms, suitably from 200-2000 ppm, from 300 to 1500 or from 450-1200 ppm of magnesium atoms (ASTM D5185).

The detergent composition may comprise (or consist of) a combination of one or more magnesium sulfonate detergents and one or more calcium salicylate detergents. Alternately, the detergent additive(s) is a combination of magnesium salicylate and magnesium sulfonate.

The combination of one or more magnesium sulfonate detergents and one or more calcium salicylate detergents optionally provides the lubricating composition thereof with: 1) from 200-4000 ppm of magnesium atoms, suitably from 200-2000 ppm, from 300 to 1500 ppm or from 450-1200 ppm of magnesium atoms (ASTM D5185), and 2) at least 500 ppm, preferably at least 750 ppm, more preferably at least 900 ppm of atomic calcium, such as from 500-4000 ppm, preferably from 750-3000 ppm, more preferably from 900-2000 ppm atomic calcium (ASTM D5185).

The detergent may comprise one or more calcium detergents such as calcium carboxylate (e.g., salicylate), sulfonate, or phenate detergent.

Suitably the calcium detergent has a TBN of from 30 to 700 mgKOH/g (ASTM D2896), such as 50 to 650 mgKOH/g, such as 200 to 500 mgKOH/g, such as 240 to 450 mgKOH/g or alternately of 150 mgKOH/g or less, such as 100 mgKOH/g or less, or 200 mgKOH/g or more, or 300 mgKOH/g or more, or 350 mgKOH/g or more.

Suitably, the calcium detergent is a calcium salicylate, sulfonate, or phenate having a TBN of from 30 to 700 mgKOH/g, 30 to 650 mgKOH/g (ASTM D2896), such as 50 to 650 mgKOH/g, such as 200 to 500 mgKOH/g, such as 240 to 450 mgKOH/g or alternately of 150 mgKOH/g or less, such as 100 mgKOH/g or less, or 200 mgKOH/g or more, or 300 mgKOH/g or more, or 350 mgKOH/g or more.

Calcium detergent is typically present in amount sufficient to provide at least 500 ppm, preferably at least 750 more preferably at least 900 ppm atomic calcium to the lubricating oil composition (ASTM D5185). If present, any calcium detergent is suitably present in amount sufficient to provide no more than 4000 ppm, preferably no more than 3000 ppm, more preferably no more than 2000 ppm atomic calcium to the lubricating oil composition (ASTM D5185). If present, any calcium detergent is suitably present in amount sufficient to provide at from 500-4000 ppm, preferably from 750-3000 ppm more preferably from 900-2000 ppm atomic calcium to the lubricating oil composition (ASTM D5185).

Suitably the total atomic amount of metal from detergent in the lubrication composition according to all aspects of the disclosure is no more than 5000 ppm, preferably no more than 4000 pm and more preferably no more than 2000 ppm (ASTM D5185). The total amount of atomic metal from detergent in the lubrication oil composition according to all aspects of the disclosure is suitably at least 500 ppm, preferably at least 800 ppm and more preferably at least 1000 ppm (ASTM D5185). The total amount of atomic metal from detergent in the lubrication oil composition according to all aspects of the disclosure is suitably from 500 to 5000 ppm, preferably from 500 to 3000 ppm and more preferably from 500 to 2000 ppm (ASTM D5185).

Sulfonate detergents may be prepared from sulfonic acids which are typically obtained by the sulfonation of alkyl substituted aromatic hydrocarbons, such as those obtained from the fractionation of petroleum or by the alkylation of aromatic hydrocarbons. Examples include those obtained by alkylating benzene, toluene, xylene, naphthalene, diphenyl, or their halogen derivatives such as chlorobenzene, chlorotoluene, and chloronaphthalene. The alkylation may be carried out in the presence of a catalyst with alkylating agents having from about 3 to more than 70 carbon atoms. The alkaryl sulfonates usually contain from about 9 to about 80 or more carbon atoms, preferably from about 16 to about 60 carbon atoms per alkyl substituted aromatic moiety. The oil soluble sulfonates or alkaryl sulfonic acids may be neutralized with oxides, hydroxides, alkoxides, carbonates, carboxylate, sulfides, hydrosulfides, nitrates, borates and ethers of the metal. The amount of metal compound is chosen having regard to the desired TBN of the final product, but typically ranges from about 100 to 220 mass % (preferably at least 125 mass %) of that stoichiometrically required.

Metal salts of phenols and sulfurized phenols are prepared by reaction with an appropriate metal compound such as an oxide or hydroxide and neutral or overbased products may be obtained by methods well known in the art. Sulfurized phenols may be prepared by reacting a phenol with sulfur or a sulfur-containing compound such as hydrogen sulfide, sulfur monohalide, or sulfur dihalide, to form products which are generally mixtures of compounds in which 2 or more phenols are bridged by sulfur-containing bridges.

Carboxylate detergents, e.g., salicylates, can be prepared by reacting an aromatic carboxylic acid (such as a C₅₋₁₀₀, C₉₋₃₀, C₁₄₋₂₄ alkyl-substituted hydroxy-benzoic acid) with an appropriate metal compound such as an oxide or hydroxide and neutral or overbased products may be obtained by methods well known in the art. The aromatic moiety of the aromatic carboxylic acid can contain heteroatoms, such as nitrogen and oxygen. Preferably, the moiety contains only carbon atoms; more preferably the moiety contains six or more carbon atoms; for example, benzene is a preferred moiety. The aromatic carboxylic acid may contain one or more aromatic moieties, such as one or more benzene rings, either fused or connected via alkylene bridges.

Preferred substituents in oil-soluble salicylic acids are alkyl substituents, which may be linear or branched. In alkyl-substituted salicylic acids, the alkyl groups advantageously contain 1 to 500, such as 5 to 100, preferably 9 to 30, especially 14 to 20, carbon atoms. Where there is more than one alkyl group, the average number of carbon atoms in all of the alkyl groups is preferably at least 9 to ensure adequate oil solubility.

Alternately, salicylate detergent useful herein may be selected from the salicylate detergents disclosed in US 2022/0073836. Such detergents comprise polyisobutylene (Mn 100 to 900 g/mol, such as 150 to 400 g/mol) substituted phenols as part of the alkyl salicylate moiety of an alky salicylate metal salt.

Further, as metal organic and inorganic base salts, which are used as detergents can contribute to the sulfated ash content of a lubricating oil composition, in embodiments of the present disclosure, the amounts of such additives are minimized. In order to maintain a low sulfur level, salicylate detergents can be used and the lubricating composition herein may comprise one or more salicylate detergents (said detergents are preferably used in amounts in the range of 0.05 to 20.0 mass %, more preferably from 1.0 to 10.0 mass % and most preferably in the range of from 2.0 to 5.0 mass %, based on the total weight of the lubricating composition).

The total sulfated ash content of the lubricating composition herein is typically not greater than 2.0 mass %, alternately at a level of not greater than 1.0 mass % and alternately at a level of not greater than 0.8 mass %, based on the total weight of the lubricating composition as determined by ASTM D874.

Furthermore, it is useful that each of the detergents, independently, have a TBN (total base number) value in the range of from 10 to 700 mgKOH/g, 10 to 500 mgKOH/g, alternately in the range of from 100 to 650, alternately in the range of from 10 to 500 mgKOH/g, alternately in the range of from 30 to 350 mgKOH/g, and alternately in the range of from 50 to 300 mgKOH/g, as measured by ISO 3771.

The sulfonate detergents (such as Ca and/or Mg sulfonate detergents) may be present in an amount to deliver 0.1 mass % to 1.5 mass %, or 0.15 to 1.2 mass %, or 0.2 mass % to 0.9 mass % sulfonate soap to the lubricant composition.

The salicylate detergents (such as Ca and/or Mg salicylate detergents) are present in an amount to deliver 0.3 mass % to 1.4 mass %, or 0.35 mass % to 1.2 mass %, or 0.4 mass % to 1.0 mass % salicylate soap to the lubricant composition.

The sulfonate soap may be present in an amount 0.2 mass % to 0.8 mass % of the lubricant composition, and the salicylate soap may be present in an amount 0.3 mass % to 1.0 mass % of the lubricant composition.

The total of all alkaline earth metal detergent soap may be present in an amount 0.6 mass % to 2.1 mass %, or 0.7 mass % to 1.4 mass % of the lubricant composition.

Typically, lubricating compositions formulated for use in heavy-duty diesel engines comprise detergents at from about 0.1 to about 10 mass %, alternately from about 0.5 to about 7.5 mass %, alternately from about 1 to about 6.5 mass %, based on the lubricating composition.

Typically, lubricating compositions formulated for use in a passenger-car engines comprise detergents at from about 0.1 to about 10 mass %, alternately from about 0.5 to about 7.5 mass %, alternately from about 1 to about 6.5 mass %, based on the lubricating composition.

Typically, lubricating compositions formulated for use in a drive train (e.g., transmissions) comprise detergents at from about 0.1 to about 10 mass %, alternately from about 0.5 to about 7.5 mass %, alternately from about 2 to about 6.5 mass %, based on the lubricating composition.

Optionally, phenate is substantially absent or absent from the detergent in the lubricating oil composition.

### D. Friction Modifiers

A friction modifier is any material or materials that can alter the coefficient of friction of a surface lubricated by any lubricant or fluid-containing such material(s). Friction modifiers, also known as friction reducers, or lubricity agents or oiliness agents, and other such agents that change the ability of base oils, formulated lubricating compositions, or functional fluids, to modify the coefficient of friction of a lubricated surface may be effectively used in combination with the base oils or lubricating compositions disclosed herein if desired. Friction modifiers that lower the coefficient of friction are particularly advantageous in combination with the base oils and lubricating compositions of this disclosure.

Illustrative friction modifiers may include, for example, organometallic compounds or materials, or mixtures thereof. Illustrative organometallic friction modifiers useful in the lubricating oil formulations of this disclosure include, for example, tungsten and/or molybdenum compounds, such as molybdenum amine, molybdenum diamine, an organotungstenate (such as Molyvan™ W-324 from Vanderbuilt Chemicals LLC), a molybdenum dithiocarbamate, molybdenum dithiophosphates, molybdenum amine complexes, molybdenum carboxylates, and the like, and mixtures thereof. Examples of useful molybdenum-containing compounds may conveniently include molybdenum dithiocarbamates, trinuclear molybdenum compounds, for example, as described in PCT Publication No. WO 98/26030, sulfides of molybdenum and molybdenum dithiophosphate, dimers Sakura Lube™ 515, 525, and Molyvan 3000 dimers. Other known friction modifiers comprise oil-soluble organo-molybdenum compounds (Moly van™ 855), MoDDP, MoDTC, and the like. Such organo-molybdenum friction modifiers may also provide antioxidant and anti-wear credits to a lubricating oil composition. Examples of such oil-soluble organo-molybdenum compounds include dithiocarbamates, dithiophosphates, dithiophosphinates, xanthates, thioxanthates, sulfides, and the like, and mixtures thereof. Particularly preferred are molybdenum dithiocarbamates, dialkyldithiophosphates, alkyl xanthates and alkylthioxanthates.

Additionally, the molybdenum compound may be an acidic molybdenum compound. These compounds will react with a basic nitrogen compound as measured by ASTM test D664 or D2896 titration procedure and are typically hexavalent. Included are molybdic acid, ammonium molybdate, sodium molybdate, potassium molybdate, and other alkali metal molybdates and other molybdenum salts, e.g., hydrogen sodium molybdate, MoOC₁₄, MoO₂Br₂, Mo₂O₃C₁₆, molybdenum trioxide or similar acidic molybdenum compounds.

Among the molybdenum compounds useful in the compositions of this disclosure are organo-molybdenum compounds of the formula: Mo(R″OCS₂)₄ and Mo(R″SCS₂)₄, wherein R″ is an organo group selected from the group consisting of alkyl, aryl, aralkyl and alkoxyalkyl, generally of from 1 to 30 carbon atoms, and preferably 2 to 12 carbon atoms and most preferably alkyl of 2 to 12 carbon atoms. Especially preferred are the dialkyldithiocarbamates of molybdenum.

Another group of organo-molybdenum compounds useful in the lubricating compositions of this disclosure are trinuclear molybdenum compounds, especially those of the formula Mo₃SₖLₙQ_{z} and mixtures thereof wherein the L are independently selected ligands having organo groups with a sufficient number of carbon atoms to render the compound soluble or dispersible in the oil, n is from 1 to 4, k varies from 4 to 7, Q is selected from the group of neutral electron-donating compounds such as water, amines, alcohols, phosphines, and ethers, and z ranges from 0 to 5 and includes non-stoichiometric values. At least 21 carbon atoms should be present among all the ligand/organo groups, such as at least 25, at least 30, or at least 35 carbon atoms.

Lubricating oil compositions useful in all aspects of the present disclosure preferably contain at least 1 ppm, at least 10 ppm, at least 30 ppm, at least 40 ppm and more preferably at least 50 ppm molybdenum. Suitably, lubricating oil compositions useful in all aspects of the present disclosure contain no more than 1000 ppm, no more than 750 ppm, or no more than 500 ppm of molybdenum. Lubricating oil compositions useful in all aspects of the present disclosure preferably contain from 10 to 1000, such as 30 to 750 or 40 to 500, ppm of molybdenum (measured as atoms of molybdenum). Alternately, the lubricating oil compositions useful in all aspects of the present disclosure preferably contain 0 ppm Mo.

For more information or useful friction modifiers containing Mo, please see U.S. Pat. No. 10,829,712 (col 8, ln 58 to col 11, ln 31).

Ashless friction modifiers may be present in the lubricating oil compositions of the present disclosure and are known generally and include esters formed by reacting carboxylic acids and anhydrides with alkanols and amine-based friction modifiers. Other useful friction modifiers generally include a polar terminal group (e.g., carboxyl or hydroxyl) covalently bonded to an oleophilic hydrocarbon chain. Esters of carboxylic acids and anhydrides with alkanols are described in U.S. Pat. No. 4,702,850. Examples of other conventional organic friction modifiers are described by M. Belzer in the “Journal of Tribology” (1992), Vol. 114, pp. 675-682 and M. Belzer and S. Jahanmir in “Lubrication Science” (1988), Vol. 1, pp. 3-26. Typically, the total amount of organic ashless friction modifier in a lubricant according to the present disclosure does not exceed 5 mass %, based on the total mass of the lubricating oil composition and preferably does not exceed 2 mass % and more preferably does not exceed 0.5 mass %.

Illustrative friction modifiers useful in the lubricating compositions described herein include, for example, alkoxylated fatty acid esters, alkanolamides, polyol fatty acid esters, borated glycerol fatty acid esters, fatty alcohol ethers, and mixtures thereof.

Illustrative alkoxylated fatty acid esters include, for example, polyoxyethylene stearate, fatty acid polyglycol ester, and the like. These can include polyoxypropylene stearate, polyoxybutylene stearate, polyoxyethylene isosterate, polyoxypropylene isostearate, polyoxyethylene palmitate, and the like.

Illustrative alkanolamides include, for example, lauric acid diethylalkanolamide, palmic acid diethylalkanolamide, and the like. These can include oleic acid diethyalkanolamide, stearic acid diethylalkanolamide, oleic acid diethylalkanolamide, polyethoxylated hydrocarbylamides, polypropoxylated hydrocarbylamides, and the like.

Illustrative polyol fatty acid esters include, for example, glycerol monooleate, saturated mono-, di-, and triglyceride esters, glycerol monostearate, and the like. These can include polyol esters, hydroxyl-containing polyol esters, and the like.

Illustrative borated glycerol fatty acid esters include, for example, borated glycerol monooleate, borated saturated mono-, di-, and tri-glyceride esters, borated glycerol monosterate, and the like. In addition to glycerol polyols, these can include trimethylolpropane, pentaerythritol, sorbitan, and the like. These esters can be polyol monocarboxylate esters, polyol dicarboxylate esters, and on occasion polyoltricarboxylate esters. Preferred can be the glycerol monooleates, glycerol di-oleates, glycerol tri-oleates, glycerol mono-oleates, glycerol di-stearates, and glycerol tri-stearates and the corresponding glycerol mono-palmitates, glycerol di-palmitates, and glycerol tri-palmitates, and the respective isostearates, linoleates, and the like. Ethoxylated, propoxylated, and/or butoxylated fatty acid esters of polyols, especially using glycerol as underlying polyol are useful herein.

Illustrative fatty alcohol ethers include, for example, stearyl ether, myristyl ether, and the like. Alcohols, including those that have carbon numbers from C₃ to C₅₀, can be ethoxylated, propoxylated, or butoxylated to form the corresponding fatty alkyl ethers. The underlying alcohol portion can preferably be stearyl, myristyl, C₁₁-C₁₃ hydrocarbon, oleyl, isosteryl, and the like.

Useful concentrations of friction modifiers may range from 0.01 mass % to 5 mass %, or about 001 mass % to about 2.5 mass %, or about 0.05 mass % to about 1.5 mass %, or about 0.051 mass % to about 1 mass %. Concentrations of molybdenum-containing materials are often described in terms of Mo metal concentration. Advantageous concentrations of Mo may range from 25 ppm to 700 ppm or more, and often with a preferred range of 50-200 ppm. Friction modifiers of all types may be used alone or in mixtures with the materials of this disclosure. Often mixtures of two or more friction modifiers, or mixtures of friction modifier(s) with alternate surface-active material(s), are also desirable. For example, combinations of Mo-containing compounds with polyol fatty acid esters, such as glycerol mono-oleate are useful herein.

### E. Antioxidants

Antioxidants retard the oxidative degradation of base oils during service. Such degradation may result in deposits on metal surfaces, the presence of sludge, a viscosity increase in a lubricant, and the like. A wide variety of oxidation inhibitors that are useful in lubricating oil compositions. See Lubricants and Related Products, Klamann, Wiley VCH, 1984; U.S. Pat. Nos. 4,798,684 and 5,084,197, for example.

Useful antioxidants include hindered phenols. These phenolic antioxidants may be ashless (metal-free) phenolic compounds or neutral or basic metal salts of certain phenolic compounds. Typical phenolic antioxidant compounds are the hindered phenolics, which contain a sterically hindered hydroxyl group, and these include those derivatives of dihydroxy aryl compounds in which the hydroxyl groups are in the o- or p-position to each other. Typical phenolic antioxidants include the hindered phenols substituted with C₆₊ alkyl groups and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include, for example, hindered 2,6-di-alkyl-phenolic proprionic ester derivatives. Bis-phenolic antioxidants may also be advantageously used herein. Examples of ortho-coupled phenols include: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include, for example, 4,4′-bis(2,6-di-t-butyl-phenol) and 4,4′-methylene-bis(2,6-di-t-butyl-phenol).

Effective amounts of one or more catalytic antioxidants may also be used. The catalytic antioxidants comprise an effective amount of a) one or more oil soluble polymetal organic compounds; and, effective amounts of b) one or more substituted diphenyl amine (such as N,N′-diaryl-o-phenylenediamine) compounds or c) one or more hindered phenol compounds; or a combination of both b) and c). Catalytic antioxidants useful herein are more fully described in U.S. Pat. No. 8,048,833.

Non-phenolic oxidation inhibitors, which may be used include aromatic amine antioxidants and these may be used either as such or in combination with phenolics. Typical examples of non-phenolic antioxidants include: alkylated and non-alkylated aromatic amines such as aromatic monoamines of the formula R₈R₉R₁₀N, where R₈ is an aliphatic, aromatic or substituted aromatic group, R₉ is an aromatic or a substituted aromatic group, and R₁₀ is H, alkyl, aryl or R₁₁S(O)XR₁₂ where R₁₁ is an alkylene, alkenylene, or aralkylene group, R₁₂ is an alkyl group, or an alkenyl, aryl, or alkaryl group, and x is 0, 1, or 2. The aliphatic group R₈ may contain from 1 to about 20 carbon atoms, and preferably contains from about 6 to 12 carbon atoms. The aliphatic group is typically a saturated aliphatic group. Preferably, both R₈ and R₉ are aromatic or substituted aromatic groups, and the aromatic group may be a fused ring aromatic group such as naphthyl. Aromatic groups R₈ and R₉ may be joined together with other groups such as S.

Typical aromatic amines antioxidants have alkyl substituent groups of at least about 6 carbon atoms. Examples of aliphatic groups include hexyl, heptyl, octyl, nonyl, and decyl. Generally, the aliphatic groups will not contain more than about 14 carbon atoms. The general types of amine antioxidants useful in the present compositions include diphenylamines (such as di(C₈₋₁₄-alkyl substituted diphenyl) amine, such as di(nonylphenyl)amine), phenyl naphthylamines, phenothiazines, imidodibenzyls and diphenyl phenylene diamines. Mixtures of two or more aromatic amines are also useful. Polymeric amine antioxidants can also be used. Particular examples of aromatic amine antioxidants useful in the present disclosure include: p,p′-dioctyldiphenylamine; t-octylphenyl-alpha-naphthylamine; phenyl-alpha-naphthylamine; and p-octylphenyl-alpha-naphthylamine.

Sulfur-containing antioxidants are also useful herein. In particular, one or more oil-soluble or oil-dispersible sulfur-containing antioxidant(s) can be used as an antioxidant additive. For example, sulfurized alkyl phenols and alkali or alkaline earth metal salts thereof also are useful antioxidants herein. Suitably, the lubricating oil composition(s) of the present disclosure may include the one or more sulfur-containing antioxidant(s) in an amount to provide the lubricating oil composition with from 0.02 to 0.2, preferably from 0.02 to 0.15, even more preferably 0.02 to 0.1, even more preferably 0.04 to 0.1, mass % sulfur based on the total mass of the lubricating oil composition. Optionally the oil-soluble or oil-dispersible sulfur-containing antioxidant(s) are selected from sulfurized C₄ to C₂₅ olefin(s), sulfurized aliphatic (C₇ to C₂₉) hydrocarbyl fatty acid ester(s), ashless sulfurized phenolic antioxidant(s), sulfur-containing organo-molybdenum compound(s), and combinations thereof. For further information, on sulfurized materials useful as antioxidants herein, please see U.S. Pat. No. 10,731,101 (col 15, ln 55 to col 22, ln 12).

Antioxidants useful herein include hindered phenols and/or arylamines. These antioxidants may be used individually by type or in combination with one another.

Typical antioxidants include: Irganox™ L67, Irganox™ L135, Ethanox™ 4702, Lanxess Additin™ RC 7110; Ethanox™ 4782J; Irganox™ 1135, Irganox™ 5057, sulfurized lard oil and palm oil fatty acid methyl ester.

Antioxidant additives may be used in an amount of about 0.01 to 10 (alternately 0.01 to 5, alternately 0.01 to 3) mass %, alternately about 0.03 to 5 mass %, alternately 0.05 to less than 3 mass %, based upon the weight of the lubricating composition.

Compositions according to the present disclosure may contain an additive having a different enumerated function that also has secondary effects as an antioxidant (for example, phosphorus-containing anti-wear agents (such as ZDDP) may also have antioxidant effects). These additives are not included as antioxidants for purposes of determining the amount of antioxidant in a lubricating oil composition or concentrate herein.

### F. Pour Point Depressants

Conventional pour point depressants (also known as lube oil flow improvers or LOFI's) may be added to the compositions of the present disclosure if desired. These pour point depressants may be added to lubricating compositions disclosed herein to lower the minimum temperature at which the fluid will flow or can be poured. Examples of suitable pour point depressants include polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. U.S. Pat. Nos. 1,815,022; 2,015,748; 2,191,498; 2,387,501; 2,655,479; 2,666,746; 2,721,877; 2,721,878; and 3,250,715 describe useful pour point depressants and/or the preparation thereof. Such additives may be used in an amount of about 0.01 to 5 mass %, preferably about 0.01 to 1.5 mass %, based upon the weight of the lubricating composition.

### G. Anti-Foam Agents

Anti-foam agents may advantageously be added to lubricant compositions described herein. These agents prevent or retard the formation of stable foams. Silicones and/organic polymers are typical anti-foam agents. For example, polysiloxanes, such as silicon oil or polydimethyl siloxane, provide anti-foam properties.

Anti-foam agents are commercially available and may be used in minor amounts such as 5 mass % or less, 3 mass % or less, 1 mass % or less, 0.1 mass % or less, such as from 5 to mass % to 0.1 ppm such as from 3 mass % to 0.5 ppm, such as from 1 mass % to 10 ppm.

For example, it may be that the lubricating oil composition comprises an anti-foam agent comprising polyalkyl siloxane, such as a polydialkyl siloxane, for example, wherein the alkyl is a C₁-C₁₀ alkyl group, e.g., a polydimethylsiloxane (PDMS), also known as a silicone oil. Alternately, the siloxane is a poly(R³)siloxane, wherein R³ is one or more same or different linear branched or cyclic hydrocarbyls, such as alkyls or aryls, typically having 1 to 20 carbon atoms. It may be that, for example, the lubricating oil composition comprises a polymeric siloxane compound according to Formula 1 below wherein R¹ and R² are independently methyl, ethyl, propyl, butyl, pentyl, hexyl, heptyl, octyl, nonyl or decyl, phenyl, naphthyl, alkyl substituted phenyl, or isomers thereof (such as methyl, phenyl) and n is from 2 to 1000, such as 50 to 450, alternately such as 40 to 100.

Additionally, or alternatively, it may be that the lubricating oil composition comprises an organo-modified siloxane (OMS), such as a siloxane modified with an organo group such as a polyether (e.g., ethylene-propyleneoxide copolymer), long chain hydrocarbyl (e.g., C₁₁-C₁₀₀ alkyl), or aryl (e.g., C₆-C₁₄ aryl). It may be that, for example, the lubricating oil composition comprises an organo-modified siloxane compound according to Formula 1, wherein n is from 2 to 2000, such as 50 to 450 (alternately such as 40 to 100), and wherein R¹ and R² are the same or different, optionally wherein each of R¹ and R² is, independently an organo group, such as an organo group selected from polyether (e.g., ethylene-propyleneoxide copolymer), long chain hydrocarbyl (e.g., C₁₁-C₁₀₀ alkyl), or aryl (e.g., C₆-C₁₄ aryl). Preferably, one of R¹ and R² is CH₃.

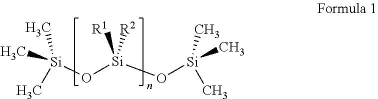

Based on the total weight of the lubricant composition, the siloxane according to Formula 1 is incorporated so as to provide about 0.1 to less than about 30 ppm Si, or about 0.1 to about 25 ppm Si, or about 0.1 to about 20 ppm Si, or about 0.1 to about 15 ppm Si, or about 0.1 to about 10 ppm Si. More preferably, it is in the range of about 3-10 ppm Si.

In embodiments, silicone anti-foam agents useful herein are available from Dow Corning Corporation and Union Carbide Corporation, such as Dow Corning FS-1265 (1000 centistokes), Dow Corning DC-200, and Union Carbide UC-L45. Silicone anti-foamants useful herein include polydimethylsiloxane, fluoro-silicone materials, phenyl-methyl polysiloxane, linear, cyclic or branched siloxanes, silicone polymers and copolymers, and/organo-silicone copolymers. Also, a siloxane polyether copolymer Anti-foamant available from OSI Specialties, Inc. of Farmington Hills, Michigan and may be substituted or included. One such material is sold as SILWET-L-7220. Additional useful silicon containing agents include those disclosed in EP 3 366 755 A1.

Acrylate polymer anti-foam agent can also be used herein. Typical acrylate anti-foamants include polyacrylate anti-foamant available from Monsanto Polymer Products Co. known as PC-1244. A preferred acrylate polymer anti-foam agent useful herein is PX™3841 (i.e., an alkyl acrylate polymer), commercially available from Dorf Ketl, also referred to as Mobilad™C402.

In embodiments, a combination of silicone anti-foamant and acrylate anti-foamant can be used, such as at a weight ratio of the silicone anti-foamant to the acrylate anti-foamant of from about 5:1 to about 1:5, see, for example, US Patent Application Publication No. 2021/0189283.

### H. Viscosity Modifiers

Viscosity modifiers (also referred to as viscosity index improvers or viscosity improvers) can be included in the lubricating compositions described herein. Viscosity modifiers provide lubricants with high and low temperature operability. These additives impart shear stability at elevated temperatures and acceptable viscosity at low temperatures. Suitable viscosity modifiers include high molecular weight hydrocarbons, polyesters, and viscosity modifier dispersants (also referred to as a dispersant viscosity modifiers or DVM's) that can function as both a viscosity modifier and a dispersant. Typical molecular weights of these polymers are between about 10,000 to 1,500,000 g/mol, more typically about 20,000 to 1,200,000 g/mol, and even more typically between about 50,000 and 1,000,000 g/mol.

Examples of suitable viscosity modifiers are linear or radial (star-shaped) polymers and copolymers of methacrylate, butadiene, olefins, or alkylated styrenes. Polyisobutylene is a commonly used viscosity modifier. Another suitable viscosity modifier is polymethacrylate (copolymers of various chain length alkyl methacrylates, for example), some formulations of which also serve as pour point depressants. Other suitable viscosity modifiers include copolymers of ethylene and propylene, hydrogenated block copolymers of styrene and isoprene, and polyacrylates (copolymers of various chain length acrylates, for example). Specific examples include styrene-isoprene or styrene-butadiene based polymers of 50,000 to 200,000 g/mol molecular weight.

Copolymers useful as viscosity modifiers include those commercially available from Chevron Oronite Company LLC under the trade designation “PARATONE™” (such as “PARATONE™ 8921,” “PARATONE™ 68231,” and “PARATONE™ 8941”); from Afton Chemical Corporation under the trade designation “HiTEC™” (such as HiTEC™ 5850B, and HiTEC™5777); and from The Lubrizol Corporation under the trade designation “Lubrizol™ 7067C”. Hydrogenated polyisoprene radial (star) polymers useful as viscosity modifiers herein include those commercially available from Infineum International Limited, e.g., under the trade designation “SV200™” and “SV600™”. Hydrogenated diene-styrene block copolymers useful as viscosity modifiers herein are commercially available from Infineum International Limited, e.g., under the trade designation “SV150™”.

Polymers useful as viscosity modifiers herein include polymethacrylate or polyacrylate polymers, such as linear polymethacrylate or polyacrylate polymers, such as those available from Evnoik Industries under the trade designation “Viscoplex™” (e.g., Viscoplex™ 6-954) or star polymers which are available from Lubrizol Corporation under the trade designation Asteric™ (e.g., Lubrizol™ 87708 and Lubrizol™ 87725).

Vinyl aromatic-containing polymers useful as viscosity modifiers herein may be derived from vinyl aromatic hydrocarbon monomers, such as styrenic monomers, such as styrene. Illustrative vinyl aromatic-containing copolymers useful herein may be represented by the following general formula: A-B wherein A is a polymeric block derived predominantly from vinyl aromatic hydrocarbon monomer (such as styrene), and B is a polymeric block derived predominantly from conjugated diene monomer (such as isoprene).

Vinyl aromatic-containing polymers useful as viscosity modifiers may have a Kinematic viscosity at 100° C. of 20 cSt or less, such as 15 cSt or less, such as 12 cSt or less, but may be diluted (such as in Group I, II, and/or III basestock) to higher Kinematic viscosities at 100° C., such as to 40 cSt or more, such as 100 cSt or more, such as 1000 cSt or more, such as 1000 to 2000 cSt).

Dispersant viscosity modifiers useful herein include the amide, imide, and/or ester functionalized partially or fully saturated polymers comprising C₄₋₅ olefins as described in United States application U.S. Ser. No. 18/480,571, filed Oct. 4, 2023, which is herein incorporated by reference in its entirety. Preferred DVM's include polymers referred to as “functionalized polymers” described in U.S. Ser. No. 18/480,571, and preferably are a functionalized hydrogenated polyisoprene family of polymers for use in lubricating oil compositions. In an advantageous form, the lubricating oil composition described herein further optionally includes one or more functionalized polymers described in 18/480,571 as dispersant viscosity modifiers 's at from 0.2 to 2.0 mass %, or 0.4 to 1.8 mass %, or 0.6 to 1.6 mass %, or 0.8 to 1.4 mass %, or 1.0 to 1.2 mass % of the lubricating oil composition, where the functionalized polymers comprises an amide, imide, and/or ester functionalized partially or fully saturated polymer comprising C₄₋₅ olefins having: i) an Mw/Mn of less than 2, or less than 1.8, or less than 1.6, ii) a Functionality Distribution (Fd) value of 3.5 or less, or 3.2 or less, or 3.0 or less, or 2.5 or less, and iii) an Mn of 10,000 g/mol or more, or 15,000 g/mol or more, or 20,000 g/mol or more, or 25,000 g/mol or more (GPC-PS) of the polymer prior to functionalization, optionally provided that, if the polymer prior to functionalization is a copolymer of isoprene and butadiene, then the Mn of the copolymer is greater than 25,000 g/mol, or 30,000 g/mol or more, or 35,000 g/mol or more, or 40,000 g/mol or more (GPC-PS). (GPC-PS is performed as set out in United States patent application U.S. Ser. No. 18/480,571, filed Oct. 4, 2023). For the functionalized polymer described in 18/480,571 useful herein, Average Functionality [also referred to as Average Functionality Value (Fv)] and Functionality Distribution (Fd) value are determined by Gel Permeation Chromatography using polystyrene standards as described in the Experimental section of US patent application U.S. Ser. No. 18/480,571, filed Oct. 4, 2023. The functionalized polymers described in 18/480,571 useful herein may include at least 50%, or at least 60%, or at least 70% of 1,4-insertions of monomer, such as isoprene monomer. Furthermore, the functionalized polymers described in 18/480,571 useful herein may include a partially or fully saturated homopolyisoprene containing one or more pendant amine groups and having an Mn of 25,000 to 100,000 g/mol, or 35,000 to 90,000 g/mol, or 45,000 to 80,000 g/mol, or 55,000 to 75,000 g/mol (GPC-PS) and at least 50%, or at least 60%, or at least 70% of 1,4-insertions prior to functionalization. The functionalized polymers described in 18/480,571 useful herein may be absent of styrene repeat units, or absent of butadiene repeat units, or is not a homo-polyisobutylene, or is not a copolymer of isoprene and butadiene.

Other useful DVM's include functionalized olefin copolymers (such as amine functionalized ethylene propylene copolymers). See U.S. Pat. Nos. 5,663,126, 6,187,721, 5,874,389; WO 97/47709; U.S. Pat. Nos. 6,300,289; 6,686,321; WO 99/21902; US 2002/0183456; US 2004/0043909; WO 03/099890; US 2008/0139423; US2008/0293600; WO 2006/116663; US 2004/0043909; and US 2010/0162981 for other useful DVM's.

Vinyl aromatic-containing polymer concentrates prepared in base oil (such as in Group I, II, and/or III basestock) useful as viscosity modifiers may have a Kinematic viscosity at 100° C. of 40 cSt or more, such as 100 cSt or more, such as 1000 cSt or more, such as 1000 to 2000 cSt. Further dilution in base oil (such as in Group I, II, and/or III basestock) may lower the viscosities at 100° C., such as to 20 cSt or less, such as 15 cSt or less, such as 12 cSt or less.

Typically, the viscosity modifiers may be used in an amount of about 0.01 to about 10 mass %, such as about 0.1 to about 7 mass %, such as 0.1 to about 4 mass %, such as about 0.2 to about 2 mass %, such as about 0.2 to about 1 mass %, and such as about 0.2 to about 0.5 mass %, based on the total weight of the formulated lubricant composition.

Viscosity modifiers are typically added as concentrates, in large amounts of diluent oil. The “as delivered” viscosity modifier typically contains from 20 mass % to 75 mass % of an active polymer for polymethacrylate or polyacrylate polymers, or from 8 mass % to 20 mass % of an active polymer for olefin copolymers, hydrogenated polyisoprene star polymers, or hydrogenated diene-styrene block copolymers, in the “as delivered” polymer concentrate.

### I. Dispersants

During engine operation, oil-insoluble oxidation byproducts are produced. Dispersants help keep these byproducts in solution, thus diminishing their deposition on metal surfaces. Dispersants used in the formulation of the lubricating compositions herein may be ashless or ash-forming in nature. Preferably, the dispersant is ashless. So called ashless dispersants are organic materials that form substantially no ash upon combustion. For example, non-metal-containing or borated metal-free dispersants are considered ashless. In contrast, metal-containing detergents tend to form ash upon combustion.

Dispersants useful herein typically contain a polar group attached to a relatively high molecular weight hydrocarbon chain. The polar group typically contains at least one element of nitrogen, oxygen, or phosphorus. Typical hydrocarbon chains contain 40 to 500, such as 50 to 400 carbon atoms. When used in context of functionalized polymers operating as dispersants, the molecular weights are typically reported in terms of the base polymer prior to modification. For example PIBSA-PAM dispersant molecular weights are typically reported for the base polymer prior to functionalization with the acylating agent (maleic acid or anhydride) and functional group (such as polyamine). Hence, herein dispersant molecular weights are typically assigned the molecular weight of the base polymer the dispersant is derived from.

### Dispersants of (Poly)alkenylsuccinic Derivatives

A particularly useful class of dispersants includes the (poly)alkenylsuccinic derivatives, typically produced by the reaction of a long chain hydrocarbyl-substituted succinic compound, usually a hydrocarbyl-substituted succinic anhydride, with a polyhydroxy or polyamino compound. The long chain hydrocarbyl group constituting the oleophilic portion of the molecule which confers solubility in the oil, is often a polyisobutylene group (typically the long chain hydrocarbyl group, such as a polyisobutylene group, has an Mn of 400 to 3000 g/mol, such as 450 to 2500 g/mol). Many examples of this type of dispersant are well known commercially and in the literature. Exemplary US Patents describing such dispersants include U.S. Pat. Nos. 3,172,892; 3,2145,707; 3,219,666; 3,316,177; 3,341,542; 3,444,170; 3,454,607; 3,541,012; 3,630,904; 3,632,511; 3,787,374 and 4,234,435. Other types of dispersants are described in U.S. Pat. Nos. 3,036,003; 3,200,107; 3,254,025; 3,275,554; 3,438,757; 3,454,555; 3,565,804; 3,413,347; 3,697,574; 3,725,277; 3,725,480; 3,726,882; 4,454,059; 3,329,658; 3,449,250; 3,519,565; 3,666,730; 3,687,849; 3,702,300; 4,100,082; 5,705,458. A further description of dispersants useful herein may be found, for example, in European Patent Applications Nos. 0 471 071 and 0 451 380, to which reference is made for this purpose.

Hydrocarbyl-substituted succinic acid and hydrocarbyl-substituted succinic anhydride derivatives are useful dispersants. In particular, succinimide, succinate esters, or succinate ester amides prepared by the reaction of a hydrocarbon-substituted succinic acid or anhydride compound (typically having at least 25 carbon atoms, such as 28 to 400 carbon atoms, in the hydrocarbon substituent), with at least one equivalent of a polyhydroxy or polyamino compound (such as an alkylene amine) are particularly useful herein. Hydrocarbyl-substituted succinic acid and hydrocarbyl-substituted succinic anhydride derivatives may have a number average molecular weight of at least 400 g/mol, such as at least 900 g/mol, such as at least 1500 g/mol, such as from 400 to 4000 g/mol, such as from 800 to 3000, such as from 2000 to 2800 g/mol, such from about 2100 to 2500 g/mol, and such as from about 2200 to about 2400 g/mol.

Succinimides, which are particularly useful herein, are formed by the condensation reaction between: 1) hydrocarbyl-substituted succinic anhydrides, such as polyisobutylene succinic anhydride (PIBSA); and 2) polyamine (PAM). Examples of suitable polyamines include: polyhydrocarbyl polyamines, polyalkylene polyamines, hydroxy-substituted polyamines, polyoxyalkylene polyamines, and combinations thereof. Examples of polyamines include tetraethylene pentamine, pentaethylene hexamine, tetraethylenepentamine (TEPA), pentaethylenehaxamine (PEHA), N-phenyl-p-phenylenediamine (ADPA), and other polyamines having an average of 5, 6, 7, 8, or 9 nitrogen atoms per molecule. Mixtures where the average number of nitrogen atoms per polyamine molecule is greater than 7 are commonly called heavy polyamines or H-PAMs and may be commercially available under trade names such as HPA™ and HPA-X™ from DowChemical, E-100™ from Huntsman Chemical, et al. Examples of hydroxy-substituted polyamines include N-hydroxyalkyl-alkylene polyamines such as N-(2-hydroxyethyl)ethylene diamine, N-(2-hydroxyethyl) piperazine, and/or N-hydroxyalkylated alkylene diamines of the type described, for example, in U.S. Pat. No. 4,873,009. Examples of polyoxyalkylene polyamines include polyoxyethylene and/or polyoxypropylene diamines and triamines (as well as co-oligomers thereof) having an average Mn from about 200 to about 5000 g/mol. Products of this type are commercially available under the tradename Jeffamine™ Representative examples of useful succinimides are shown in U.S. Pat. Nos. 3,087,936; 3,172,892; 3,219,666; 3,272,746; 3,322,670; 3,652,616; 3,948,800; and 6,821,307; and CA U.S. Pat. No. 1,094,044.

The dispersants may comprise one or more, optionally borated, higher molecular weight (Mn 1600 g/mol or more, such as 1800 to 3000 g/mol) succinimides and one or more, optionally borated, lower molecular weight (Mn less than 1600 g/mol) succinimides, where the higher molecular weight may be 1600 to 3000 g/mol, such as 1700 to 2800 g/mol, such as 1800 to 2500 g/mol, such as 1850 to 2300 g/mol; and the lower molecular weight may be 600 to less than 1600 g/mol, such as 650 to 1500 g/mol, such as 700 to 1400 g/mol, such as 800 to 1300 g/mol, such as 850 to 1200 g/mol such as 900 to 1150 g/mol, such as 900 to 1000 g/mol. The higher molecular weight succinimide dispersant may be present in the lubricating composition in an amount of from 0.5 to 10 mass %, or from 0.8 to 6 mass %, or from 1.0 to 5 mass %, or from 1.5 to 5 mass %, or from 1.5 to 4.0 mass %; and the lower molecular weight succinimides dispersant may be present in the lubricating composition in an amount of from 1 to 5 mass %, or from 1.5 to 4.8 mass %, or from 1.8 to 4.6 mass %, or from 1.9 to 4.6 mass %, or at 2 mass % or more, such as 2 to 5 mass %. The lower molecular weight succinimides may differ from the higher molecular weight succinimides, by 500 g/mol or more, such as by 750 g/mol or more, such as by 1000 g/mol or more, such as by 1200 g/mol or more, such as by 500 to 3000 g/mol, such as by 750 to 2000 g/mol, such as by 1000 to 1500 g/mol.

Succinate esters useful as dispersants include those formed by the condensation reaction between hydrocarbyl-substituted succinic anhydrides and alcohols or polyols. For example, the condensation product of a hydrocarbyl-substituted succinic anhydride and pentaerythritol is a useful dispersant.

Succinate ester amides useful herein are formed by a condensation reaction between hydrocarbyl-substituted succinic anhydrides and alkanol amines. Suitable alkanol amines include ethoxylated polyalkylpolyamines, propoxylated polyalkylpolyamines, and polyalkenylpolyamines such as polyethylene polyamines and/or propoxylated hexamethylenediamine. Representative examples are shown in U.S. Pat. No. 4,426,305.

Hydrocarbyl-substituted succinic anhydrides (such as PIBSA) esters of hydrocarbyl bridged aryloxy alcohols are also useful as dispersants herein. For information on such dispersants, please see U.S. Pat. No. 7,485,603, particularly, col 2, ln 65 to col 6, ln 22 and col 23, ln 40 to col 26, ln 46. In particular, PIBSA esters of methylene-bridged naphthyloxy ethanol (i.e., 2-hydroxyethyl-1-naphthol ether (or hydroxy-terminated ethylene oxide oligomer ether of naphthol) are useful herein.

The molecular weight of the hydrocarbyl-substituted succinic anhydrides used in the preceding paragraphs will typically range from 350 to 4000 g/mol, such as 400 to 3000 g/mol, such as 450 to 2800 g/mol, such as 800 to 2500 g/mol. The above (poly)alkenylsuccinic derivatives can be post-reacted with various reagents such as sulfur, oxygen, formaldehyde, carboxylic acids such as oleic acid.

The dispersants may be present in the lubricant in an amount 0.1 mass % to 20 mass % of the composition, such as 0.2 to 15 mass %, such as 0.25 to 10 mass %, such as 0.3 to 5 mass %, such as 1.0 mass % to 3.0 mass %, of the lubricating oil composition.

The above (poly)alkenylsuccinic derivatives, can also be post reacted with boron compounds such as boric acid, borate esters or highly borated dispersants, to form borated dispersants generally having from about 0.1 to about 5 moles of boron per mole of dispersant reaction product.

Dispersants useful herein include borated succinimides, including those derivatives from mono-succinimides, bis-succinimides, and/or mixtures of mono- and bis-succinimides, wherein the hydrocarbyl succinimide is derived from a hydrocarbylene group such as polyisobutylene having an Mn of from about 300 to about 5000 g/mol, or from about 500 to about 3000 g/mol, or about 1000 to about 2000 g/mol, or a mixture of such hydrocarbylene groups, often with high terminal vinylic groups.

The boron-containing dispersant may be present at 0.01 mass % to 20 mass %, or 0.1 mass % to 15 mass %, or 0.1 mass % to 10 mass %, or 0.5 mass % to 8 mass %, or 1.0 mass % to 6.5 mass %, or 0.5 mass % to 2.2 mass % of the lubricating composition.

The boron-containing dispersant may be present in an amount to deliver boron to the composition at 15 ppm to 2000 ppm, or 25 ppm to 1000 ppm, or 40 ppm to 600 ppm, or 80 ppm to 350 ppm.

The borated dispersant may be used in combination with non-borated dispersant and may be the same or different compound as the non-borated dispersant. In one embodiment, the lubricating composition may include one or more boron-containing dispersants and one or more non-borated dispersants, wherein the total amount of dispersant may be 0.01 mass % to 20 mass %, or 0.1 mass % to 15 mass %, or 0.1 mass % to 10 mass %, or 0.5 mass % to 8 mass %, or 1.0 mass % to 6.5 mass %, or 0.5 mass % to 2.2 mass % of the lubricating composition and wherein the ratio of borated dispersant to non-boroated dispersant may be 1:10 to 10:1 (weight:weight) or 1:5 to 3:1 or 1:3 to 2:1.

The dispersant may comprise one or more borated or unborated poly(alkenyl) succinimides, where the polyalkyenyl is derived from polyisobutylene and the imide is derived from a polyamine (“PIBSA-PAM”).

The dispersant may comprise one or more PIBSA-PAMs, where the PIB is derived from polyisobutylene having an Mn of from 600 to 5000, such as from 700 to 4000, such as from 800 to 3000, such as from 900 to 2500 g/mol and the polyamine is derived from hydrocarbyl-substituted polyamines, such as tetraethylene pentamine, pentaethylene hexamine, tetraethylenepentamine (TEPA), pentaethylenehaxamine (PEHA), N-phenyl-p-phenylenediamine (ADPA), and other polyamines having an average of 5, 6, 7, 8, or 9 nitrogen atoms per molecule). The dispersant may be borated, typically at levels of up to 4 mass % such as from 1 to 3 mass %. The dispersant may comprise one or more borated and one or more non-borated PIBSA-PAM's. The dispersant may comprise one or more borated PIBSA-PAM's derived from a PIB having an Mn of 700 to 1800 g/mol (such as 800 to 1500 g/mol) and one or more non-borated PIBSA-PAM's derived from a PIB having an Mn of more than 1800 to 5000 g/mol (such as 2000 to 3000 g/mol). The dispersant may comprise one or more non-borated PIBSA-PAM's derived from a PIB having an Mn of 700 to 1800 g/mol (such as 800 to 1500 g/mol) and one or more borated PIBSA-PAM's derived from a PIB having an Mn of more than 1800 to 5000 g/mol (such as 2000 to 3000 g/mol).

The dispersant may comprise PIBSA derived from a PIB having an Mn of 700 to 5000 g/mol (such as 800 to 3000 g/mol) and one or more borated or non-borated PIBSA-PAM's derived from a PIB having an Mn of 700 to 5000 g/mol.

The dispersant may comprise PIBSA derived from a PIB having an Mn of 700 to 5000 g/mol (such as 800 to 3000 g/mol) and one or more borated PIBSA-PAM's derived from a PIB having an Mn of 700 to 1800 g/mol (such as 800 to 1500 g/mol) and one or more non-borated PIBSA-PAM's derived from a PIB having an Mn of more than 1800 to 5000 g/mol (such as 2000 to 3000 g/mol). The dispersant may comprise PIBSA derived from a PIB having an Mn of 700 to 5000 g/mol (such as 800 to 3000 g/mol) one or more non-borated PIBSA-PAM's derived from a PIB having an Mn of 700 to 1800 g/mol (such as 800 to 1500 g/mol) and one or more borated PIBSA-PAM's derived from a PIB having an Mn of more than 1800 to 5000 g/mol (such as 2000 to 3000 g/mol).

The dispersant may comprise one or more borated or non-borated PIBSA-PAM's and one or more PIBSA-esters of hydrocarbyl bridged aryloxy alcohols.

The dispersant may comprise one or more borated and one or more non-borated PIBSA-PAM's.

The dispersant may comprise one or more, optionally borated, higher molecular weight (Mn 1600 g/mol or more, such as 1800 to 3000 g/mol) PIBSA-PAM's and one or more, optionally borated, lower molecular weight (Mn less than 1600 g/mol) PIBSA-PAM's, where the higher molecular weight may be 1600 to 3000 g/mol, such as 1700 to 2800 g/mol, such as 1800 to 2500 g/mol, such as 1850 to 2300 g/mol; and the lower molecular weight may be 600 to less than 1600 g/mol, such as 650 to 1500 g/mol, such as 700 to 1400 g/mol, such as 800 to 1300 g/mol, such as 850 to 1200 g/mol, such as 900 to 11500 g/mol, such as 900 to 100 g/mol. The higher molecular weight PIBSA-PAM dispersant may be present in the lubricating composition in an amount of from 0.5 to 10 mass %, or from 0.8 to 6 mass %, or from 1.0 to 5 mass %, or from 1.5 to 5 mass % or from 1.5 to 4.0 mass %; and the lower molecular weight PIBSA-PAM dispersant may be present in the lubricating composition in an amount of from 1 to 5 mass %, or from 1.5 to 4.8 mass %, or from 1.8 to 4.6 mass %, or from 1.9 to 4.6 mass %, or at 2 mass % or more, such as 2 to 5 mass %.

### Dispersants of Mannich Bases

Mannich base dispersants useful herein are typically made from the reaction of an amine component, a hydroxy aromatic compound (substituted or unsubstituted, such as alkyl substituted), such as alkylphenols, and an aldehyde, such as formaldehyde. See U.S. Pat. Nos. 4,767,551 and 10,899,986. Process aids and catalysts, such as oleic acid and sulfonic acids, can also be part of the reaction mixture. Representative examples are shown in U.S. Pat. Nos. 3,697,574; 3,703,536; 3,704,308; 3,751,365; 3,756,953; 3,798,165; 3,803,039; 4,231,759; 9,938,479; 7,491,248; and 10,899,986, and PCT Publication No. WO 01/42399.

### Dispersants of Polymethacrylate or Polyacrylate Derivatives

Polymethacrylate or polyacrylate derivatives are another class of dispersants useful herein. These dispersants are typically prepared by reacting a nitrogen-containing monomer and a methacrylic or acrylic acid esters containing 5-25 carbon atoms in the ester group. Representative examples are shown in U.S. Pat. Nos. 2,100,993, and 6,323,164. Polymethacrylate and polyacrylate dispersants are typically lower molecular weights.

The lubricating composition of the disclosure typically comprises dispersant at 0.1 mass % to 20 mass % of the composition, such as 0.2 to 15 mass %, such as 0.25 to 10 mass %, such as 0.3 to 5 mass %, such as 2.0 mass % to 4.0 mass % of the lubricating oil composition. Alternately the dispersant may be present at 0.1 mass % to 5 mass %, or 0.01 mass % to 4 mass % of the lubricating composition.

For further information on dispersants useful herein, please see U.S. Pat. No. 10,829,712, col 13, ln 36 to col 16, ln 67 and U.S. Pat. No. 7,485,603, col 2, ln 65 to col 6, ln 22, col 8, ln 25 to col 14, ln 53, and col 23, ln 40 to col 26, ln 46.

Compositions according to the present disclosure may contain an additive having a different enumerated function that also has secondary effects as a dispersant (for example, viscosity modifiers described above, may also have dispersant effects). These additives are not included as dispersants for purposes of determining the amount of dispersant in a lubricating oil composition or concentrate herein.

### J. Corrosion Inhibitors/Anti-Rust Agents

Corrosion inhibitors may be used to reduce the corrosion of metals and are often alternatively referred to as metal deactivators or metal passivators. Some corrosion inhibitors may alternatively be characterized as antioxidants.

Suitable corrosion inhibitors may include nitrogen and/or sulfur-containing heterocyclic compounds such as triazoles (e.g., benzotriazoles), substituted thiadiazoles, imidazoles, thiazoles, tetrazoles, hydroxyquinolines, oxazolines, imidazolines, thiophenes, indoles, indazoles, quinolines, benzoxazines, dithiols, oxazoles, oxatriazoles, pyridines, piperazines, triazines and derivatives of any one or more thereof. A particular corrosion inhibitor is a benzotriazole represented by the structure:

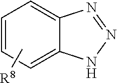

wherein R⁸ is absent (hydrogen) or is a C₁ to C₂₀ hydrocarbyl or substituted hydrocarbyl group which may be linear or branched, saturated or unsaturated. It may contain ring structures that are alkyl or aromatic in nature and/or contain heteroatoms such as N, O, or S. Examples of suitable compounds may include benzotriazole, alkyl-substituted benzotriazoles (e.g., tolyltriazole, ethylbenzotriazole, hexylbenzotriazole, octylbenzotriazole, etc.), aryl substituted benzotriazole, alkylaryl- or arylalkyl-substituted benzotriazoles, and the like, as well as combinations thereof. For instance, the triazole may comprise or be a benzotriazole and/or an alkylbenzotriazole in which the alkyl group contains from 1 to about 20 carbon atoms or from 1 to about 8 carbon atoms. Non-limiting examples of such corrosion inhibitors may comprise or be benzotriazole, tirazoles such as tolyltriazole, and/or optionally, substituted benzotriazoles such as Irgamet™ and Irgamet™ 39, which are commercially available from BASF of Ludwigshafen, Germany. A preferred corrosion inhibitor may comprise or be benzotriazole and/or tolyltriazole.

Additionally, or alternatively, the corrosion inhibitor may include one or more substituted thiadiazoles represented by the structure:

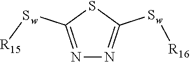

wherein R₁₅ and R₁₆ are independently hydrogen or a hydrocarbon group, which group may be aliphatic or aromatic, including cyclic, alicyclic, aralkyl, aryl and alkaryl, and wherein each w is independently 1, 2, 3, 4, 5, or 6 (preferably 2, 3, or 4, such as 2). These substituted thiadiazoles are derived from the 2,5-dimercapto-1,3,4-thiadiazole (DMTD) molecule. Many derivatives of DMTD have been described in the art, and any such compounds may be included in the fluid used in the present disclosure. For example, U.S. Pat. Nos. 2,719,125; 2,719,126; and 3,087,937; describe the preparation of various 2,5-bis-(hydrocarbon dithio)-1,3,4-thiadiazoles.

Further, additionally or alternatively, the corrosion inhibitor may include one or more other derivatives of DMTD, such as a carboxylic ester in which R₁₅ and R₁₆ may be joined to the sulfide sulfur atom through a carbonyl group. Preparation of these thioester-containing DMTD derivatives is described, for example, in U.S. Pat. No. 2,760,933. DMTD derivatives produced by condensation of DMTD with alpha-halogenated aliphatic carboxylic acids having at least 10 carbon atoms are described, for example, in U.S. Pat. No. 2,836,564. This process produces DMTD derivatives wherein R₁₅ and R₁₆ are HOOC—CH(R₁₉)—(R₁₉ being a hydrocarbyl group). DMTD derivatives further produced by amidation or esterification of these terminal carboxylic acid groups may also be useful.

The preparation of 2-hydrocarbyldithio-5-mercapto-1,3,4-thiadiazoles is described, for example, in U.S. Pat. No. 3,663,561.

A class of DMTD derivatives may include mixtures of a 2-hydrocarbyldithio-5-mercapto-1,3,4-thiadiazole and a 2,5-bis-hydrocarbyldithio-1,3,4-thiadiazole. Such mixtures may be sold under the tradename HiTEC™ 4313 and are commercially available from Afton Chemical Company.

The preparation of 2-hydrocarbyldithio-5-mercapto-1,3,4-thiadiazoles is described, for example, in U.S. Pat. No. 3,663,561.

Still further, additionally or alternatively, the corrosion inhibitor may include a trifunctional borate having the structure, B(OR₄₆)₃, in which each R₄₆ may be the same or different. As the borate may typically be desirably compatible with the non-aqueous medium of the composition, each R₄₆ may, in particular, comprise or be a hydrocarbyl C₁-C₈ moiety. For compositions in which the non-aqueous medium comprises or is a lubricating oil basestock, for example, better compatibility can typically be achieved when the hydrocarbyl moieties are each at least C₄. Non-limiting examples of such corrosion inhibitors thus include, but are not limited to, triethylborate, tripropylborates such as triisopropylborate, tributylborates such as tri-tert-butylborate, tripentylborates, trihexylborates, trioctylborates such as tri-(2-ethylhexyl) borate, monohexyl dibutylborate, and the like, as well as combinations thereof.

When used, a corrosion inhibitor may comprise a substituted thiadiazole, a substituted benzotriazole, a substituted triazole, a trisubstituted borate, or a combination thereof.

Additional corrosion inhibitors useful for ameliorating water damage, may be fatty alkyl ethers derived from alkyl alcohols, including those that have carbon numbers from C₃ to C₅₀, that have been ethoxylated, propoxylated, or butoxylated to form the corresponding fatty alkyl ethers. The underlying alcohol portion can preferably be stearyl, myristyl, C₁₁-C₁₃ hydrocarbyl, oleyl, isosteryl, and the like. Useful ethoxylated alcohols include ethyloxylated lauryl alcohol (such as Berol™ 1214) and or Surfonic™ L24-4, Huntsman.

When desired, corrosion inhibitors can be used in any effective amount, but, when used, may typically be used in amounts from about 0.001 mass % to 5.0 mass %, based on the weight of the composition, e.g., from 0.005 mass % to 3.0 mass % or from 0.01 mass % to 1.0 mass %. Alternately, such additives may be used in an amount of about 0.01 to 5 mass %, preferably about 0.01 to 1.5 mass %, based upon the weight of the lubricating composition.

In some embodiments, 3,4-oxypyridinone-containing compositions may contain substantially no (e.g., 0, or less than 0.001 mass %, 0.0005 mass % or less, not intentionally added, and/or absolutely no) triazoles, benzotriazoles, substituted thiadiazoles, imidazoles, thiazoles, tetrazoles, hydroxyquinolines, oxazolines, imidazolines, thiophenes, indoles, indazoles, quinolines, benzoxazines, dithiols, oxazoles, oxatriazoles, pyridines, piperazines, triazines, derivatives thereof, combinations thereof, or all corrosion inhibitors.

Compositions according to the present disclosure may contain an additive having a different enumerated function that also has secondary effects as a corrosion inhibitor. These additives are not included as corrosion inhibitor for purposes of determining the amount of corrosion inhibitor in a lubricating oil composition or concentrate herein.

### K. Anti-Wear Agents

The lubricating oil composition of the present disclosure can contain one or more anti-wear agents that can reduce friction and excessive wear. Any anti-wear agent known by a person of ordinary skill in the art may be used in the lubricating oil composition. Non-limiting examples of suitable anti-wear agents include dithiophosphates and or dithiocarbamates (such as metal (e.g., Pb, Sb, Mo, and the like) salts of dithiophosphates, and or metal (e.g., Zn, Pb, Sb, Mo, and the like) salts of dithiocarbamates), metal (e.g., Zn, Pb, Sb, Mo, and the like) salts of fatty acids, boron compounds, phosphate esters, phosphite esters, amine salts of phosphoric acid esters or thiophosphoric acid esters, reaction products of dicyclopentadiene and thiophosphoric acids and combinations thereof.

In embodiments, the anti-wear agent is or comprises a dihydrocarbyl dithiophosphate metal salt. The metal of the dihydrocarbyl dithiophosphate metal salt may be an alkali or alkaline earth metal, or aluminum, lead, tin, manganese, nickel, or copper. In some embodiments, the hydrocarbyl group of the dihydrocarbyl dithiophosphate metal salt has from about 3 to about 22 carbon atoms, from about 3 to about 18 carbon atoms, from about 3 to about 12 carbon atoms, or from about 3 to about 8 carbon atoms and may be an alkyl, substituted alkyl, aryl or substituted aryl. In embodiments, the alkyl group is linear and/or branched.

Useful anti-wear agents also include substituted or unsubstituted thiophosphoric acids, and salts thereof include metal-containing compounds such as metal dithiophosphate compounds selected from metal dialkyl-, diaryl- and/or alkylaryl-dithiophosphates.

In embodiments, the anti-wear compound can be a zinc dithiocarbamate complex, such as the zinc dithiocarbamates represented by the formula:

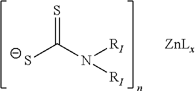

where each R_{I} is independently a linear, cyclic, or branched, saturated or unsaturated, aliphatic hydrocarbon moiety having from 1 to about 10 carbon atoms, n is 0, 1, or 2, L is a ligand that saturates the coordination sphere of zinc, and x is 0, 1, 2, 3, or 4. In certain embodiments, the ligand, L, is selected from the group consisting of water, hydroxide, ammonia, amino, amido, alkylthiolate, halide, and combinations thereof.

Anti-wear additives useful herein also include boron-containing compounds, such as borate esters, borated fatty amines, borated epoxides, alkali metal (or mixed alkali metal or alkaline earth metal) borates and borated overbased metal salts.

The anti-wear additives are typically used in amounts of from about 0.01 mass % to about 5 mass %, from about 0.05 mass % to about 3 mass %, from about 0.4 mass % to about 1.2 mass %, from about 0.1 mass % to about 1 mass %, preferably from about 0.5 mass % to about 1.0 mass %, and more preferably from about 0.6 mass % to about 0.8 mass %, based on the total weight of the lubricating composition, although more or less can often be used advantageously.

Compositions according to the present disclosure may contain an additive having a different enumerated function that also has secondary effects as an anti-wear agent (for example, Component B zinc hydrocarbyl diphosphates compounds described above, may also have anti-wear effects). These additives are not included as anti-wear agents for purposes of determining the amount of anti-wear agents in a lubricating oil composition or concentrate herein.

### L. Demulsifiers

Demulsifiers useful herein include trialkyl phosphates, and various polymers and copolymers of ethylene glycol, ethylene oxide, propylene oxide, and mixtures thereof. Additionally demulsifiers useful herein include those described in U.S. Pat. No. 10,829,712 (col 20, ln 34-40). Typically, a small amount of a demulsifying component may be used herein. A preferred demulsifying component is described in European Patent No. 330 522. It is obtained by reacting an alkylene oxide with an adduct obtained by reacting a bis-epoxide with a polyhydric alcohol. Such additives may be used in an amount of about 0.001 to 5 mass %, preferably about 0.01 to 2 mass %.

### M. Seal Compatibility Agents

Other optional additives include seal compatibility agents such as organic phosphates, aromatic esters, aromatic hydrocarbons, esters (butylbenzyl phthalate, for example), and polybutenyl succinic anhydride. Such additives may be used in an amount of about 0.001 to 5 mass %, preferably about 0.01 to 2 mass %. In embodiments the seal compatibility agents are seal swell agents, such as PIBSA (polyisobutenyl succinic anhydride) or sulfolene derivatives such as ExxonMobil Necton-37™ (FN 1380) and ExxonMobil Mineral Seal Oil™ (FN 3200).

### N. Extreme Pressure Agents

The lubricating oil composition of the present disclosure can contain one or more extreme pressure agents that can prevent sliding metal surfaces from seizing under conditions of extreme pressure. Any extreme pressure agent known by a person of ordinary skill in the art may be used in the lubricating oil composition. Generally, the extreme pressure agent is a compound that can combine chemically with a metal to form a surface film that prevents the welding of asperities in opposing metal surfaces under high loads. Non-limiting examples of suitable extreme pressure agents include sulfurized animal or vegetable fats or oils, sulfurized animal or vegetable fatty acid esters, fully or partially esterified esters of trivalent or pentavalent acids of phosphorus, sulfurized olefins, dihydrocarbyl polysulfides, sulfurized Diels-Alder adducts, sulfurized dicyclopentadiene, sulfurized or co-sulfurized mixtures of fatty acid esters and monounsaturated olefins, co-sulfurized blends of fatty acid, fatty acid ester and alpha-olefin, functionally substituted dihydrocarbyl polysulfides, thia-aldehydes, thia-ketones, epithio compounds, sulfur-containing acetal derivatives, co-sulfurized blends of terpene and acyclic olefins, and poly sulfide olefin products, amine salts of phosphoric acid esters or thiophosphoric acid esters, and combinations thereof. The amount of the extreme pressure agent may vary from about 0.01 mass % to about 5 mass %, from about 0.05 mass % to about 3 mass %, or from about 0.1 mass % to about 1 mass %, based on the total weight of the lubricating oil composition.

### O. Non-Basestock Unsaturated Hydrocarbons

The lubricating oil composition of the present disclosure can contain one or more unsaturated hydrocarbons. These unsaturated hydrocarbons are distinct from any baseoils (lubricating oil basestocks of Group I, II, III, IV and/or V) and/or viscosity modifiers that may be present in the compositions and always have at least one (and typically only one, in the case of linear alpha-olefins, or LAOs) unsaturation per molecule. Without being bound by theory, it is believed that the unsaturation(s) may provide an antioxidation functionality and/or a sulfur-trapping functionality that may supplement and/or replace one or more antioxidant additives and/or one or more corrosion inhibitor additives, but unsaturated hydrocarbons (LAOs) will typically not provide the only antioxidant nor the only corrosion inhibition functionality in lubrication oil compositions. Non-limiting examples of unsaturated hydrocarbons can include one or more unsaturated C₁₂-C₆₀ hydrocarbons (such as C₁₂-C₄₈ hydrocarbons, C₁₂-C₃₆ hydrocarbons, C₁₂-C₃₀ hydrocarbons, or C₁₂-C₂₄ hydrocarbons). Other non-limiting examples of unsaturated hydrocarbons can include oligomers/polymers of polyisobutylenes that have retained (or been post-polymerization modified to exhibit) a (near-)terminal unsaturation, and/or blends thereof. When present, unsaturated hydrocarbons may be present from 0.01 to 5 mass % (in particular, 0.1 to 3 mass %, alternately 0.1 to 1.5 mass %), based on total weight of the lubricating oil composition.

In embodiments, the LOC comprises one or more alpha-olefins, such as linear alpha-olefins (LAO), having 8 to 36 carbon atoms, such as 8 to 24 carbon atoms, more preferably 10 to 20 carbon atoms, more preferably 12 to 20 carbon atoms, more preferably 14 to 18 carbon atoms. In embodiments, the LOC comprises mixtures of linear alpha-olefins, having 8 to 24 carbon atoms, more preferably 10 to 20 carbon atoms, more preferably 12 to 20 carbon atoms, more preferably 14 to 18 carbon atoms. In embodiments, the LOC comprises mixtures of linear alpha-olefins, having 14 or more carbon atoms. In embodiments, the LOC may comprise from 0.001 to 15 mass %, (in particular 0.15 to 10 mass %, alternately 0.20 mass % to 5 mass %, alternately 0.25 to 2 mass %) based upon the weight of the lubricating composition, of one or more C₈ to C₃₆ alpha olefins. In embodiments, the LOC may comprise from 0.001 to 15 mass %, (in particular 0.15 to 10 mass %, alternately 0.20 mass % to 5 mass %, alternately 0.25 to 2 mass %) based upon the weight of the lubricating composition, of one, two, three, four, five or more C₈ to C₃₆ alpha olefins, such linear alpha olefins having 8 to 24 carbon atoms, more preferably 10 to 20 carbon atoms, more preferably 12 to 20 carbon atoms, more preferably 14 to 18 carbon atoms.

When lubricating oil compositions contain one or more of the additives discussed above, the additive(s) are typically blended into the composition in an amount sufficient for it to perform its intended function. Typical amounts of such additives useful in the present disclosure, especially for use in crankcase lubricants, are shown in the Table below.

It is noted that many of the additives are shipped from the additive manufacturer as a concentrate, containing one or more additives together, with a certain amount of base oil or other diluents. Accordingly, the weight amounts in the table below, as well as other amounts mentioned herein, are directed to the amount of active ingredient (that is the non-diluent portion of the ingredient). The weight percent (mass %) indicated below is based on the total weight of the lubricating oil composition.

Typical Amounts of Lubricating Oil Components

| | A (mass % | B (mass % | C (mass % |
|---|---|---|---|
| Additive Formulations | a.i.) | a.i.) | a.i.) |
| Dispersant | 0.1-20 | 0.1-20 | 1-8 |
| Detergents | 0.1-20 | 0.1-20 | 0.2-9 |
| Corrosion Inhibitor Anti-rust/ | optional | 0.05-5 | 0.1-1.5 |
| extreme pressure agents | | | |
| Zinc hydrocarbyl diphosphate | 0.1-20 | 0.2-8 | 0.5-5 |
| Antioxidant | 0.01-10 | 0.1-5 | 0.1-4 |
| Pour Point Depressant | optional | 0-5 | 0.01-1.5 |
| Anti-foaming Agent | optional | 0-5 | 0.001-0.15 |
| Functionalized Polymer | 0.01-10 | 0.1-5 | 0.1-2 |
| Friction Modifier | optional | 1. | 0.5 |
| Anti-wear Agent (different | 0.01-10 | 0.1-5 | 0.1-3 |
| from the zinc hydrocarbyl | | | |
| diphosphate) | | | |
| Viscosity Modifier | optional | 0.01-10 | 0.25-3 |
| Seal Swell Agents | optional | 0-5 | 0-2 |
| Extreme Pressure Agents | optional | 0-5 | 0-3 |
| Unsaturated Hydrocarbons | optional | 0-5 | 0-3 |
| (LAOs) | | | |
| Basestock | Balance (such | Balance | Balance |
| | as 50 to 95%) | | |

Typical Amounts of Lubricating Oil Components in LOC (Continued)

| ADDITIVE FORMULATIONS | A (mass %) | B (mass %) | C (mass %) |
|---|---|---|---|
| Dispersant (borated and non-borated) | 0.1-40 | 1-20 | 4 to 15 |
| Detergents | 0.1-20 | 0.2-15 | 2 to 10 |
| Zinc hydrocarbyl diphosphate | 0.1-15 | 0.5-5 | 1 to 5 |
| Amine and or phenol based Antioxidant | 0.01-7 | 0.10-5 | 1 to 5 |
| Sulfurized fatty acid ester | 0.01-20 | 0.1 to 10 | 0.5-5 |
| Molybdenum containing compound | 0.01-10 | 0.1 to 7 | 0.1 to 5 |
| Antifoaming Agent | 0.001-5 | 0.001-0.2 | 0.001-0.1 |
| Friction Modifier | 0-5 | 0-1.5 | 0.1 to 5 |
| Viscosity Modifier | 0.01-25 | 1-20 | 5-15 |
| LAO (Linear Alpha Olefin) | 0.1 to 10 | 0.1 to 5 | 0.1 to 2.5 |
| Optional additional additives | 0-20 | 0.1-10 | 0.1-5 |
| Basestock (50 to 99 mass %) | Balance | Balance | Balance |

Typical Amounts of Lubricating Oil Components in LOC (Continued)

| ADDITIVE FORMULATIONS | D (mass %) | E (mass %) | F (mass %) |
|---|---|---|---|
| Dispersant borated | 0.1-10 | 0.5-8 | 0.5-5 |
| Dispersant non-borated | 0.1 to 30 | 0.5 to 20 | 1 to 15 |
| Detergent Ca high TBN | 0.1-19.8 | 0.25-9 | 0.25 to 5 |
| Detergent Mg, preferably high TBN | 0.1-19.8 | 0.5-8 | 0.5 to 5 |
| Detergent Ca low TBN | 0.1-9.8 | 0.5-8 | 0.5 to 5 |
| Zinc hydrocarbyl diphosphate | 0.1-15 | 0.5-5 | 0.5 to 3 |
| Amine and or phenol (such as diphenyl | 0.01-7 | 0.10-5 | 1 to 5 |
| amine) based antioxidant | | | |
| Sulfurized fatty acid ester | 0.01-20 | 0.1 to 10 | 0.5-5 |
| Molybdenum containing compound | 0-10 | 0.0 to 7 | 0.1 to 5 |
| Antifoaming Agent | 0.001-5 | 0.001-0.2 | 0.001-0.1 |
| Friction Modifier | 0-5 | 0-1.5 | 0.1 to 5 |
| Viscosity Modifier | 0.01-25 | 1-20 | 5-15 |
| LAO (Linear Alpha Olefin) | 0.1 to 10 | 0.1 to 5 | 0.1 to 2.5 |
| Optional additional additives | 0-20 | 0.1-10 | 0.1-10 |
| Basestock (50 to 99 mass %) | Balance | Balance | Balance |

The foregoing additives are typically commercially available materials. These additives may be added independently, but are usually pre-combined in packages, which can be obtained from suppliers of lubricant oil additives. Additive packages with a variety of ingredients, proportions and characteristics are available and selection of the appropriate package will take the use of the ultimate composition into account.

### Fuel Compositions

This disclosure also relates to fuel compositions comprising: 1) hydrogen and 2) hydrocarbon fuel, wherein the hydrocarbon fuel may be derived from petroleum and/or biological sources (“biofuel” or “renewable fuel”). In embodiments, the fuel composition comprises a combination of:
a) 1 to 99.1 mass % (such as 25 to 99 mass %, or 50 to 95 mass %,) of hydrogen, and
b) 0.1 to 99 mass % (such as 1 to 75 mass %, or 5 to 50 mass %) of hydrocarbon fuel, based upon the total mass of hydrogen and hydrocarbon fuel.

In embodiments, the hydrocarbon fuel comprises renewable fuel. The renewable fuel component is typically produced from vegetable oil (such as palm oil, rapeseed oil, soybean oil, jatropha oil), microbial oil (such as algae oil), animal fats (such as cooking oil, animal fat, and/or fish fat), ammonia and/or biogas. Renewable fuel refers to ammonia and biofuel produced from biological resources formed through contemporary biological processes. In an embodiment, the renewable fuel component is produced by means of a hydrotreatment process. Hydrotreatment involves various reactions where molecular hydrogen reacts with other components, or the components undergo molecular conversions in the presence of molecular hydrogen and a solid catalyst. The reactions include, but are not limited to, hydrogenation, hydrodeoxygenation, hydrodesulfurization, hydrodenitrification, hydrodemetallization, hydrocracking, and isomerization. The renewable fuel component may have different distillation ranges, which provide the desired properties to the component, depending on the intended use.

In embodiments, the hydrocarbon fuel comprises petroleum derived fuel. Preferred examples include gasoline fuel, diesel fuel. In embodiments, the hydrocarbon fuel may be one or more of natural gas, compressed natural gas, gasoline (such as gasoline having an octane number of 87 or more, such as 93 more), diesel fuel (such as diesel fuel having a cetane number of 40 or more, such as 50 or more), aviation fuel, bunker fuel and the like.

In embodiments, the fuel composition comprises hydrogen and diesel fuel, which is optionally used as pilot fuel (i.e., sprayed in hydrogen fueled engines) in internal combustion engines such as in high load engines such as high load large engines, such as marine engines, power generation engines, and the like

In embodiments, the hydrogen fuel is derived from fuel cells that produce hydrogen, such as ammonia fuel cells, such as those described in WO 2022/261488A1. Alternately, hydrogen produced from ammonia is also useful herein, such as hydrogen generated from ammonia as described in WO2020/095467A1

In embodiments, the fuel composition comprises a combination of:
a) 1 to 99.8 mass % (such as 25 to 95 mass %, or 50 to 90 mass %) of hydrogen,
b) 0.1 to 99 mass % mass % (such as 25 to 95 mass %, or 50 to 90 mass %) of petroleum derived fuel, and/or
c) 0.1 to 99 mass % (such as 25 to 95 mass %, or 50 to 90 mass %) of renewable fuel, based upon the total mass of hydrogen fuel, renewable fuel and the petroleum derived fuel.

This invention also relates to a method of lubricating a hydrogen fueled internal combustion engine during operation of the engine comprising:
(i) providing a lubricating composition as described herein to the internal combustion engine, such as to a crankcase;
(ii) providing a fuel composition comprising hydrogen and hydrocarbon fuel to the internal combustion engine; and
(iii) combusting the fuel composition in an internal combustion engine, wherein the fuel composition comprises a combination of:
a) 1 to 99.8 mass % (such as 25 to 95 mass %, or 50 to 90 mass %) of hydrogen,
b) 0.1 to 99 mass % mass % (such as 25 to 95 mass %, or 50 to 90 mass %) of petroleum derived fuel, and/or
c) 0.1 to 99 mass % (such as 25 to 95 mass %, or 50 to 90 mass %) of renewable fuel, based upon the total mass of hydrogen fuel, renewable fuel and the petroleum derived fuel.

### Uses

The lubricating compositions disclosed herein may be used to lubricate mechanical engine components, particularly in hydrogen fueled internal combustion engines, e.g., spark-ignited or compression-ignited, two- or four-stroke reciprocating hydrogen fueled engines, by adding the lubricant thereto. Typically, they are crankcase lubricants, such as passenger car motor oils or heavy-duty engine lubricants.

In particular, the lubricating compositions disclosed herein are suitably used in the lubrication of the crankcase of a compression-ignited, hydrogen fueled internal combustion engine, such as a heavy-duty engine.

In particular, the lubricating compositions disclosed herein are suitably used in the lubrication of the crankcase of a spark-ignited turbo charged hydrogen fueled internal combustion engine, optionally the turbocharger is prior to the hydrogen fueled internal combustion engine.

In particular, the lubricating compositions disclosed herein are suitably used a passenger vehicle lubricant or a commercial vehicle lubricant.

In embodiments, the lubricating oils disclosed herein are used in spark-assisted high compression hydrogen fueled internal combustion engines.

In embodiments, the lubricating compositions disclosed herein are suitably used in the lubrication of the crankcase of an hydrogen fueled engine for a heavy-duty vehicle (i.e., a heavy-duty vehicle having a gross vehicle weight rating of 10,000 pounds or more.)

In particular, lubricating oil formulations of this disclosure are particularly useful in compression-ignited hydrogen fueled internal combustion engines, i.e., heavy-duty engines, employing low viscosity oils, such as API FA-4 and future oil categories, in which wear protection of the valve train becomes challenging.

Also, the lubricating compositions described herein may be useful as lubricants for natural gas engines [e.g., natural gas is the fuel the engines run on, commonly called GEOs or (natural) gas engine oils].

The lubricating compositions described herein may be used to lubricate mechanical engine components, particularly in hydrogen fueled internal combustion engines, e.g., spark-ignited or compression-ignited two- or four-stroke reciprocating engines, by adding the lubricant thereto.

The lubricating compositions described herein are particularly suitable for hydrogen fueled internal combustion engines that are prone to piston-liner wear from a long duration of operation, hence the invention might extend engine lifetime.

Also, the lubricating compositions described herein are useful as lubricants for ammonia fueled engines and the like [e.g., ammonia fuel (or hydrogen combined with ammonia fuel) or ammonia combined with hydrocarbon fuel, such as gasoline or diesel fuel) is the fuel the combusted in the internal combustion engine].

This disclosure further relates to the following additional embodiments:

### Additional Embodiments/Clauses

1. A method of reducing abnormal combustion events in a hydrogen fueled internal combustion engine during operation of the engine comprising: (i) providing a lubricating oil composition to the hydrogen fueled internal combustion engine; (ii) providing fuel comprising hydrogen to the internal combustion engine; and (iii) combusting the fuel in the hydrogen fueled internal combustion engine; wherein the lubricating oil composition: 1) comprises one or more zinc dihydrocarbyl dithiophosphate compounds that provide more than 0.01 mass % zinc, and less than 0.080 mass % of phosphorus, or greater than or equal to 0.10 mass % and less than 0.40 mass % of phosphorus, based upon the weight lubricating oil composition, 2) exhibits reduced pre-ignition (Pre-Ignition Testing Method 1 or 2, see Experimental section) at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

2. The method of paragraph 1, wherein the lubricating oil composition has an SAE viscosity descriptor of 25W-X, 20W-X, 15W-X, 10W-X, 5W-X or 0W-X where X represents any one of 8, 12, 16, 20, 30, 40, 50 and 60.

3. The method of paragraphs 1-2, wherein the lubricating oil composition comprises less than 0.06 mass % of phosphorus.

4. The method of paragraphs 1-3, wherein the lubricating oil composition comprises less than 0.02 mass % of phosphorus.

5. The method of paragraphs 1-4, wherein the lubricating oil composition comprises 0.016 or less mass % of phosphorus.

6. The method of paragraphs 1-5, wherein the lubricating oil composition comprises one or more petroleum derived base oils, each having a KV100 of 11 cSt or less.

7. The method of paragraphs 1-6, wherein the lubricating oil composition comprises: a) Group I, II and or III base oil, and b) one or more zinc dialkyl dithiophosphate compounds.

8. The method of paragraphs 1-7, wherein the hydrocarbyl group of the zinc hydrocarbyl dithiophosphate is derived from one or more primary alcohols, one or more secondary alcohols and or a combination of primary and secondary alcohols.

9. The method of paragraphs 1-8, wherein, the lubricating oil composition comprises 50 mass % or more of Group I, II and or III base oil, based upon the weight of the lubricating oil composition.

10. The method of paragraphs 1-9, wherein, the lubricating oil composition comprises less than 50 mass % of Group III base oil.

11. The method of paragraphs 1-10, wherein, the lubricating oil composition comprises less than 50 mass % of Group IV base oil.

12. The method of paragraphs 1-11, wherein, the lubricating oil composition comprises less than 50 mass % of PAO base oil.

13. The method of paragraphs 1-12, wherein, the lubricating oil composition comprises up to 900 ppm zinc.

14. The method of paragraphs 1-13, wherein the lubricating oil composition comprises: a) Group I, II and or III base oil, and b) zinc dialkyl dithiophosphate, c) detergent, d) dispersant and or dispersant viscosity modifier.

15. The method of paragraph 14, wherein the dispersant and or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

16. The method of paragraphs 1-15, wherein the fuel supplied to the engine comprises at least 25 mass % hydrogen, based upon the mass of the fuel.

17. The method of paragraphs 1-16, wherein the fuel supplied to the engine comprises at least 50 mass % hydrogen, based upon the mass of the fuel.

18. The method of paragraphs 1-17, wherein the fuel supplied to the engine comprises 100 mass % hydrogen, based upon the mass of the fuel.

19. The method of paragraphs 1-18, wherein the hydrogen fuel and the lubricating oil composition are combined in the combustion chamber to form a fuel composition.

20. The method of paragraphs 1-19, wherein the hydrogen fuel and the lubricating oil composition are combined prior to injection into the combustion chamber to form a fuel composition.

21. The method of paragraphs 1-20, wherein the lubricating oil composition has at least 20% less pre-ignition events using Pre-Ignition Testing Method 1 at an engine speed of 55% of Pmax (as determined according to Regulation 49) as compared to the same composition except that the concentration of the zinc dihydrocarbyl diphosphate compounds is.

22. The method of paragraphs 1-21, wherein the lubricating oil composition has at least 20% less pre-ignition events using Pre-Ignition Testing Method 1 at an engine speed of 100% of Pmax (as determined according to Regulation 49) as compared to the same composition except that the concentration of the zinc dihydrocarbyl diphosphate compounds is.

23. The method of paragraphs 1-22, wherein the lubricating oil composition exhibits at least 20% reduced pre-ignition (Pre-Ignition Testing Method 1) at a given engine speed whilst operating at maximum BMEP for that given engine speed (rpm), as compared to the same composition except that the concentration of the zinc dihydrocarbyl diphosphate compounds is.

24. The method of paragraphs 1-23, wherein the lubricating oil composition exhibits at least 20% reduced pre-ignition (Pre-Ignition Testing Method 1) at 1000 rpm whilst operating at maximum BMEP for 1000 rpm, as compared to the same composition except that the ZDDP concentration is.

25. The method of paragraphs 1-24, wherein the lubricating oil composition exhibits at least 10% reduced pre-ignition (Pre-Ignition Testing Method 1) at 1200 rpm whilst operating at maximum BMEP for 1200 rpm, as compared to the same composition except that the ZDDP concentration is.

26. The method of paragraphs 1-25, wherein the lubricating oil composition obtains a number of pre-ignition events/1000 cycles at 12 Bar BMEP (Pre-Ignition Testing Method 1) of at least 10% less than the same composition except that the ZDDP concentration is.

27. The method of paragraphs 1-26, wherein the lubricating oil composition obtains a number of pre-ignition events/1000 cycles at 18 Bar BMEP (Pre-Ignition Testing Method 1) of at least 10% less than the same composition except that the ZDDP concentration is.

28. The method of paragraphs 1-27, wherein the number of pre-ignition events per 1,000 engine cycles is less than or equal to 5.

29. The method of paragraphs 1-28, wherein the air: fuel ratio at 12 bar is 3:1 or less.

30. The method of paragraphs 1-29, wherein the air: fuel ratio at 18 bar is 3:1 or less.

31. The method of paragraphs 1-30, wherein, the oil of lubricating viscosity comprises a Group I base oil, a Group II base oil, or combinations thereof and is included at greater than 80 wt. % of the composition.

32. The method of paragraph 7, wherein the oil of lubricating viscosity is substantially free of Group III and/or Group IV base oil.

33. The method of paragraphs 1-32, wherein the hydrocarbyl group of the zinc hydrocarbyl dithiophosphate is derived from a combination of primary and secondary alcohols.

34. The method of paragraphs 1-33, wherein the lubricating oil composition further comprises a dispersant, dispersant viscosity modifier or combinations thereof.

35. The method of paragraph 34, wherein the dispersant or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

36. The method of paragraph 34, wherein the dispersant comprises one or more, optionally borated, higher molecular weight polyisobutylene succinimide (PIBSA-PAM) dispersant (Mn 1600 g/mol or more), one or more, optionally borated, lower molecular weight polyisobutylene succinimide (PIBSA-PAM) dispersant (Mn less than 1600 g/mol), or combinations thereof, and wherein the treat level of the dispersant is from 1.0 to 15.0 wt. % of the lubricating oil composition.

37. The method of paragraph 36, wherein the higher molecular weight PIBSA-PAM is borated, the lower molecular weight PIBSA-PAM is borated or a combination thereof, and is/are included at a treat level to deliver from 20 ppm to 700 ppm by weight of boron to the lubricating oil composition.

38. The method of paragraphs 1-37, wherein the lubricating oil composition further comprises a corrosion inhibitor selected from the group consisting of corrosion inhibitor a substituted thiadiazole, a substituted benzotriazole, a substituted triazole, a trisubstituted borate, or a combination thereof, and is/are includes at a treat level of 0.001 wt. % to 5.0 wt. % of the lubricating oil composition.

39. The method of any of paragraphs 1 to 38, wherein the lubricating oil composition further comprises one or more of the following components: one or more functional polymers, one or more other friction modifiers; one or more antioxidants; one or more pour point depressants; one or more anti-foaming agents; one or more viscosity modifiers; one or more dispersants; one or more inhibitors, one or more antirust agents; one or more seal swell agents; and/or one or more anti-wear agents.

40. The method of paragraphs 1-39, wherein the hydrogen comprises green hydrogen, blue hydrogen, brown hydrogen, or combinations thereof.

41. The method of paragraphs 1-40, wherein the fuel further includes natural gas, propane, renewable fuel, or combinations thereof.

42. The method of paragraphs 1-41, wherein the fuel comprising hydrogen and the lubricating oil composition are combined in a combustion chamber of the hydrogen fueled internal combustion engine to form a fuel composition.

43. The method of paragraphs 1-42, wherein the fuel comprising hydrogen and the lubricating oil composition are combined prior to injection into a combustion chamber of the hydrogen fueled internal combustion engine to form a fuel composition.

44. The method of paragraphs 1-43, wherein the lubricating oil composition is used as a passenger vehicle lubricant or a commercial vehicle lubricant.

45. The method of paragraphs 1-44, further including a turbocharger prior to the hydrogen fueled internal combustion engine.

46. The method of paragraph 20, wherein the hydrogen fueled internal combustion engine is an heavy duty internal combustion engine.

47. The method of paragraph 20, wherein the hydrogen fueled internal combustion engine is a stationary internal combustion engine.

48. A lubricating oil composition comprising or resulting from the admixing of: a) an oil of lubricating viscosity having a KV100 of less than 10 cSt and included at greater than 50 wt. % of the composition comprising a Group I base oil, a Group II base oil, a Group III base oil, a Group IV base oil, or combinations thereof; b) detergent; c) dispersant; and d) one or more zinc hydrocarbyl diphosphate compounds that provides more than 0.01 mass % zinc, and less than 0.080 mass % of phosphorus or greater than or equal to 0.10 mass % and less than 0.40 mass % of phosphorus, based upon the weight lubricating oil composition, wherein the lubricating oil composition decreases pre-ignition (Pre-Ignition Testing Method 1 or 2) at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

49. The composition of paragraph 48, wherein, the oil of lubricating viscosity comprises a Group I base oil, a Group II base oil, or combinations thereof, and is included at greater than 80 wt. % of the composition.

50. The composition of paragraphs 48-49, wherein the oil of lubricating viscosity is substantially free of Group III and/or Group IV base oil.

51. The composition of paragraphs 48-50, wherein the lubricating oil composition further comprises a dispersant, dispersant viscosity modifier or combinations thereof.

52. The composition of paragraph 51, wherein the dispersant or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

53. The composition of paragraph 51, wherein the dispersant comprises one or more, optionally borated, higher molecular weight polyisobutylene succinimide (PIBSA-PAM) dispersant (Mn 1600 g/mol or more), one or more, optionally borated, lower molecular weight polyisobutylene succinimide (PIBSA-PAM) dispersant (Mn less than 1600 g/mol), or combinations thereof, and wherein the treat level of the dispersant is from 1.0 to 15.0 wt. % of the lubricating oil composition.

54. The composition of paragraph 53, wherein the higher molecular weight PIBSA-PAM is borated, the lower molecular weight PIBSA-PAM is borated or a combination thereof, and is/are included at a treat level to deliver from 20 ppm to 700 ppm by weight of boron to the lubricating oil composition.

55. The composition of paragraphs 48-54, wherein the lubricating oil composition further comprises a corrosion inhibitor selected from the group consisting of corrosion inhibitor a substituted thiadiazole, a substituted benzotriazole, a substituted triazole, a trisubstituted borate, or a combination thereof, and is/are includes at a treat level of 0.001 wt. % to 5.0 wt. % of the lubricating oil composition.

56. The composition of paragraphs 48-55, wherein the hydrocarbyl group of the zinc hydrocarbyl dithiophosphate is derived from one or more primary alcohols, one or more secondary alcohols or a combination of primary and secondary alcohols.

57. The composition of paragraphs 48-56, wherein the lubricating oil composition further comprises one or more of the following components: one or more functional polymers, one or more other friction modifiers; one or more antioxidants; one or more pour point depressants; one or more anti-foaming agents; one or more viscosity modifiers; one or more dispersants; one or more inhibitors, one or more antirust agents; one or more seal swell agents; and/or one or more anti-wear agents.

58. The composition of paragraphs 48-57, wherein the lubricating oil composition is used as a passenger vehicle lubricant or a commercial vehicle lubricant.

59. The composition of paragraphs 48-58, wherein the hydrogen fueled internal combustion engine is a heavy duty diesel internal combustion engine.

60. The composition of paragraphs 48-59, wherein the hydrogen fueled internal combustion engine is a stationary internal combustion engine.

61. A method of lubricating a hydrogen fueled internal combustion engine comprising supplying to the engine a lubricating oil composition, wherein the lubricating oil composition: 1) comprises one or more zinc dihydrocarbyl dithiophosphate compounds that provide more than 0.01 mass % zinc, and less than 0.080 mass % of phosphorus or greater than or equal to 0.10 mass % and less than 0.40 mass % of phosphorus, based upon the weight lubricating oil composition, 2) exhibits reduced pre-ignition (Pre-Ignition Testing Method 1 or 2, see Experimental section) at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

62. A fuel composition comprising the lubricating oil composition of paragraphs 48-60 and hydrogen fuel.

63. The use of the lubricating oil composition of paragraphs 48-60, to lubricate a hydrogen fueled internal combustion engine.

The following non-limiting examples are provided to illustrate the disclosure.

### Experimental

### Testing Procedures

Sulfated ash (“SASH”) content is measured by ASTM D874.

Phosphorus, Calcium, Zinc, and Silicon content are measured by ASTM D5185.

Pre-Ignition testing (referred to as Pre-Ignition Testing Method 1) for Example 1 below was conducted using the following method: Abnormal combustion events (pre-ignition) were determined as follows: data regarding pre-ignition occurrences was generated using a turbocharged, port fuelled Daimler OM936 7.7 liter, 6 cylinder engine, modified to run on hydrogen fuel with a reduction in compression ratio to 10-12:1, upscaling of fuel injectors and turbocharger system, adaption of the blowby system to prevent high concentrations of hydrogen in the crankcase, and adaption of a CNG-based engine control system modified for lean burn operation. The engine was operated under conditions between 12 to 18 bar brake mean effective pressure, between engine speeds of about 1000 to 1200 rpm and at air to fuel ratio (AFR) between 1.85 and 2.05. For each cycle (a cycle being 2 piston cycles (up/down, up/down), data was collected on peak pressure and mass faction burned over the duration of each cycle. Post processing of the data included calculation of combustion metrics, verification of operating parameters being within target limits, and detection of pre-ignition events (statistical procedure outlined below). From the above data, outliers, which are potential occurrences of pre-ignition were collected. For each pre-ignition cycle, data recorded included peak pressure (PP), MFB03.5 (crank angle at 3.5% mass fraction burned), cycle number and engine cylinder. A cycle was identified as having a pre-ignition event if both of the crank angle corresponding to MFB03.5 of the fuel and the cylinder PP are outliers. Outliers were determined relative to the distribution of a particular cylinder and test segment in which it occurs. Determination of “outliers” was an iterative process involving calculation of the mean and standard deviation of PP and MFB03.5 for each segment and cylinder; and cycles with parameters that exceed n standard deviations from the mean. The number of standard deviations n, used as a limit for determining outliers, is a function of the number of cycles in the test and was calculated using the Grubbs' test for outliers. Outliers were identified in the severe tail of each distribution. That is, if n is the number of standard deviations obtained from Grubbs' test for outliers, an outlier for PP is identified as one exceeding the mean plus n standard deviations of peak pressure. Likewise, an outlier for MFB03.5 was identified as one being lower than the mean less n standard deviations of MFB03.5. Data was further examined to ensure that the outliers indicated an occurrence of pre-ignition, rather than some other abnormal combustion event or an electrical sensor error.

Pre-Ignition testing (referred to as Pre-Ignition Testing Method 2) of lubricating oil compositions for Abnormal Combustion Events was measured using the following method for Examples 2 and 3 below. Abnormal combustion events (pre-ignition) were determined as follows: Pre-ignition was measured using a turbocharged, direct injection Mercedes M274, 2.0 litre, 4-cylinder engine, modified to run on hydrogen fuel with HDEV4 series gasoline injectors and modified ignition coil. A 3 mm diameter side mounted dosing lance was integrated into the intake port of cylinder 4. Test oils were metered into the intake port through means of a peristaltic pump. The engine was operated at speeds of around 1550 rpm with 14 bar brake mean effective pressure, air to fuel ratio (AFR) of 1.7 and air intake temperature of 75° C. The test procedure consists of a 10-minute pre-conditioning phase in the absence of oil dosing, followed by a 10-minute period in which oil is dosed at a rate of approximately 0.3 g/kWh and a final 10-minute post-conditioning phase without oil dosing. Data collected over the duration of this test was analysed to determine the frequency of pre-ignition occurrences. Data analysis of the frequency of pre-ignition occurrences was done as follows: For each cycle (a cycle being 2 piston cycles (up/down, up/down), data was collected on peak pressure and mass faction burned over the duration of each cycle. Post processing of the data included calculation of combustion metrics, verification of operating parameters being within target limits, and detection of pre-ignition events (statistical procedure outlined below). From the above data, outliers, which are potential occurrences of pre-ignition were collected. Data from cylinder 4 was analysed to identify pre-ignition events resulting from the test oil. For each pre-ignition cycle, data recorded included peak pressure (PP), MFB05 (crank angle at 5% mass fraction burned), cycle number and engine cylinder. A cycle was identified as having a pre-ignition event if both the crank angle corresponding to MFB05 of the fuel and the cylinder PP are outliers. Outliers were determined relative to the distribution of a particular cylinder during the pre-conditioning phase. An outlier for PP is identified as one exceeding the mean plus three standard deviations of peak pressure. Likewise, an outlier for MFB05 was identified as one being lower than the mean less three standard deviations of MFB05. Data was further examined to ensure that the outliers indicated an occurrence of pre-ignition, rather than some other abnormal combustion event or an electrical sensor error.

As used herein, Brake Mean Effective Pressure (BMEP) is the mean effective pressure calculated from measured brake torque. The word “brake” denotes the actual torque or power available at the engine flywheel, as measured on a dynamometer. Thus, BMEP is a measure of the useful power output of the engine. BMEP is defined as the work accomplished during an engine cycle, divided by the engine swept volume; the engine torque normalized by engine displacement and can be calculated using the following formula: BMEP=(2pTn)/(Vd), where Tis torque (Nm), n is the number of revolutions per cycle, Vd is displacement (m³), p is pi, 3.14. For a 4 stroke engine n is 2, for a 2 stroke engine n is 1. The results are reported in bars.

Regulation 49 is Addendum 48: Regulation 49, revision 6 dated Mar. 4 2013, entitled Uniform Provisions Concerning The Measures To Be Taken Against The Emission Of Gaseous And Particulate Pollutants From Compression-Ignition Engines And Positive Ignition Engines For Use In Vehicles of the United Nations Agreement Concerning the Adoption of Uniform Technical Prescriptions for Wheeled Vehicles, Equipment and Parts which can be fitted and/or be used on Wheeled Vehicles and the Conditions for Reciprocal Recognition of Approvals Granted on the Basis of these Prescriptions, Annex 4 (Uniform Provisions Concerning the Measures to be Taken Against The Emission of Gaseous and Particulate Pollutants From Compression-Ignition Engines and Positive Ignition Engines For Use in Vehicles), E/ECE/324/Rev.1/Add.48/Rev.6-E/ECE/TRANS/505/Rev.1/Add.48/Rev.6, dated Mar. 4 2013). See §§ 7.3 to 7.4.7, et seq, page 115 et seq. for Engine Power Curve, torque measurements, etc.

### Example 1

Oil A (inventive) and Oil B (comparative) were prepared and evaluated for pre-ignition according to the Pre-Ignition Testing Method 1 procedure described above. Testing was performed at: 1) 75,000 cycles at 1000 rpm, 1.85 AFR and 12 bar BMEP; or 2) 40,000 cycles at 1200 rpm, 2.05 AFR and 16, 17 or 18 bar BMEP. Data collected over the duration of this test was analyzed to determine the frequency of pre-ignition occurrences. The data is reported in Table 1 below.

TABLE 1

| | Inventive | Comparative |
|---|---|---|
| | Oil A | Oil B |
| Component | | |
| PIBSA-PAM | 6.0 | 6.0 |
| calcium detergent | 5.0 | 5.0 |
| ZDDP (derived from combination of | 0.20 | 5.0 |
| primary and secondary alcohols) | | |
| Group III basestock (4 to 6 cSt) | 78.7 | 73.9 |
| Remainder of additives | 10.1 | 10.1 |
| Total Oil | 100.0 | 100.0 |
| Properties | | |
| Pre-ignition @ 1000 rpm, 12 bar BMEP, | 2.66 | 8.78 |
| 1.85 AFR (PI events per 1000 cycles) | | |
| Pre-ignition @ 1200 rpm, 2.05 AFR and | 0.56 | 1.22 |
| 16 bar BMEP (PI events per 1000 cycles) | | |
| Pre-ignition @ 1200 rpm, 2.05 AFR and | 0.99 | 1.19 |
| 17 bar BMEP (PI events per 1000 cycles) | | |
| Pre-ignition @ 1200 rpm, 2.05 AFR and | 1.43 | 2.43 |
| 18 bar BMEP (PI events per 1000 cycles) | | |
| Ca mass % | 0.6 | 0.6 |
| P mass % | 0.016 | 0.40 |
| Si ppm | 11 | 12 |
| Sulfated Ash (mass %) | 2.01 | 2.94 |
| Zn mass % | 0.018 | 0.440 |

* Oils A and B contained the same components in the same amounts of diphenyl amine antioxidant, PDMS anti-foamant, diluent, hydrogenated styrene-diene copolymer viscosity modifier, group III basestock (4 to 6 cSt), and soap mass.

### Example 2

Comparative oil 1 and Inventive oils 2 and 3 were prepared and evaluated for pre-ignition according to the Pre-Ignition Testing Method 2 procedure described above. The data is reported in Table 2 below. All three of the oils were of equivalent composition differing only in the amount of ZDDP weight % included in the oil. Pre-ignition testing was performed on the inventive and comparative lubricating oils at the following conditions: 1550 rpm, 14 bar BMEP, 1.70 air: fuel ratio (AFR), air intake temperature of 75° C. Data collected over the duration of this test was analyzed using the data analysis procedure described above to determine the frequency of pre-ignition occurrences. The data is reported in Table 2 below for the comparative and inventive lubricating oils.

Based on the data in Table 2 below, it was surprisingly and unexpectedly discovered that the two inventive lubricating including 0.02 wt. % and 0.0 wt. % phosphorous enabled a significant reduction in abnormal combustion events, such as pre-ignition with respect to a comparable lubricating oil including phosphorous at 0.08 wt. % of the lubricating oil composition. The data in Table 2 shows that a beneficial level of phosphorous content in the lubricating oil being less than 0.08 wt. % of the composition to significantly decrease abnormal combustion events.

TABLE 2

| | Comparative | Inventive | Inventive |
|---|---|---|---|
| | Oil 1 | Oil 2 | Oil 3 |
| Constituent | | | |
| PIBSA-PAM dispersant | 6.0 | 6.0 | 6.0 |
| Calcium Sulfonate detergent | 5.4 | 5.4 | 5.4 |
| ZDDP (derived from | 1.0 | 0.2 | 0.0 |
| combination of primary and | | | |
| secondary alcohols) | | | |
| Group III basestock (4 to 6 cSt) | 77.5 | 78.3 | 78.5 |
| Remainder of additives | 10.1 | 10.1 | 10.1 |
| Oil Total | 100.0 | 100.0 | 100.0 |
| Properties | | | |
| Count of Pre-ignition @ 1550 | 57 | 27.3 | 14.5 |
| rpm, 14 bar BMEP, 1.70 AFR, air | | | |
| intake temperature 75° C. | | | |
| % P | 0.08 | 0.02 | 0.00 |
| % Ash | 2.2 | 2.0 | 2.0 |
| % Ca | 0.63 | 0.63 | 0.63 |
| Viscosity Grade | 10W-40 | 10W-40 | 10W-40 |

### Example 3

Comparative oils 1 and 5 and Inventive oils 4 and 6 were prepared and evaluated for pre-ignition according to the Pre-Ignition Testing Method 2 procedure described above. The data is reported in Table 3 below. All four of the oils were of equivalent composition differing only in the amount of ZDDP weight % included in the oil and the type of ZDDP used (derived from combination of primary and secondary alcohols or derived from only primary alcohols). Pre-ignition testing was performed on the inventive and comparative lubricating oils at the following conditions: 1550 rpm, 14 bar BMEP, 1.70 air: fuel ratio (AFR), air intake temperature of 75° C. Data collected over the duration of this test was analyzed using the data analysis procedure described above to determine the frequency of pre-ignition occurrences. The data is reported in Table 3 below for the two comparative lubricating oil and two inventive lubricating oils.

Based on the data in Table 3 below, it was surprisingly and unexpectedly discovered that the two inventive lubricating (Inventive oils 4 and 6) including 0.20 wt. % phosphorous enabled a significant reduction in abnormal combustion events, such as pre-ignition with respect to comparable lubricating oils (Comparative oils 1 and 5) including phosphorous at 0.08 wt. % of the lubricating oil composition. The data in Table 2 shows that a beneficial level of phosphorous content in the lubricating oil being greater than 0.08 wt. % of the composition to significantly decrease abnormal combustion events for when the phosphorus is either from a ZDDP derived from primary alcohols or a ZDDP (derived from combination of primary and secondary alcohols).

TABLE 3

| | Comparative | Inventive | Comparative | Inventive |
|---|---|---|---|---|
| | Oil 1 | Oil 4 | Oil 5 | Oil 6 |
| Constituent | | | | |
| PIBSA-PAM dispersant | 6.0 | 6.0 | 6.0 | 6.0 |
| Calcium Sulfonate detergent | 5.4 | 5.4 | 5.4 | 5.4 |
| ZDDP (derived from | 1.0 | 2.5 | | |
| combination of primary and | | | | |
| secondary alcohols) | | | | |
| ZDDP (derived from primary | | | 1.2 | 2.9 |
| alcohols) | | | | |
| Group III basestock (4 to 6 cSt) | 77.5 | 76.0 | 77.4 | 75.7 |
| Remainder of additives | 10.1 | 10.1 | 10.1 | 10.1 |
| Oil Total | 100.0 | 100.0 | 100.1 | 100.1 |
| Properties | | | | |
| Count of Pre-ignition @ 1550 | 57 | 42 | 14 | 6.5 |
| rpm, 14 bar BMEP, 1.70 AFR, air | | | | |
| intake temperature 75° C. | | | | |
| % P | 0.08 | 0.20 | 0.08 | 0.20 |
| % Ash | 2.2 | 2.5 | 2.2 | 2.5 |
| % Ca | 0.63 | 0.63 | 0.63 | 0.63 |
| Viscosity Grade | 10W-40 | 10W-40 | 10W-40 | 10W-40 |

All documents described herein are incorporated by reference herein, including any priority documents and/or testing procedures, to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. The term “comprising” is considered synonymous with the term “including.” The term “comprising” or any cognate word specifies the presence of stated features, steps, or integers or components, but does not preclude the presence or addition of one or more other features, steps, integers, components or groups thereof. Likewise, whenever a composition, an element, or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa, wherein “consists essentially of” permits inclusion of substances not materially affecting the characteristics of the composition to which it applies.

What is claimed is:

1. A method of reducing abnormal combustion events in a hydrogen fueled internal combustion engine during operation of the engine comprising:
(i) providing a lubricating oil composition to the hydrogen fueled internal combustion engine;
(ii) providing fuel comprising hydrogen to the internal combustion engine; and
(iii) combusting the fuel in the hydrogen fueled internal combustion engine;
wherein the lubricating oil composition: 1) comprises one or more zinc dihydrocarbyl dithiophosphate compounds that provide more than 0.01 mass % zinc, and less than 0.08 mass % of phosphorus or greater than or equal to 0.10 mass % and less than 0.40 mass % of phosphorus, based upon the weight lubricating oil composition, 2) exhibits reduced pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

2. The method of claim 1, wherein the lubricating oil composition has an SAE viscosity descriptor of 25W-X, 20W-X, 15W-X, 10W-X, 5W-X or 0W-X where X represents any one of 8, 12, 16, 20, 30, 40, 50 and 60.

3. The method of claim 1, wherein the lubricating oil composition comprises less than 0.06 mass % of phosphorus.

4. The method of claim 1, wherein the lubricating oil composition comprises less than 0.02 mass % of phosphorus.

5. The method of claim 1, wherein the lubricating oil composition comprises 0.016 or less mass % of phosphorus.

6. The method of claim 1, wherein the lubricating oil composition comprises:
a) Group I, Group II Group III, Group IV, or combinations thereof base oils at greater than or equal to 50 wt. % of the lubricating oil composition.

7. The method of claim 1, wherein the hydrocarbyl group of the zinc hydrocarbyl dithiophosphate is derived from one or more primary alcohols, one or more secondary alcohols and or a combination of primary and secondary alcohols.

8. The method of claim 1, wherein, the lubricating oil composition comprises up to 900 ppm zinc.

9. The method of claim 1, wherein the lubricating oil composition comprises:
a) Group I, II and or III base oil, and
b) zinc dialkyl dithiophosphate,
c) detergent,
d) dispersant and or dispersant viscosity modifier.

10. The method of claim 9, wherein the dispersant and or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

11. The method of claim 1, wherein the fuel supplied to the engine comprises at least 50 mass % hydrogen, based upon the mass of the fuel.

12. The method of claim 1, wherein the hydrogen fuel and the lubricating oil composition are combined in the combustion chamber to form a fuel composition or are combined prior to injection into the combustion chamber to form a fuel composition.

13. The method of claim 1, wherein, the oil of lubricating viscosity comprises a Group I base oil, a Group II base oil, or combinations thereof and is included at greater than 80 wt. % of the composition.

14. The method of claim 6, wherein the oil of lubricating viscosity is substantially free of Group III and/or Group IV base oil.

15. The method of claim 1, wherein the hydrocarbyl group of the zinc hydrocarbyl dithiophosphate is derived from one or more primary alcohols, one or more secondary alcohols or a combination of primary and secondary alcohols.

16. The method of claim 1, wherein the lubricating oil composition further comprises a dispersant, dispersant viscosity modifier or combinations thereof.

17. The method of claim 16, wherein the dispersant or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

18. The method of claim 16, wherein the dispersant comprises one or more, optionally borated, higher molecular weight polyisobutylene succinimide (PIBSA-PAM) dispersant (Mn 1600 g/mol or more), one or more, optionally borated, lower molecular weight polyisobutylene succinimide (PIBSA-PAM) dispersant (Mn less than 1600 g/mol), or combinations thereof, and wherein the treat level of the dispersant is from 1.0 to 15.0 wt. % of the lubricating oil composition.

19. The method of claim 18, wherein the higher molecular weight PIBSA-PAM is borated, the lower molecular weight PIBSA-PAM is borated or a combination thereof, and is/are included at a treat level to deliver from 20 ppm to 700 ppm by weight of boron to the lubricating oil composition.

20. The method of claim 1, wherein the lubricating oil composition further comprises a corrosion inhibitor selected from the group consisting of corrosion inhibitor a substituted thiadiazole, a substituted benzotriazole, a substituted triazole, a trisubstituted borate, or a combination thereof, and is/are includes at a treat level of 0.001 wt. % to 5.0 wt. % of the lubricating oil composition.

21. The method of claim 1, wherein the lubricating oil composition further comprises one or more of the following components: one or more functional polymers, one or more other friction modifiers; one or more antioxidants; one or more pour point depressants; one or more anti-foaming agents; one or more viscosity modifiers; one or more dispersants; one or more inhibitors, one or more antirust agents; one or more seal swell agents; and/or one or more anti-wear agents.

22. The method of claim 1, wherein the hydrogen comprises green hydrogen, blue hydrogen, brown hydrogen, or combinations thereof.

23. The method of claim 1, wherein the fuel further includes natural gas, propane, renewable fuel, or combinations thereof.

24. The method of claim 1, wherein the fuel comprising hydrogen and the lubricating oil composition are combined in a combustion chamber of the hydrogen fueled internal combustion engine to form a fuel composition.

25. The method of claim 1, wherein the fuel comprising hydrogen and the lubricating oil composition are combined prior to injection into a combustion chamber of the hydrogen fueled internal combustion engine to form a fuel composition.

26. The method of claim 1, wherein the lubricating oil composition is used as a passenger vehicle lubricant or a commercial vehicle lubricant.

27. The method of claim 1, further including a turbocharger prior to the hydrogen fueled internal combustion engine.

28. The method of claim 1, wherein the hydrogen fueled internal combustion engine is a heavy duty internal combustion engine or a stationary internal combustion engine.

29. A lubricating oil composition comprising or resulting from the admixing of:
a) an oil of lubricating viscosity having a KV100 of less than 10 cSt and included at greater than 50 wt. % of the composition comprising a Group I base oil, a Group II base oil, a Group III base oil, a Group IV base oil, or combinations thereof;
b) detergent;
c) dispersant; and
d) one or more zinc hydrocarbyl diphosphate compounds that provides more than 0.01 mass % zinc, and less than 0.08 mass % of phosphorus or greater than or equal to 0.10 mass % and less than 0.40 mass % of phosphorus, based upon the weight lubricating oil composition,
wherein the lubricating oil composition decreases pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

30. The composition of claim 29, wherein, the oil of lubricating viscosity comprises a Group I base oil, a Group II base oil, or combinations thereof, and is included at greater than 80 wt. % of the composition.

31. The composition of claim 29, wherein the oil of lubricating viscosity is substantially free of Group III and/or Group IV base oil.

32. The composition of claim 29, wherein the lubricating oil composition further comprises a dispersant, dispersant viscosity modifier or combinations thereof.

33. The composition of claim 32, wherein the dispersant or dispersant viscosity modifier comprises an amide, imide, and/or ester functionalized partially or fully saturated polymer comprising C₄₋₅ olefins having: i) an Mw/Mn of less than 2, ii) a Functionality Distribution (Fd) value of 3.5 or less, and iii) an Mn of 10,000 g/mol or more of the polymer prior to functionalization.

34. The composition of claim 32, wherein the dispersant comprises one or more, optionally borated, higher molecular weight polyisobutylene succinimide (PIBSA-PAM) dispersant (Mn 1600 g/mol or more), one or more, optionally borated, lower molecular weight polyisobutylene succinimide (PIBSA-PAM) dispersant (Mn less than 1600 g/mol), or combinations thereof, and wherein the treat level of the dispersant is from 1.0 to 15.0 wt. % of the lubricating oil composition.

35. The composition of claim 34, wherein the higher molecular weight PIBSA-PAM is borated, the lower molecular weight PIBSA-PAM is borated or a combination thereof, and is/are included at a treat level to deliver from 20 ppm to 700 ppm by weight of boron to the lubricating oil composition.

36. The composition of claim 29, wherein the lubricating oil composition further comprises a corrosion inhibitor selected from the group consisting of corrosion inhibitor a substituted thiadiazole, a substituted benzotriazole, a substituted triazole, a trisubstituted borate, or a combination thereof, and is/are includes at a treat level of 0.001 wt. % to 5.0 wt. % of the lubricating oil composition.

37. The composition of claim 29, wherein the hydrocarbyl group of the zinc hydrocarbyl dithiophosphate is derived from one or more primary alcohols, one or more secondary alcohols or a combination of primary and secondary alcohols.

38. The composition of claim 29, wherein the lubricating oil composition further comprises one or more of the following components: one or more functional polymers, one or more other friction modifiers; one or more antioxidants; one or more pour point depressants; one or more anti-foaming agents; one or more viscosity modifiers; one or more dispersants; one or more inhibitors, one or more antirust agents; one or more seal swell agents; and/or one or more anti-wear agents.

39. The composition of claim 29, wherein the lubricating oil composition is used as a passenger vehicle lubricant or a commercial vehicle lubricant.

40. The composition of claim 29, wherein the hydrogen fueled internal combustion engine is a heavy duty diesel internal combustion engine or a stationary internal combustion engine.

41. A method of lubricating a hydrogen fueled internal combustion engine comprising supplying to the engine a lubricating oil composition, wherein the lubricating oil composition: 1) comprises one or more zinc dihydrocarbyl dithiophosphate compounds that provide more than 0.01 mass % zinc, and less than 0.08 mass % of phosphorus or greater than or equal to 0.10 mass % and less than 0.40 mass % of phosphorus, based upon the weight lubricating oil composition, 2) exhibits reduced pre-ignition at a given engine speed whilst operating at maximum BMEP for that given engine speed (rpm), as compared to the same composition except that the concentration of the zinc dihydrocarbyl diphosphate compounds is such that the mass % phosphorus in the lubricating oil composition is not within the specified ranges.

42. A fuel composition comprising the lubricating oil composition of claim 29 and hydrogen fuel.

43. The use of the lubricating oil composition of claim 29, to lubricate a hydrogen fueled internal combustion engine.
